(19) United States
(12) Patent Application Publication
(10) Pub. No.: US 2026/0349657 A1
(43) Pub. Date: Nov. 5, 2026

(54) Arithmetic Processing Device

(71) Applicant: Semiconductor Energy Laboratory Co., Ltd., Kanagawa-ken (JP)

(72) Inventors: Yoshiyuki KUROKAWA, Sagamihara, Kanagawa (JP); Satoru OHSHITA, Hadano, Kanagawa (JP); Hidefumi RIKIMARU, Tama, Tokyo (JP)

(73) Assignee: Semiconductor Energy Laboratory Co., Ltd., Kanagawa-ken (JP)

(21) Appl. No.: 19/101,746

(22) PCT Filed: Jul. 27, 2023
(86) PCT No.: PCT/IB2023/057606

§ 371 Date: Feb. 6, 2025

(30) Foreign Application Priority Data
Aug. 10, 2022 (JP) 2022-127917

(51) Int. Cl. G06F 7/544

(52) U.S. Cl. CPC G06F 7/5443

(57) ABSTRACT

A novel arithmetic processing device is provided. The arithmetic processing device includes a first current generation portion, a second current generation portion, a third current generation portion, and a product-sum operation unit; the first current generation portion has a function of outputting a first current amount corresponding to first data and a function of outputting a second current amount corresponding to second data; the second current generation portion has a function of outputting a third current amount corresponding to third data; the third current generation portion has a function of outputting a fourth current amount corresponding to fourth data; the product-sum operation unit has a function of outputting a current amount corresponding to multiplication of the first current amount and the third current amount and multiplication of the second current amount and the fourth current amount; and at least one of the first data and the second data is zero.

### TECHNICAL FIELD

One embodiment of the present invention relates to an arithmetic processing device and particularly to an arithmetic processing device capable of performing a product-sum operation.

Note that one embodiment of the present invention is not limited to the above technical field. The technical field of one embodiment of the invention disclosed in this specification and the like relates to an object, a method, a driving method, or a manufacturing method. One embodiment of the present invention relates to a process, a machine, manufacture, or a composition of matter. Specific examples of the technical field of one embodiment of the present invention disclosed in this specification and the like include a semiconductor device, a display apparatus, a light-emitting apparatus, a power storage device, an optical device, an imaging device, a lighting device, an arithmetic device, a control device, a memory device, an input device, an output device, an input/output device, a signal processing device, an arithmetic processing device, an electronic computer, an electronic appliance, driving methods thereof, and manufacturing methods thereof.

### BACKGROUND ART

Recently, integrated circuits that imitate the mechanism of the human brain have been actively developed. The integrated circuits incorporate the brain mechanism as electronic circuits and include circuits corresponding to “neurons” and “synapses” of the human brain. Such integrated circuits may therefore be called “neuromorphic”, “brain-morphic”, or “brain-inspired” circuits. The integrated circuits have a non-von Neumann architecture and may be able to perform parallel processing with extremely low power consumption as compared with a von Neumann architecture, which consumes higher power with increasing processing speed.

An information processing model that imitates a biological neural network including “neurons” and “synapses” is referred to as an artificial neural network (ANN) (simply referred to as a neural network in some cases). By using a neural network, inference with an accuracy as high as or higher than that of a human can be carried out. In a neural network, an arithmetic operation in which outputs of a plurality of artificial neurons (simply referred to as neurons in some cases) are weighted and added, i.e., a product-sum operation, is the main arithmetic operation.

Patent Document 1 proposes, as a circuit that performs a product-sum operation in a neural network, a structure in which a transistor including an oxide semiconductor in its channel formation region is used.

Non-patent Document 1 proposes a method for reducing power consumption required for arithmetic operation in a neural network.

### REFERENCES

### Patent Document

[Patent Document 1] PCT International Publication No. 2020/254909

### Non-Patent Document

[Non-patent Document 1] Atsutake Kosuge et al., “A 16 nJ/Classification FPGA-Based Wired-Logic DNN Accelerator Using Fixed-Weight Non-Linear Neural Net”, IEEE Journal on Emerging and Selected Topics in Circuits and Systems, vol. 11, no. 4, pp. 751-761, December 2021

### SUMMARY OF THE INVENTION

### Problems to be Solved by the Invention

As a method for reducing power consumption required for arithmetic operation in a neural network, a scale-down of a model (also referred to as model compression) is performed. For example, a reduction of bits (sometimes referred to as quantization), pruning, or zero skipping is known as a technique for the scale-down of a model, and one or more of them are used for the scale-down.

Note that in this specification and the like, a connection between neurons in a neural network is referred to as a “net”, a connection strength is referred to as “weight data (also referred to as a weight coefficient in some cases)”, and a signal transmitted via the net is referred to as “net data” in some cases.

The reduction of bits is a way of reducing the number of bits of data for an arithmetic operation in a neural network. For example, in normal scientific computation or the like, data of a floating-point number is used, and the number of bits of the data is 32 bits or the like. Even when the data is an integer of approximately 8 bits, for example, the inference accuracy of the neural network hardly decreases in some cases. By reducing bits, the memory capacity for storing data can be reduced. In addition, the scale of a circuit that performs arithmetic operation (e.g., a multiplier circuit and an adder circuit) can be small. Moreover, the multiplier circuit can be replaced with an adder circuit by setting the weight data to 1 bit, for example. Accordingly, when the circuit scale becomes small, reduction in power consumption is possible.

Pruning is a way of reducing the number of terms of a product-sum operation. This corresponds to thinning (sometimes referred to as decimation) of a net in a neural network. In the case where the value of the weight data is zero or small, contribution of the corresponding net to the product-sum operation is zero or small. Thus, even without the net, the inference accuracy of the neural network hardly decreases in some cases. Pruning can decrease the number of arithmetic operations and thus can reduce the power consumption. Note that a mechanism of deleting the decimated net in a circuit is required to obtain an effect of reducing power consumption by pruning.

Zero skipping is a way of, in the case where at least one of weight data and net data is zero, not performing an arithmetic operation of a corresponding term. Note that in a neural network, a large proportion of weight data is known to be distributed around zero, and a reduction of bits sometimes increases the probability that the weight data around zero becomes zero. In the case where the weight data is zero, the multiplication of a term corresponding to the weight data is zero, and the addition of the term in the product-sum operation is also zero. That is, arithmetic operations of the multiplication and the addition of the term are not necessary. When the multiplication and the addition themselves are not performed, the multiplier circuit and the adder circuit do not consume power; thus, power consumption can be reduced. Note that zero skipping require a circuit that determines the data to be zero.

One object of one embodiment of the present invention is to provide a semiconductor device or arithmetic processing device with reduced power consumption. Another object is to provide a semiconductor device or arithmetic processing device with improved arithmetic efficiency. Another object is to provide a novel semiconductor device or a novel arithmetic processing device.

Note that the objects listed above do not preclude the existence of other objects. Note that, in one embodiment of the present invention, there is no need to achieve all these objects listed above. Objects other than objects listed above are apparent from the description of the specification, the drawings, the claims, and the like and objects other than objects listed above can be derived from the description of the specification, the drawings, the claims, and the like.

### Means for Solving the Problems

The present invention is made in view of the above objects, and for example, a model of a neural network reduced in weight by pruning or the like can be applied to an analog in-memory AI (Artificial Intelligence) chip with a current-writing method disclosed in Patent Document 1. In that case, zero is input as weight data corresponding to a pruned net.

The AI chip enables multi-bit arithmetic operation. In the case where the net data is zero in the AI chip, power consumption for inputting the data is zero. Furthermore, in the case where at least one of weight data and net data is zero, power consumption of the memory cell performing multiplication is zero.

(1)

One embodiment of the present invention is an arithmetic processing device including a first semiconductor device, a second semiconductor device, and a third semiconductor device, in which the first semiconductor device, the second semiconductor device, and the third semiconductor device each include a first current generation portion, a second current generation portion, a third current generation portion, and a product-sum operation unit; the product-sum operation unit includes a first cell and a second cell; the first current generation portion has a function of outputting a first current amount corresponding to first data and a function of outputting a second current amount corresponding to second data; the second current generation portion has a function of outputting a third current amount corresponding to third data; the third current generation portion has a function of outputting a fourth current amount corresponding to fourth data; the first cell has a function of storing the first current amount and a function of outputting a fifth current amount corresponding to multiplication of the first current amount and the third current amount; the second cell has a function of storing the second current amount and a function of outputting a sixth current amount corresponding to multiplication of the second current amount and the fourth current amount; the product-sum operation unit has a function of outputting a seventh current amount corresponding to addition of the fifth current amount and the sixth current amount; the first current amount in the case where the first data is zero, the second current amount in the case where the second data is zero, the third current amount in the case where the third data is zero, and the fourth current amount in the case where the fourth data is zero are each lower than or equal to 1×10⁻¹¹ A; the first semiconductor device, the second semiconductor device, and the third semiconductor device each form part of a pruned neural network; data corresponding to the seventh current amount in the second semiconductor device is input as the third data in the first semiconductor device; data corresponding to the seventh current amount in the third semiconductor device is input as the fourth data in the first semiconductor device; and at least one of the first data and the second data in the first semiconductor device is zero.

(2)

In the above (1), the arithmetic processing device may include a control portion, and the control portion may have a function of setting at least one of the first data and the second data in the first semiconductor device to zero.

(3)

In the above (1) or (2), the first semiconductor device, the second semiconductor device, and the third semiconductor device may each include a transistor including an oxide semiconductor in a channel formation region.

(4)

In the above (1) or (2), preferably, the first semiconductor device, the second semiconductor device, and the third semiconductor device each include a plurality of current sources, and the amount of current output from each of the plurality of current sources is lower than or equal to 1.0×10⁻⁸ A.

(5)

In the above (1) or (2), the first semiconductor device, the second semiconductor device, and the third semiconductor device may each include a transistor operating in a subthreshold region.

(6)

In the above (1) or (2), the arithmetic processing device may include a first layer and a second layer positioned over the first layer; the first current generation portion and the product-sum operation unit of the first semiconductor device may be provided in one of the first layer and the second layer; and the first current generation portion and the product-sum operation unit of the second semiconductor device and the first current generation portion and the product-sum operation unit of the third semiconductor device may each be provided in the other of the first layer and the second layer.

(7)

In the above (1) or (2), the first cell may include a first arithmetic cell and a first driving cell; the second cell may include a second arithmetic cell and a second driving cell; the first arithmetic cell may be electrically connected to the first current generation portion through a first wiring; the first arithmetic cell may be electrically connected to the second current generation portion through a second wiring; the first driving cell may be electrically connected to the second current generation portion through the second wiring; the second arithmetic cell may be electrically connected to the first current generation portion through the first wiring; the second arithmetic cell may be electrically connected to the third current generation portion through a third wiring; the second driving cell may be electrically connected to the third current generation portion through the third wiring; the first current generation portion may have a function of supplying the first current amount or the second current amount to the first wiring; the second current generation portion may have a function of supplying a first reference current or the third current amount to the second wiring; the third current generation portion may have a function of supplying a second reference current or the fourth current amount to the third wiring; the first arithmetic cell may have a function of retaining a first potential corresponding to the first current amount; the first driving cell may have a function of retaining a second potential corresponding to the first reference current; the first arithmetic cell may have a function of supplying the fifth current amount corresponding to a product of the first current amount and the third current amount to the first wiring when a current supplied from the second current generation portion to the second wiring is changed from the first reference current to the third current amount in a state where the first potential is retained in the first arithmetic cell and the second potential is retained in the first driving cell; the second arithmetic cell may have a function of retaining a third potential corresponding to the second current amount; the second driving cell may have a function of retaining a fourth potential corresponding to the second reference current; and the second arithmetic cell may have a function of supplying the sixth current amount corresponding to a product of the second current amount and the fourth current amount to the first wiring when a current supplied from the third current generation portion to the third wiring is changed from the second reference current to the fourth current amount in a state where the third potential is retained in the second arithmetic cell and the fourth potential is retained in the second driving cell.

### Effect of the Invention

With the use of a model of a neural network in the arithmetic processing device of one embodiment of the present invention, for example, an effect of reducing power consumption similar to that by pruning can be obtained without deleting the nets decimated by pruning in a circuit. In addition, for example, an effect of reducing power consumption similar to that by zero skipping can be obtained without providing a separate circuit that determines the data to be zero by zero skipping.

One embodiment of the present invention can provide a semiconductor device or arithmetic processing device with reduced power consumption. Another embodiment of the present invention can provide a semiconductor device or arithmetic processing device with improved arithmetic efficiency. Another embodiment of the present invention can provide a novel semiconductor device or a novel arithmetic processing device.

Note that the effects listed above do not preclude the presence of other effects. Note that one embodiment of the present invention does not necessarily achieve all the effects listed above. Effects other than the effects listed above are apparent from the description of the specification, the drawings, the claims, and the like and effects other than the effects listed above can be derived from the description of the specification, the drawings, the claims, and the like.

### BRIEF DESCRIPTION OF THE DRAWINGS

FIG. 1 is a diagram showing a configuration example of a semiconductor device.

FIG. 2A and FIG. 2B are diagrams showing configuration examples of an arithmetic processing device.

FIG. 3A to FIG. 3C are diagrams each showing a neural network.

FIG. 4 is a diagram showing a configuration example of an arithmetic processing device.

FIG. 5 is a block diagram showing a configuration example of a semiconductor device.

FIG. 6A to FIG. 6C are block diagrams each showing a configuration example of a circuit included in a semiconductor device.

FIG. 7A to FIG. 7D are circuit diagrams each showing a configuration example of a circuit included in a semiconductor device.

FIG. 8A to FIG. 8D are circuit diagrams each showing a configuration example of a circuit included in a semiconductor device.

FIG. 9 is a circuit diagram showing a configuration example of a circuit included in a semiconductor device.

FIG. 10 is a block diagram showing a configuration example of a semiconductor device.

FIG. 11 is a block diagram showing a configuration example of a semiconductor device.

FIG. 12 is a timing chart showing an operation example of a semiconductor device.

FIG. 13 is a block diagram showing a configuration example of a semiconductor device.

FIG. 14A to FIG. 14C are block diagrams each showing a configuration example of a circuit included in a semiconductor device.

FIG. 15 is a block diagram showing a configuration example of a circuit included in a semiconductor device.

FIG. 16A is a circuit diagram showing a configuration example of a circuit included in a semiconductor device. FIG. 16B is a block diagram showing a configuration example of a circuit included in a semiconductor device.

FIG. 17A and FIG. 17B are block diagrams each showing a configuration example of a circuit included in a semiconductor device. FIG. 17C is a circuit diagram showing a configuration example of a circuit included in a semiconductor device.

FIG. 18 is a block diagram showing a configuration example of a semiconductor device.

FIG. 19A and FIG. 19B are diagrams showing hierarchical neural networks.

FIG. 20 is a block diagram showing a configuration example of a semiconductor device.

FIG. 21 is a block diagram showing a configuration example of a semiconductor device.

FIG. 22 is a block diagram showing a configuration example of a semiconductor device.

FIG. 23A and FIG. 23B are diagrams showing examples of electronic components.

FIG. 24A and FIG. 24B are diagrams showing examples of electronic appliances. FIG. 24C to FIG. 24E are diagrams each showing an example of a large computer.

FIG. 25 is a diagram showing an example of a device for space.

FIG. 26 is a diagram showing an example of a storage system applicable to a data center.

### MODE FOR CARRYING OUT THE INVENTION

In this specification and the like, a semiconductor device refers to a device that utilizes semiconductor characteristics, and means a circuit including a semiconductor element (e.g., a transistor, a diode, or a photodiode) or a device including the circuit, for example. The semiconductor device also means any device that can function by utilizing semiconductor characteristics. For example, an integrated circuit including a semiconductor element, a chip provided with an integrated circuit, an electronic component including a packaged chip, and an electronic appliance provided with an electronic component are examples of a semiconductor device. For example, a display apparatus, a light-emitting apparatus, a power storage device, an optical device, an imaging device, a lighting device, an arithmetic device, a control device, a memory device, an input device, an output device, an input/output device, a signal processing device, an electronic computer, an electronic appliance, and the like themselves might be semiconductor devices, or might include semiconductor devices.

Embodiments will be described below with reference to the drawings. Note that the embodiments can be implemented in many different modes. Accordingly, it will be readily understood by those skilled in the art that the modes and details can be changed in various ways without departing from the spirit and scope thereof. Thus, the present invention should not be interpreted as being limited to the description in the embodiments.

In this specification and the like, the configuration described in each embodiment can be combined with the configurations described in the other embodiments as appropriate to constitute one embodiment of the present invention. In addition, in the case where a plurality of configurations are described in one embodiment, the configurations can be combined as appropriate to constitute one embodiment.

As for the drawings illustrating the embodiments, in the structures of the invention, the same reference numerals are used in common for the same portions or portions having similar functions in different drawings, and repeated description thereof is omitted in some cases. In drawings, for example, the same hatching pattern is used for portions having similar functions, and the portions are not denoted by specific reference numerals in some cases. Moreover, some components are omitted in a perspective view, a top view (also referred to as a “plan view”), and the like for easy understanding of the drawings in some cases. In the drawings, some hidden lines and the like are omitted in some cases. In the drawings, for example, a hatching pattern or the like is omitted in some cases.

In the drawings, the size, the layer thickness, or the region is exaggerated for clarity in some cases. Thus, the drawings are not necessarily limited to the drawings with the shown size, aspect ratio, and the like, for example. Note that the drawings schematically show ideal examples, and embodiments of the present invention are not limited to shapes, values, and the like shown in the drawings, for example. For example, in the actual manufacturing process, a layer, a resist mask, or the like might be unintentionally reduced in size by treatment such as etching, which is not shown in the drawings in some cases for easy understanding. For example, in the actual circuit operation, a fluctuation in voltage, current, or the like might be caused by noise, difference in timing, or the like, which is not illustrated in some cases for easy understanding.

In this specification, drawings, and the like, components of this invention are classified on the basis of the functions and shown as components independent of each other in some cases. However, it may be difficult to separate components on the basis of the functions, so that one component may be associated with a plurality of functions or several components may be associated with one function. Accordingly, the component is not limited to that described in this specification, drawings, and the like and can be explained with another term as appropriate depending on the situation.

In this specification, drawings, and the like, when a plurality of components are denoted by the same reference numeral, and in particular need to be distinguished from each other, an identification sign such as “A”, “b”, “_1”, “[n]”, or “[m, n]” is sometimes added to the reference numeral, for example.

Note that in this specification and the like, a “conduction state” or an “on state” of a transistor refers to a state where a source and a drain of the transistor can be regarded as being electrically short-circuited, a state where current can be made to flow between the source and the drain, or the like. For example, the “conduction state” or the “on state” refers to a state where the voltage between the gate and the source is higher than the threshold voltage in an n-channel transistor, a state where the voltage between the gate and the source is lower than the threshold voltage in a p-channel transistor, or the like in some cases. Furthermore, a “non-conduction state,” a “cutoff state,” or an “off state” of a transistor refers to a state where a source and a drain of the transistor can be regarded as being electrically disconnected. For example, the “non-conduction state”, the “cutoff state”, or the “off state” refers to a state where the voltage between the gate and the source is lower than the threshold voltage in an n-channel transistor, a state where the voltage between the gate and the source is higher than the threshold voltage in a p-channel transistor, or the like in some cases.

In this specification and the like, “off-state current” of a transistor refers to current flowing between a source and a drain of the transistor in the off state (also referred to as drain current) unless otherwise specified. Note that in this specification and the like, when the transistor is in the off state, drain current and current flowing between the gate and the source or the drain (also referred to as gate leakage current) are sometimes referred to as leakage current.

### Embodiment 1

A semiconductor device and an arithmetic processing device of one embodiment of the present invention will be described with reference to drawings. Note that the semiconductor device and the arithmetic processing device of one embodiment of the present invention may be suitably used, for example, as part of a neural network and particularly as part of a neural network reduced in weight by pruning or the like.

### <Configuration Example of Semiconductor Device>

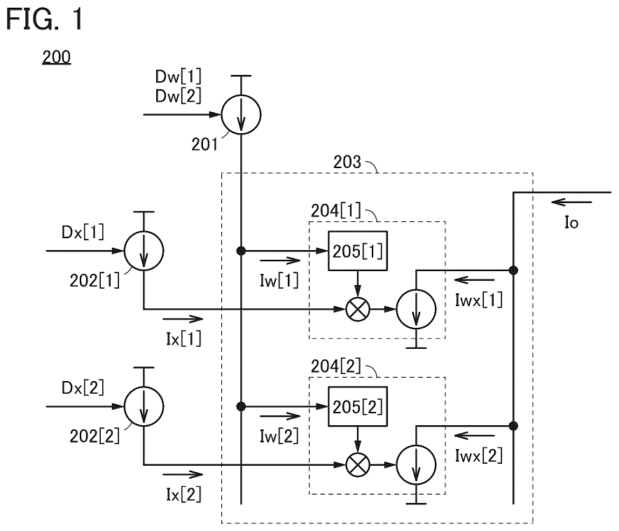

FIG. 1 is a schematic view showing a configuration example of a semiconductor device 200 of one embodiment of the present invention.

The semiconductor device 200 shown in FIG. 1 includes a first current generation portion 201, a second current generation portion 202[1], a second current generation portion 202[2], and a product-sum operation unit 203. The product-sum operation unit 203 includes a cell 204[1] and a cell 204[2]. The cell 204[1] includes a memory unit 205[1]. The cell 204[2] includes a memory unit 205[2].

The first current generation portion 201 has a function of outputting a first current amount I_{w}[1] corresponding to first data D_{w}[1]. For example, the first current amount I_{w}[1] is proportional to the first data D_{w}[1] (I_{w}[1]∝D_{w}[1]). The first current generation portion 201 also has a function of outputting a first current amount I_{w}[2] corresponding to first data D_{w}[2]. For example, the first current amount I_{w}[2] is proportional to the first data D_{w}[2] (I_{w}[2]∝D_{w}[2]).

The second current generation portion 202[1] has a function of outputting a second current amount Iₓ[1] corresponding to second data Dₓ[1]. For example, the second current amount Iₓ[1] is proportional to the second data Dₓ[1] (Iₓ[1]∝Dₓ[1]).

The second current generation portion 202[2] has a function of outputting a second current amount Iₓ[2] corresponding to second data Dₓ[2]. For example, the second current amount Iₓ[2] is proportional to the second data Dₓ[2] (Iₓ[2]∝Dₓ[2]).

The cell 204[1] has a function of storing the first current amount I_{w}[1] in the memory unit 205[1]. The cell 204[1] also has a function of outputting a third current amount I_{wx}[1] corresponding to the multiplication of the first current amount I_{w}[1] and the second current amount Iₓ[1]. For example, the third current amount I_{wx}[1] is proportional to the product of the first current amount I_{w}[1] and the second current amount Iₓ[1] (I_{wx}[1]∝I_{w}[1]×Iₓ[1]).

The cell 204[2] has a function of storing the first current amount I_{w}[2] in the memory unit 205[2]. The cell 204[1] also has a function of outputting a third current amount I_{wx}[2] corresponding to the multiplication of the first current amount I_{w}[2] and the second current amount Iₓ[2]. For example, the third current amount I_{wx}[2] is proportional to the product of the first current amount I_{w}[2] and the second current amount Iₓ[2] (I_{wx}[2]∝I_{w}[2]×Iₓ[2]).

The product-sum operation unit 203 has a function of outputting a fourth current amount Iₒ corresponding to the addition of the third current amount I_{wx}[1] and the third current amount I_{wx}[2]. For example, the fourth current amount Iₒ is proportional to the sum of the third current amount I_{wx}[1] and the third current amount I_{wx}[2] (Iₒ∝I_{wx}[1]+I_{wx}[2]).

That is, the fourth current amount Iₒ is proportional to the product sum of the first current amount (I_{w}[1] and I_{w}[2]) and the second current amount (Iₓ[1] and Iₓ[2]) (Iₒ∝I_{w}[1]×Iₓ[1]+I_{w}[2]×Iₓ[2]).

Thus, the semiconductor device 200 has a function of outputting the fourth current amount Iₒ corresponding to the product-sum operation of the input second data (Dₓ[1] and Dₓ[2]) and the first data (Dₓ[1] and Dₓ[2]) stored in the cell 204[1] and the cell 204[2].

Note that although a configuration example in which the second current amounts (Iₓ[1] and Iₓ[2]) corresponding to the second data (Dₓ[1] and Dₓ[2]) are generated from the second current generation portion 202[1] and the second current generation portion 202[2] is shown here, one embodiment of the present invention is not limited thereto. For example, a configuration may be employed in which the second current amounts (Iₓ[1] and Iₓ[2]) are directly input as the second data without providing the second current generation portions.

Although a configuration example in which the fourth current amount Iₒ is directly output is shown here, one embodiment of the present invention is not limited thereto. For example, the fourth current amount Iₒ may be output after performing an arithmetic operation corresponding to a given function. Examples of the function include a non-linear function such as a sigmoid function, a tanh function, a softmax function, a ReLU function, or a threshold function.

In the semiconductor device 200, the first current amount I_{w}[1] in the case where the first data D_{w}[1] is zero, the first current amount I_{w}[2] in the case where the first data D_{w}[2] is zero, the second current amount Iₓ[1] in the case where the second data Dₓ[1] is zero, and the second current amount Iₓ[2] in the case where the second data Dₓ[2] is zero are each a current amount where data is zero.

The current amount where data is zero is a value of current that slightly flows due to the off-state current (current flowing between a source and a drain when a transistor is in an off state) of the transistor included in each of the first current generation portion 201, the second current generation portion 202[1], and the second current generation portion 202[2]. Thus, the current amount where data is zero is, for example, lower than or equal to 1×10⁻¹¹ A, preferably lower than or equal to 1×10⁻¹⁵ A, further preferably lower than or equal to 1×10⁻¹⁸ A.

The first current generation portion 201, the second current generation portion 202[1], and the second current generation portion 202[2] each include a transistor functioning as a switch for controlling whether current is output or not, for example. That is, the value of the off-state current flowing when the transistor is brought into an off state is the current amount where data is zero. Examples of the transistor include a Si transistor (a transistor including silicon in a channel formation region) and an OS transistor (a transistor including an oxide semiconductor in a channel formation region).

An OS transistor features an extremely low off-state current because the band gap of the oxide semiconductor where the channel is formed is greater than or equal to 2 eV. The off-state current value per micrometer of channel width of the OS transistor at room temperature can be lower than or equal to 1 aA (1×10⁻¹⁸ A), lower than or equal to 1 zA (1×10⁻²¹ A), or lower than or equal to 1 yA (1×10⁻²⁴ A). Note that the off-state current value per micrometer of channel width of a Si transistor at room temperature is higher than or equal to 1 fA (1×10⁻¹⁵ A) and lower than or equal to 1 pA (1×10⁻¹² A). In other words, the off-state current of the OS transistor is lower than that of the Si transistor by approximately ten orders of magnitude.

The off-state current of the OS transistor hardly increases even in a high-temperature environment. Specifically, the off-state current hardly increases even at an environment temperature higher than or equal to room temperature and lower than or equal to 200 °C. Furthermore, the on-state current of the OS transistor is unlikely to decrease even in a high-temperature environment. Meanwhile, the on-state current of the Si transistor decreases in a high-temperature environment. That is, the OS transistor has a higher on-state current than the Si transistor in a high-temperature environment. In the OS transistor, the ratio between on-state current and off-state current is large even at an environmental temperature higher than or equal to 125 °C and lower than or equal to 150 °C; thus, a favorable switching operation can be performed. Thus, the semiconductor device including the OS transistor can operate stably and have high reliability even in a high-temperature environment.

A semiconductor layer of the OS transistor preferably includes at least one of indium and zinc. The semiconductor layer of the OS transistor preferably includes indium, M (M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, cobalt, magnesium, and antimony), and zinc, for example. In particular, M is preferably one or more kinds selected from gallium, aluminum, yttrium, and tin.

It is particularly preferable to use an oxide including indium (In), gallium (Ga), and zinc (Zn) (also referred to as “IGZO”) for the semiconductor layer. Alternatively, an oxide including indium (In), aluminum (Al), and zinc (Zn) (also referred to as “IAZO”) may be used for the semiconductor layer. Further alternatively, an oxide including indium (In), aluminum (Al), gallium (Ga), and zinc (Zn) (also referred to as “IAGZO”) may be used for the semiconductor layer.

When the semiconductor layer is an In-M-Zn oxide, the atomic ratio of In is preferably greater than or equal to the atomic ratio of M in the In-M-Zn oxide. Examples of the atomic ratio of the metal elements in such an In-M-Zn oxide include In:M:Zn=1:1:1 or a composition in the neighborhood thereof, In:M:Zn=1:1:1.2 or a composition in the neighborhood thereof, In:M:Zn=2:1:3 or a composition in the neighborhood thereof, In:M:Zn=3:1:2 or a composition in the neighborhood thereof, In:M:Zn=4:2:3 or a composition in the neighborhood thereof, In:M:Zn=4:2:4.1 or a composition in the neighborhood thereof, In:M:Zn=5:1:3 or a composition in the neighborhood thereof, In:M:Zn=5:1:6 or a composition in the neighborhood thereof, In:M:Zn=5:1:7 or a composition in the neighborhood thereof, In:M:Zn=5:1:8 or a composition in the neighborhood thereof, In:M:Zn=6:1:6 or a composition in the neighborhood thereof, and In:M:Zn=5:2:5 or a composition in the neighborhood thereof. The atomic ratio of In may be smaller than the atomic ratio of M in the In-M-Zn oxide. Examples of the atomic ratio of the metal elements in such an In-M-Zn oxide include In:M:Zn=1:3:2 or a composition in the neighborhood thereof and In:M:Zn=1:3:4 or a composition in the neighborhood thereof. Note that a composition in the neighborhood includes the range of ±30% of an intended atomic ratio.

For example, when an OS transistor is used for the first current generation portion 201, the first current amount I_{w}[1] in the case where the first data D_{w}[1] is zero and the first current amount I_{w}[2] in the case where the first data D_{w}[2] is zero can be extremely small, whereby power consumption can be reduced. When an OS transistor is used for the second current generation portion 202[1], the second current amount Iₓ[1] in the case where the second data Dₓ[1] is zero can be extremely small, whereby power consumption can be reduced. Furthermore, when an OS transistor is used for the second current generation portion 202[2], the second current amount Iₓ[2] in the case where the second data Dₓ[2] is zero can be extremely small, whereby power consumption can be reduced.

Each of the first current generation portion 201, the second current generation portion 202[1], and the second current generation portion 202[2] includes, for example, a plurality of current sources, controls whether each current source outputs current, and thus can generate the amount of current corresponding to data. In that case, the amount of current output from one current source corresponds to the least significant bit (LSB) of the data. Accordingly, the smaller the amount of current output from one current source is, the lower the power consumption can be. Thus, the amount of current output from one current source is, for example, lower than or equal to 1.0×10⁻⁸ A, preferably lower than or equal to 1.0×10⁻¹² A, further preferably lower than or equal to 1.0×10⁻¹⁵ A.

Note that the above-described current amount where data is zero may be, for example, a current amount that is two orders of magnitude lower, preferably three orders of magnitude lower, further preferably four orders of magnitude lower than the current amount corresponding to the least significant bit.

The first current generation portion 201, the second current generation portion 202[1], and the second current generation portion 202[2] each include a transistor functioning as a current source in order to generate a current amount corresponding to data, for example. The transistor, for example, preferably operates in a subthreshold region (a region where the voltage between a gate and a source of the transistor is lower than a threshold voltage and drain current changes exponentially with respect to the voltage between the gate and the source). That is, when having the threshold voltage within an appropriate range, the transistor allows current flow within a wide current range where the transistor operates in the subthreshold region. Examples of the transistor include a Si transistor and an OS transistor.

The memory unit 205[1] and the memory unit 205[2] can each be formed using one transistor and one capacitor, for example. When an OS transistor is used as the transistor, data (a voltage value corresponding to the amount of current) can be stored for a long time.

Note that for specific configuration examples of the components included in the semiconductor device 200, the description in Embodiment 2 and Embodiment 3 below can be referred to. For example, the first current generation portion 201 corresponds to a circuit WCS described later. The second current generation portion 202[1] and the second current generation portion 202[2] each correspond to a circuit XCS described later. The product-sum operation unit 203 corresponds to a cell array CA described later.

Note that the configuration example in which the product-sum operation of the two pieces of first data and the two pieces of second data is performed is described here for simple description; however, one embodiment of the present invention is not limited thereto. One embodiment of the present invention may be configured to perform a product-sum operation of three or more pieces of first data and three or more pieces of second data.

That is, the semiconductor device 200 of one embodiment of the present invention may include the first current generation portion 201, the second current generation portion 202[1] to a second current generation portion 202[N] (here, Nis an integer greater than or equal to 2), and the product-sum operation unit 203.

In this semiconductor device 200, the first current generation portion 201 has a function of outputting the first current amount I_{w}[1] to a first current amount I_{w}[N] corresponding respectively to the first data D_{w}[1] to first data D_{w}[N]. The second current generation portion 202[1] to the second current generation portion 202[N] have a function of respectively outputting the second current amount Iₓ[1] to a second current amount Iₓ[N] corresponding respectively to the second data Dₓ[1] to second data Dₓ[N]. The product-sum operation unit 203 has a function of outputting the fourth current amount Iₒ corresponding to the product sum of the first current amounts (I_{w}[1] to I_{w}[N]) and the second current amounts (Iₓ[1] to Iₓ[N]) (the sum of I_{w}[1]×Iₓ[1] to I_{w}[N]×Iₓ[N]).

Thus, the semiconductor device 200 has a function of outputting the fourth current amount Iₒ corresponding to the product-sum operation of the input second data (Dₓ[1] to Dₓ[N]) and the first data (D_{w}[1] to D_{w}[N]) that are stored in the cell 204[1] to a cell 204[N] included in the product-sum operation unit 203.

### <Configuration Example of Arithmetic Processing Device>

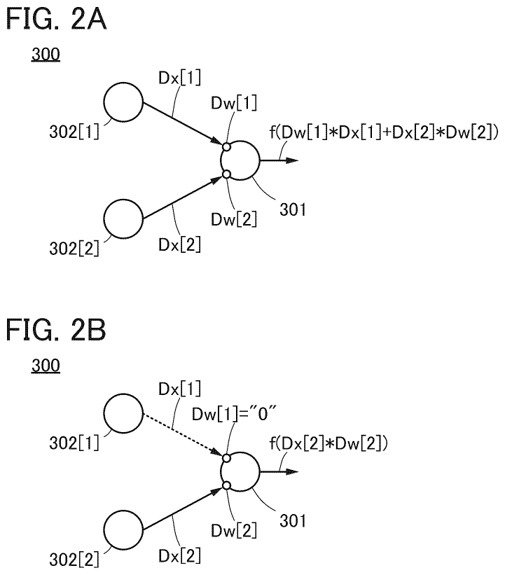

FIG. 2A is a schematic view showing a configuration example of an arithmetic processing device 300 of one embodiment of the present invention.

The arithmetic processing device 300 shown in FIG. 2A includes a semiconductor device 301, a semiconductor device 302[1], and a semiconductor device 302[2].

The semiconductor device 200 described above can be used for each of the semiconductor device 301, the semiconductor device 302[1], and the semiconductor device 302[2].

An output of the semiconductor device 302[1] is input to the semiconductor device 301 (indicated by a solid arrow in the drawing). For example, data corresponding to the fourth current amount Iₒ in the semiconductor device 302[1] (data obtained by performing an arithmetic operation corresponding to a given function with respect to the fourth current amount Iₒ) is input as the second data Dₓ[1] to the semiconductor device 301.

An output of the semiconductor device 302[2] is input to the semiconductor device 301 (indicated by a solid arrow in the drawing). For example, data corresponding to the fourth current amount Iₒ in the semiconductor device 302[2] (data obtained by performing an arithmetic operation corresponding to a given function with respect to the fourth current amount Iₒ) is input as the second data Dₓ[2] to the semiconductor device 301.

The semiconductor device 301 outputs data corresponding to the product-sum operation of the input second data (Dₓ[1] and Dₓ[2]) and the first data (D_{w}[1] and D_{w}[2]) that are stored in the semiconductor device 301. For example, the semiconductor device 301 outputs f(D_{w}[1]×Dₓ[1]+D_{w}[2]×Dₓ[2]) obtained by performing an arithmetic operation corresponding to a given function with respect to the product-sum operation.

Note that the arithmetic processing device 300 can have a stacked-layer structure. For example, a stacked-layer structure of a layer provided with the semiconductor device 301 and a layer provided with the semiconductor device 302[1] and the semiconductor device 302[2] can be employed. Note that for the structure example of the stacked-layer structure, the description in Embodiment 5 below can be referred to.

Note that a configuration example in which the outputs of the semiconductor device 302[1] and the semiconductor device 302[2] are each input to the semiconductor device 301 is described here for simple description; however, one embodiment of the present invention is not limited thereto. In the arithmetic processing device 300 of one embodiment of the present invention, outputs of the semiconductor device 302[1] to a semiconductor device 302[N] (here, N is an integer greater than or equal to 2) may each be input to the semiconductor device 301. That is, the arithmetic processing device 300 may include the semiconductor device 301 and the semiconductor device 302[1] to the semiconductor device 302[N].

In the arithmetic processing device 300, the semiconductor device 301 outputs data corresponding to the product-sum operation of the input second data (Dₓ[1] to Dₓ[N]) and the first data (D_{w}[1] to D_{w}[N]) that are stored in the semiconductor device 301. For example, the semiconductor device 301 outputs f (the sum of D_{w}[1]×Dₓ[1] to D_{w}[N]×Dₓ[N]) obtained by performing an arithmetic operation corresponding to a given function with respect to the product-sum operation.

### <Examples of Application to Neural Network>

The arithmetic processing device 300 of one embodiment of the present invention can form part of a neural network. Note that the description in Embodiment 4 below can be referred to for the configuration example of the neural network.

The neural network formed using the arithmetic processing device 300 has a function of setting at least one of the first data D_{w}[1] and the first data D_{w}[2] in the semiconductor device 301 to zero by pruning.

That is, in the semiconductor device 301 included in the arithmetic processing device 300 forming part of the pruned neural network, at least one of the first data D_{w}[1] and the first data D_{w}[2] which corresponds to a decimated net is zero.

FIG. 2B is a schematic view showing the case where a net between the semiconductor device 301 and the semiconductor device 302[1] is decimated by pruning in a neural network formed using the arithmetic processing device 300, for example.

As shown in FIG. 2B, in the case where the net between the semiconductor device 301 and the semiconductor device 302[1] is decimated (indicated by a dotted arrow in the drawing), the first data D_{w}[1] in the semiconductor device 301 is set to zero (D_{w}[1]=“0”). In that case, the term D_{w}[1]×Dₓ[1] in the product-sum operation in the semiconductor device 301 is zero, and thus, the semiconductor device 301 outputs f(D_{w}[2]×Dₓ[2]), for example.

That is, in the neural network, when the first data corresponding to the net decimated by pruning is set to zero, the first current amount corresponding to the first data becomes the current amount where data is zero. Thus, the multiplication of the term corresponding to the first data is zero, and power consumption due to the multiplication can be substantially zero. In other words, multiplication of zero can be performed with the power consumption of substantially zero without deleting the nets decimated by pruning in a circuit or providing a separate circuit that determines the data to be zero. Thus, the power consumption of the neural network formed using the arithmetic processing device 300 can be reduced.

Note that in the case where the arithmetic processing device 300 of one embodiment of the present invention includes the semiconductor device 302[1] to the semiconductor device 302[N], the neural network formed using the arithmetic processing device 300 has a function of setting at least one of the first data D_{w}[1] to the first data D_{w}[N] in the semiconductor device 301 to zero by pruning.

That is, in the semiconductor device 301 included in the arithmetic processing device 300 forming part of the pruned neural network, at least one of the first data D_{w}[1] to the first data D_{w}[N] which corresponds to a decimated net is zero.

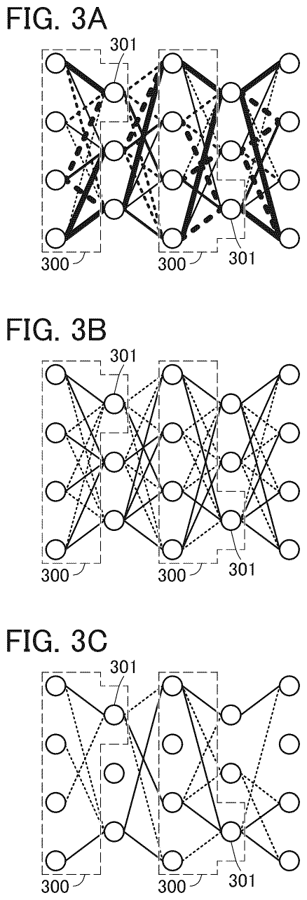

FIG. 3A to FIG. 3C are schematic diagrams each showing an example of a scale-down of a model of a neural network. An example in which a model of a neural network reduced in weight is applied to the arithmetic processing device 300 of one embodiment of the present invention will be described with reference to FIG. 3A to FIG. 3C.

As shown in FIG. 3A to FIG. 3C, the neural network is formed using a plurality of arithmetic processing devices 300 (two of which are representatively denoted by reference numerals in each drawing). In FIG. 3A to FIG. 3C, the polarity (positive or negative) and the size of weight data are represented by the line style (solid line or dotted line) and the thickness of the net.

First, a reduction of bits is performed on a DNN (Deep Neural Network) which is common and is shown as an example in FIG. 3A to reduce the number of bits of the weight data. Then, a neural network which has been subjected to the reduction of bits and is shown as an example in FIG. 3B (nets on which the reduction of bits is performed are represented by thinned lines in the drawing) can be obtained. The reduction of bits increases the proportion of weight data that become zero. Note that the weight data may be 1 bit by the reduction of bits, for example. When the weight data is set to 1 bit, a multiplier circuit can be replaced with an adder circuit, for example, so that the circuit scale can be reduced.

Next, pruning is performed on the neural network which is subjected to the reduction of bits and is shown as an example in FIG. 3B to decimate nets that become zero. Then, a neural network which is subjected to the reduction of bits and pruning and is shown as an example in FIG. 3C (decimated nets are deleted in the diagram) can be obtained. The above-described reduction of bits increases the proportion of weight data that become zero, so that the number of nets that become zero, i.e., nets that can be decimated also increases.

The neural network which is subjected to the reduction of bits and pruning and is shown as an example in FIG. 3C can be formed by setting the first data to zero as appropriate in each of the plurality of arithmetic processing devices 300. In the case where the weight data is zero in the neural network, for example, the first data becomes zero in the semiconductor device 301 included in the arithmetic processing device 300, and the first current amount corresponding to the first data also becomes the current amount where data is zero. For another example, in the case where the net data is zero, the second data becomes zero in the semiconductor device 301 included in the arithmetic processing device 300, and the second current amount corresponding to the second data also becomes the current amount where data is zero.

Thus, in the case where the net data is zero, for example, the power consumption of the second current generation portion in the semiconductor device 301 included in the arithmetic processing device 300 can be substantially zero. For another example, in the case where at least one of weight data and net data is zero, the power consumption of a cell that performs multiplication of the first data and the second data can be substantially zero in the semiconductor device 301 included in the arithmetic processing device 300.

In other words, the neural network formed using the arithmetic processing device 300 can obtain an effect of reducing power consumption similar to that by pruning and zero skipping without deleting the nets decimated by pruning in a circuit or providing a separate circuit that determines the data to be zero.

Note that the inference accuracy of the neural network might be lowered by the reduction of bits and pruning. In order to compensate for the decrease in the inference accuracy, for example, in the arithmetic processing device 300, an arithmetic operation corresponding to a given function (e.g., a sigmoid function, a tanh function, a softmax function, a ReLU function, or a threshold function) is performed on each of the outputs of the semiconductor device 301 and the semiconductor device 302[1] to the semiconductor device 302[N]. For example, optimization of the non-linear functions disclosed in Non-patent Document 1 may be performed.

Note that the semiconductor device 301 and the semiconductor device 302[1] to the semiconductor device 302[N] included in the arithmetic processing device 300 can each perform multi-bit arithmetic operation as described later in Embodiment 2. Thus, the neural network formed using the arithmetic processing device 300 can increase the inference accuracy without performing the above optimization of the non-linear function. For example, the neural network which is subjected to pruning can be retrained with the weight data of 8 bits, whereby the inference accuracy can be increased.

Note that the power consumption of the arithmetic processing device 300 is proportional to the multiplication of the first current amounts corresponding to the first data and the second current amounts corresponding to the second data in the semiconductor device 301 and the semiconductor device 302[1] to the semiconductor device 302[N]. Accordingly, as each of the first data and the second data becomes close to zero, the power consumption becomes low. Thus, a neural network formed using the arithmetic processing device 300 can achieve reduction in power consumption when a large proportion of weight data is distributed around zero by weight attenuation, for example.

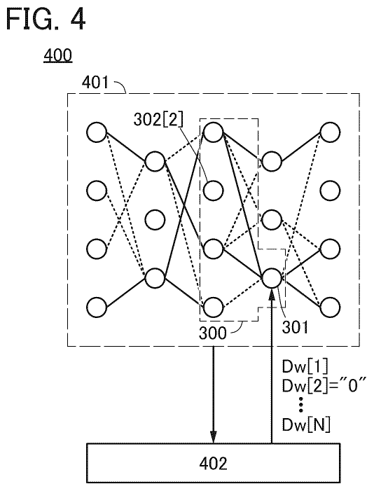

FIG. 4 is a schematic view showing a configuration example of an arithmetic processing device 400 of one embodiment of the present invention.

The arithmetic processing device 400 shown in FIG. 4 includes a neural network 401 formed using a plurality of arithmetic processing devices 300 (one of which is representatively denoted by a reference numeral in the drawing) and a control portion 402.

The control portion 402 has a function of reading the model of the neural network 401 which is subjected to pruning and inputting the first data D_{w}[1] to the first data D_{w}[N] to the semiconductor device 301 included in the arithmetic processing device 300 so that the weight data corresponding to the decimated nets become zero. That is, the control portion 402 has a function of setting at least one of the first data D_{w}[1] to the first data D_{w}[N] in the semiconductor device 301 to zero by pruning.

As an example, FIG. 4 shows the case where a net between the semiconductor device 301 and the semiconductor device 302[2] is decimated by pruning (the net is deleted in the drawing). In that case, the control portion 402 inputs the first data D_{w}[2] of zero (D_{w}[2]=“0”) to the semiconductor device 301 included in the arithmetic processing device 300.

Note that the control portion 402 may have a function of performing, for example, learning, a reduction of bits, pruning, zero skipping, optimization of a function, weight attenuation, or retraining with respect to the neural network 401.

Setting at least one of the first data D_{w}[1] to the first data D_{w}[N] to zero by the control portion 402 enables the arithmetic processing device 400 to obtain an effect of reducing power consumption similar to that by pruning and zero skipping without deleting the nets decimated by pruning in a circuit or providing a separate circuit that determines the data to be zero by zero skipping.

The semiconductor device and the arithmetic processing device according to one embodiment of the present invention are not limited to those described in this embodiment. At least part of the configuration examples, the operation examples, the drawings corresponding thereto, and the like described in this embodiment as an example can be combined with the other configuration examples, the other operation examples, the other drawings, and the other embodiments described in this specification and the like as appropriate.

### Embodiment 2

Described in this embodiment is an example of a circuit, which is a semiconductor device of one embodiment of the present invention, capable of performing a product-sum operation and an arithmetic operation of a function system.

### <Configuration Example 1 of Arithmetic Circuit>

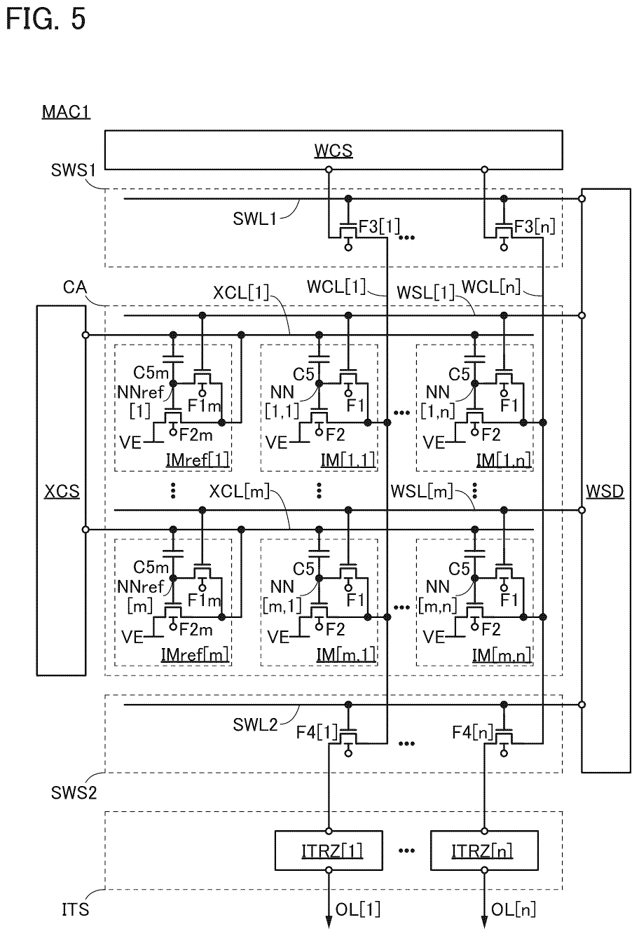

FIG. 5 shows a configuration example of an arithmetic circuit that performs product-sum operation of positive or “0” first data and positive or “0” second data. The arithmetic circuit MAC1 shown in FIG. 5 is a circuit that performs product-sum operation of the first data corresponding to a potential retained in each cell and the input second data, and performs arithmetic operation of an activation function with use of the product-sum operation result. Note that the first data and the second data can be analog data or multilevel data (discrete data), for example.

The arithmetic circuit MAC1 includes the circuit WCS, the circuit XCS, a circuit WSD, a circuit SWS1, a circuit SWS2, the cell array CA, and a circuit ITS.

The cell array CA includes a cell IM[1, 1] to a cell IM[m, n] (here, m is an integer greater than or equal to 1 and n is an integer greater than or equal to 1) and a cell IMref[1] to a cell IMref[m]. The cell IM[1, 1] to the cell IM[m, n] each have a function of generating and retaining a potential corresponding to a current amount corresponding to the first data, and the cell IMref[1] to the cell IMref[m] have a function of generating and retaining a potential corresponding to a current amount corresponding to the second data required for performing a product-sum operation with the retained first data. The cell IM[1, 1] to the cell IM[m, n] each have a function of supplying a current amount corresponding to the product of the current amount corresponding to the first data and the current amount corresponding to the second data when supplied with the second data.

Note that in this specification and the like, the cell IM[1, 1] to the cell IM[m, n] are each sometimes referred to as an “arithmetic cell”. The cell IMref[1] to the cell IMref[m] are each referred to as a “driving cell” in some cases.

In the cell array CA in FIG. 5, cells are arranged in a matrix of n+1 rows and m columns; however, the cell array CA may have a configuration in which cells are arranged in a matrix of two or more rows and one or more columns.

The cell IM[1, 1] to the cell IM[m, n] each include a transistor F1, a transistor F2, and a capacitor C5, and the cell IMref[1] to the cell IMref[m] each include a transistor F1m, a transistor F2m, and a capacitor C5m, for example.

In particular, the sizes (e.g., channel length and channel width) and configurations of the transistors F1 included in the cell IM[1, 1] to the cell IM[m, n] are preferably equal to each other, and the sizes of the transistors F2 included in the cell IM[1, 1] to the cell IM[m, n] are preferably equal to each other. The sizes of the transistors F1m included in the cell IMref[1] to the cell IMref[m] are preferably equal to each other, and the sizes of the transistors F2m included in the cell IMref[1] to the cell IMref[m] are preferably equal to each other. The size of the transistor F1 is preferably equal to that of the transistor F1m, and the size of the transistor F2 is preferably equal to that of the transistor F2m.

By making the transistors have the same size, each transistor can have almost the same electrical characteristics. By making the transistors F1 included in the cell IM[1, 1] to the cell IM[m, n] have the same size and the transistors F2 included in the cell IM[1, 1] to the cell IM[m, n] have the same size, each of the cell IM[1, 1] to the cell IM[m, n] can exhibit almost the same performance in the same condition with each other. The same condition means, for example, input potentials to a source, a drain, and a gate of the transistor F1, input potentials to a source, a drain, and a gate of the transistor F2, and a voltage input to each of the cell IM[1, 1] to the cell IM[m, n]. By making the transistors F1m included in the cell IMref[1] to the cell IMref[m] have the same size and the transistors F2m included in the cell IMref[1] to the cell IMref[m] have the same size, the cell IMref[1] to the cell IMref[m] can perform almost the same operation and have almost the same results of the operation. In the case of the same condition, the cell IMref[1] to the cell IMref[m] can exhibit almost the same performance. The same condition means, for example, input potentials to a source, a drain, and a gate of the transistor F1m, input potentials to a source, a drain, and a gate of the transistor F2m, and a voltage input to each of the cell IMref[1] to the cell IMref[m].

Unless otherwise specified, the transistor F1 and the transistor F1m in an on state may operate in a linear region in the end. In other words, the gate voltage, the source voltage, and the drain voltage of each of the above-described transistors may be within the range where the transistor operates in the linear region. However, one embodiment of the present invention is not limited thereto. For example, the transistor F1 and the transistor F1m in an on state may operate in a saturation region or may operate both in a linear region and a saturation region.

Unless otherwise specified, the transistor F2 and the transistor F2m may operate in a subthreshold region (i.e., voltage between the gate and the source of the transistor F2 or the transistor F2m may be lower than the threshold voltage, preferably drain voltage exponentially increases with respect to the voltage between the gate and the source). In other words, the gate voltage, the source voltage, and the drain voltage of each of the above-described transistors may be within the range where the transistor operates in the subthreshold region. Thus, the transistors F2 and the transistor F2m may operate so that off-state current flows between the source and the drain.

The transistor F1 and the transistor F1m are preferably OS transistors, for example. In addition, it is further preferable that a channel formation region in the transistor F1 and the transistor F1m be an oxide including at least one of indium, gallium, and zinc. Instead of the oxide, an oxide including at least one of indium, an element M (as the element M, for example, one or more of kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, cobalt, magnesium, and antimony can be given), and zinc may be used.

With the use of an OS transistor as the transistor F1 and the transistor F1m, the off-state current of the transistor F1 and the transistor F1m can be inhibited, so that the power consumption of the arithmetic circuit can be reduced. Specifically, in the case where the transistor F1 and the transistor F1m are in a non-conduction state, current that leaks from a retention node to the wiring WCL or the wiring XCL can be extremely small and thus the frequency of refresh operation for the potential of the retention node can be reduced. By reducing the frequency of refresh operations, power consumption of the arithmetic circuit can be reduced. An extremely low leakage current from the retention node to the wiring WCL or the wiring XCL allows cells to retain the potential of the retention node for a long time, increasing the arithmetic operation accuracy of the arithmetic circuit.

The use of an OS transistor also as the transistor F2 and the transistor F2m enable operation with a wide range of current in the subthreshold region, leading to a reduction in power consumption. By using an OS transistor also as the transistor F2 and the transistor F2m, the transistor F2 and the transistor F2m can be manufactured concurrently with the transistor F1 and the transistor F1m, and thus the number of manufacturing steps of the arithmetic circuit can be decreased in some cases. The transistor F2 and the transistor F2m can be, other than an OS transistor, a transistor including silicon in its channel formation region (hereinafter referred to as a Si transistor). As the silicon, amorphous silicon (referred to as hydrogenated amorphous silicon in some cases), microcrystalline silicon, polycrystalline silicon, single crystal silicon, or the like can be used, for example.

For example, when a semiconductor device or the like is highly integrated into a chip or the like, the chip may have heat when the circuit operates. This heat makes the temperature of a transistor rise to change the characteristics of the transistor and the field-effect mobility thereof may change or the operation frequency thereof may decrease. Since an OS transistor has higher heat resistance than a Si transistor, a change in field-effect mobility and a decrease in operation frequency due to a temperature change do not easily occur. Even when having a high temperature, an OS transistor is likely to keep a property of the drain current increasing exponentially with respect to the gate-source voltage. With the use of an OS transistor, even in a high temperature environment, an arithmetic operation, processing, or the like can be easily performed. To form a semiconductor device highly resistant to heat due to driving, an OS transistor is preferably used as its transistor.

In each of the cell IM[1, 1] to the cell IM[m, n], a first terminal of the transistor F1 is electrically connected to a gate of the transistor F2. A first terminal of the transistor F2 is electrically connected to a wiring VE. A first terminal of the capacitor C5 is electrically connected to the gate of the transistor F2.

In each of the cell IMref[1] to the cell IMref[m], a first terminal of the transistor F1m is electrically connected to a gate of the transistor F2m. A first terminal of the transistor F2m is electrically connected to the wiring VE. A first terminal of the capacitor C5m is electrically connected to the gate of the transistor F2m.

In each of the transistor F1, the transistor F2, the transistor F1m, and the transistor F2m in FIG. 5, a back gate is shown but the connection structure of the back gate is not shown; however, a point to which the back gate is electrically connected can be determined at the design stage. For example, in a transistor including a back gate, a gate and the back gate may be electrically connected to each other to increase the on-state current (reduce the on resistance) of the transistor. For example, the gate and the back gate of the transistor F1 may be electrically connected to each other, and the gate and the back gate of the transistor F1m may be electrically connected to each other. Furthermore, for example, in a transistor including a back gate, a wiring electrically connecting the back gate of the transistor to an external circuit or the like may be provided and a potential may be supplied to the back gate of the transistor with the external circuit or the like to change the threshold voltage of the transistor or to reduce the off-state current of the transistor.

The transistor F1 and the transistor F2 shown in FIG. 5 have back gates; however, the semiconductor device of one embodiment of the present invention is not limited thereto. For example, the transistor F1 and the transistor F2 shown in FIG. 5 may each be a transistor having a structure not including a back gate, that is, a single-gate structure. It is also possible that some transistors have a structure including a back gate and the other transistors have a structure not including a back gate.

The transistor F1 and the transistor F2 shown in FIG. 5 are n-channel transistors; however, the semiconductor device of one embodiment of the present invention is not limited thereto. For example, some or all of the transistors F1 and the transistors F2 may be replaced with p-channel transistors. When some or all of the transistors F1 and the transistors F2 are replaced with p-channel transistors, a potential applied by a wiring, a potential of a node NN, a potential of a node NNref, and the like, which are described in this specification and the like, can be changed as appropriate for the sake of desired operations of the transistor F1 and the transistor F2.

The above-described examples of changes in the configurations or the polarities of the transistor are not limited to the transistor F1 and the transistor F2. For example, the configurations or the polarities of the transistor F1m and the transistor F2m, a transistor F3[1] to a transistor F3[n] and a transistor F4[1] to a transistor F4[n] which are described later, a transistor described in other parts of this specification and the like, and a transistor shown in other drawings can be changed.

The wiring VE functions as a wiring for supplying current between the first terminal and a second terminal of the transistor F2 of each of the cell IM[1, 1], the cell IM[m, 1], the cell IM[1, n], and the cell IM[m, n] and a wiring for supplying current between the first terminal and a second terminal of the transistor F2m of each of the cell IMref[1] and the cell IMref[m]. The wiring VE functions as a wiring for supplying a constant potential, for example. The constant potential can be, for example, a low-level potential, a ground potential, or the like.

In the cell IM[1, 1], a second terminal of the transistor F1 is electrically connected to a wiring WCL[1], and a gate of the transistor F1 is electrically connected to a wiring WSL[1]. The second terminal of the transistor F2 is electrically connected to the wiring WCL[1], and a second terminal of the capacitor C5 is electrically connected to the wiring XCL[1]. In FIG. 5, in the cell IM[1, 1], a connection portion of the first terminal of the transistor F1, the gate of the transistor F2, and the first terminal of the capacitor C5 is a node NN[1, 1].

In the cell IM[m, 1], the second terminal of the transistor F1 is electrically connected to the wiring WCL[1], and the gate of the transistor F1 is electrically connected to a wiring WSL[m]. The second terminal of the transistor F2 is electrically connected to the wiring WCL[1], and the second terminal of the capacitor C5 is electrically connected to the wiring XCL[m]. In FIG. 5, in the cell IM[m, 1], a connection portion of the first terminal of the transistor F1, the gate of the transistor F2, and the first terminal of the capacitor C5 is a node NN[m, 1].

In the cell IM[1, n], the second terminal of the transistor F1 is electrically connected to a wiring WCL[n], and the gate of the transistor F1 is electrically connected to the wiring WSL[1]. The second terminal of the transistor F2 is electrically connected to the wiring WCL[n], and the second terminal of the capacitor C5 is electrically connected to the wiring XCL[1]. In FIG. 5, in the cell IM[1, n], a connection portion of the first terminal of the transistor F1, the gate of the transistor F2, and the first terminal of the capacitor C5 is a node NN[1, n].

In the cell IM[m, n], the second terminal of the transistor F1 is electrically connected to the wiring WCL[n], and the gate of the transistor F1 is electrically connected to the wiring WSL[m]. The second terminal of the transistor F2 is electrically connected to the wiring WCL[n], and the second terminal of the capacitor C5 is electrically connected to the wiring XCL[m]. In FIG. 5, in the cell IM[m, n], a connection portion of the first terminal of the transistor F1, the gate of the transistor F2, and the first terminal of the capacitor C5 is a node NN[m, n].

In the cell IMref[1], a second terminal of the transistor F1m is electrically connected to the wiring XCL[1], and a gate of the transistor F1m is electrically connected to the wiring WSL[1]. A second terminal of the transistor F2m is electrically connected to the wiring XCL[1], and the second terminal of the capacitor C5 is electrically connected to the wiring XCL[1]. In FIG. 5, in the cell IMref[1], a connection portion of a first terminal of the transistor F1m, a gate of the transistor F2m, and the first terminal of the capacitor C5 is a node NNref[1].

In the cell IMref[m], the second terminal of the transistor F1m is electrically connected to the wiring XCL[m], and the gate of the transistor F1m is electrically connected to the wiring WSL[m]. A second terminal of the transistor F2m is electrically connected to the wiring XCL[m], and the second terminal of the capacitor C5 is electrically connected to the wiring XCL[m]. In FIG. 5, in the cell IMref[m], a connection portion of the first terminal of the transistor F1m, the gate of the transistor F2m, and the first terminal of the capacitor C5 is a node NNref[m].

The node NN[1, 1] to the node NN[m, n], and the node NNref[1] to the node NNref[m] function as retention nodes of cells.

In the case where the transistor F1 is turned on in the cell IM[1, 1] to the cell IM[m, n], for example, the transistor F2 is a diode-connected transistor. When a constant potential supplied by the wiring VE is a ground potential (GND), the transistor F1 is turned on, and current with a current amount I flows from the wiring WCL to the second terminal of the transistor F2, the potential of the gate of the transistor F2 (node NN) is determined by the current amount I. Since the transistor F1 is in the on state, the potential of the second terminal of the transistor F2 is ideally equal to that of the gate of the transistor F2 (node NN). By turning off the transistor F1, the potential of the gate of the transistor F2 (node NN) is retained. Accordingly, the transistor F2 can supply, between a source and a drain of the transistor F2, current with the current amount I, which is current corresponding to the ground potential of the first terminal of the transistor F2 and the potential of the gate of the transistor F2 (node NN). In this specification and the like, the operation is called “setting (programing) the amount of current flowing between the source and the drain of the transistor F2 in the cell IM to I”, for example.

For example, the circuit SWS1 includes the transistor F3[1] to the transistor F3[n]. A first terminal of the transistor F3[1] is electrically connected to the wiring WCL[1], a second terminal of the transistor F3[1] is electrically connected to the circuit WCS, and a gate of the transistor F3[1] is electrically connected to a wiring SWL1. A first terminal of the transistor F3[n] is electrically connected to the wiring WCL[n], a second terminal of the transistor F3[n] is electrically connected to the circuit WCS, and a gate of the transistor F3[n] is electrically connected to a wiring SWL1.

As each of the transistor F3[1] to the transistor F3[n], for example, a transistor which can be used as the transistor F1 or the transistor F2 can be used. It is particularly preferable to use an OS transistor as each of the transistor F3[1] to the transistor F3[n].

The circuit SWS1 functions as a circuit that switches the conduction state and the non-conduction state between the circuit WCS and each of the wiring WCL[1] to the wiring WCL[n].

For example, the circuit SWS2 includes the transistor F4[1] to the transistor F4[n]. A first terminal of the transistor F4[1] is electrically connected to the wiring WCL[1], a second terminal of the transistor F4[1] is electrically connected to an input terminal of the converter circuit ITRZ[1], and a gate of the transistor F4[1] is electrically connected to a wiring SWL2. A first terminal of the transistor F4[n] is electrically connected to the wiring WCL[n], a second terminal of the transistor F4[n] is electrically connected to an input terminal of the converter circuit ITRZ[n], and a gate of the transistor F4[n] is electrically connected to a wiring SWL2.

As each of the transistor F4[1] to the transistor F4[n], for example, a transistor which can be used as the transistor F1 or the transistor F2 can be used. It is particularly preferable to use an OS transistor as each of the transistor F4[1] to the transistor F4[n].

The circuit SWS2 has a function of switching the conduction state and the non-conduction state between the wiring WCL[1] and the converter circuit ITRZ[1] and between the wiring WCL[n] and the converter circuit ITRZ[n].

The circuit WCS has a function of supplying data that is to be stored in each memory cell included in the cell array CA.

The circuit XCS is electrically connected to the wiring XCL[1] to the wiring XCL[m]. The circuit XCS has a function of supplying current with the amount corresponding to reference data (also referred to as reference current) described later or current with the amount corresponding to the second data to each of the cell IMref[1] to the cell IMref[m] included in the cell array CA.

The circuit WSD is electrically connected to the wiring WSL[1] to the wiring WSL[m]. The circuit WSD has a function of selecting a row of the cell array CA to which first data is written by supplying a predetermined signal to each of the wiring WSL[1] to the wiring WSL[m] when the first data is written to the cell IM[1, 1] to the cell IM[m, n]. The wiring WSL[1] to the wiring WSL[m] function as write word lines.

For example, the circuit WSD is electrically connected to the wiring SWL1 and the wiring SWL2. The circuit WSD has a function of establishing electrical continuity and discontinuity between the circuit WCS and the cell array CA by supplying a predetermined signal to the wiring SWL1 and a function of establishing electrical continuity and discontinuity between the converter circuit ITRZ[1] to the converter circuit ITRZ[n] and the cell array CA by supplying a predetermined signal to the wiring SWL2.

The circuit ITS includes a converter circuit ITRZ[1] to a converter circuit ITRZ[n], for example.

The converter circuit ITRZ[1] to the converter circuit ITRZ[n] each include an input terminal and an output terminal, for example. For example, an output terminal of the converter circuit ITRZ[1] is electrically connected to a wiring OL[1], and an output terminal of the converter circuit ITRZ[n] is electrically connected to a wiring OL[n].

The converter circuit ITRZ[1] to the converter circuit ITRZ[n] each have a function of converting a current input to input terminals into voltage according to the amount of the current and outputting the voltage from output terminals. Examples of the voltage can be an analog voltage, a digital voltage, and the like. The converter circuit ITRZ[1] to the converter circuit ITRZ[n] may each have an arithmetic circuit of a function system. In that case, for example, the arithmetic circuit may perform an arithmetic operation of a function using the converted voltage and outputs the results to the wiring OL[1] to the wiring OL[n].

In the case of performing an arithmetic operation of the hierarchical neural network, a sigmoid function, a tanh function, a softmax function, a ReLU function, a threshold function, or the like can be used as the above described function.

### <<Circuit WCS, Circuit XCS>>

Specific examples of the circuit WCS and the circuit XCS are described.

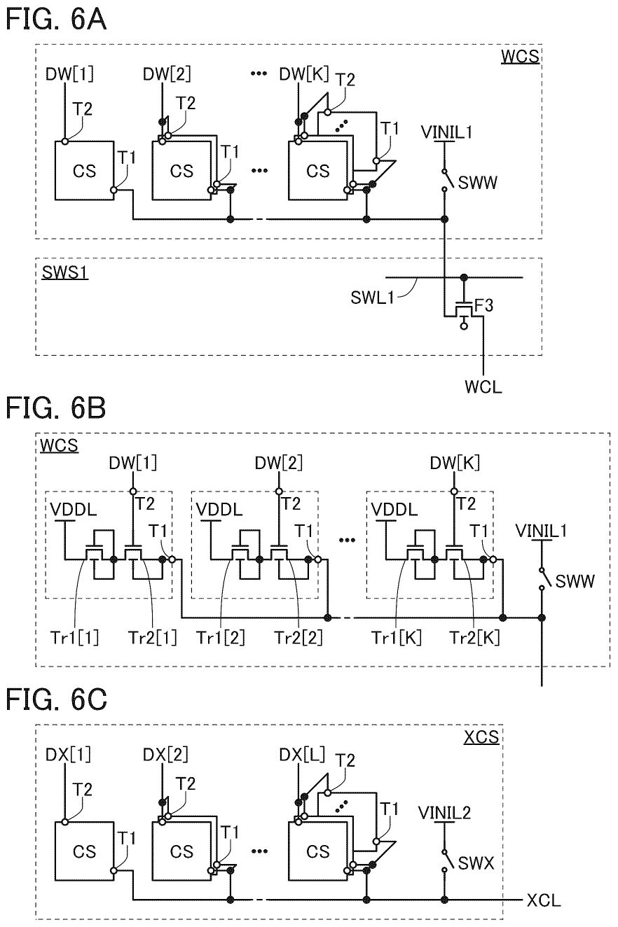

First, the circuit WCS is described. FIG. 6A is a block diagram showing an example of the circuit WCS. In FIG. 6A, to show the electrical connection between the circuit WCS and its nearby circuits, the circuit SWS1, the transistor F3, the wiring SWL1, and the wiring WCL are shown. The transistor F3 is any one of the transistor F3[1] to the transistor F3[n] included in the arithmetic circuit MAC1 in FIG. 5, and the wiring WCL is any one of the wiring WCL[1] to the wiring WCL[n] included in the arithmetic circuit MAC1 in FIG. 5.

The circuit WCS shown in FIG. 6A includes a switch SWW, for example. A first terminal of the switch SWW is electrically connected to a second terminal of the transistor F3, and a second terminal of the switch SWW is electrically connected to a wiring VINIL1. The wiring VINIL1 functions as a wiring for supplying an initialization potential to the wiring WCL, and the initialization potential can be set to a ground potential (GND), a low-level potential, and a high-level potential, for example. The switch SWW is turned on only when the initialization potential is supplied to the wiring WCL; otherwise, the switch is turned off.

As the switch SWW, an electrical switch such as an analog switch or a transistor can be used, for example. When a transistor is used as the switch SWW, for example, the transistor can have a structure similar to that of the transistor F1 and the transistor F2. A mechanical switch may be used other than the electrical switch.

The circuit WCS in FIG. 6A includes a plurality of current sources CS as an example. Specifically, the circuit WCS has a function of outputting K-bit first data (2^{K} values) (K is an integer of 1 or more) as the current amount, and the circuit WCS includes 2^{K}−1 current sources CS at that time. The circuit WCS includes one current source CS which outputs data corresponding to the first bit value as current, two current sources CS which output data corresponding to the second bit value as current, and 2^{K}−1 current sources CS which output data corresponding to the K-th bit value as current.

Each current source CS in FIG. 6A includes a terminal T1 and a terminal T2. The terminal T1 of each of the current sources CS is electrically connected to the second terminal of the transistor F3 included in the circuit SWS1. The terminal T2 of the one current source CS is electrically connected to a wiring DW[1], the terminals T2 of the two current sources CS are electrically connected to a wiring DW[2], and the terminals T2 of the 2^{K-1} current sources CS are electrically connected to a wiring DW[K].

The plurality of current sources CS included in the circuit WCS has a function of outputting the same constant current I_{Wut} from the terminals T1. In practice, at the manufacturing stage of the arithmetic circuit CDV, the transistors included in the current sources CS may have different electrical characteristics; this may yield errors. The errors of the constant current I_{Wut} output from the terminals T1 of the plurality of current sources CS are preferably within 10%, more preferably within 5%, and further preferably within 1%. In this embodiment, the description is made based on the assumption that there is no error in the constant current I_{Wut} output from the terminals T1 of the plurality of current sources CS included in the circuit WCS.

The wiring DW[1] to the wiring DW[K] function as wirings for transmitting control signals to make the current sources CS, which are electrically connected to the wiring DW[1] to the wiring DW[K], output the constant current I_{Wut}. Specifically, for example, when a high-level potential is supplied to the wiring DW[1], the current source CS electrically connected to the wiring DW[1] supplies I_{Wut} as constant current to the second terminal of the transistor F3, and when a low-level potential is supplied to the wiring DW[1], the current source CS electrically connected to the wiring DW[1] does not output I_{Wut}. For example, when a high-level potential is supplied to the wiring DW[2], the two current sources CS electrically connected to the wiring DW[2] supply the sum of 2 I_{Wut} as constant current to the second terminal of the transistor F3, and when a low-level potential is supplied to the wiring DW[2], the current sources CS electrically connected to the wiring DW[2] do not output the sum of 2 I_{Wut}. For example, when a high-level potential is supplied to the wiring DW[K], the 2^{K-1} current sources CS electrically connected to the wiring DW[K] supply the sum of 2^{K-1}I_{Wut} as constant current to the second terminal of the transistor F3, and when a low-level potential is supplied to the wiring DW[K], the current sources CS electrically connected to the wiring DW[K] do not output the sum of 2^{K-1}I_{Wut}.

The current flowing from the one current source CS electrically connected to the wiring DW[1] corresponds to the value of the first bit, the current flowing from the two current sources CS electrically connected to the wiring DW[2] corresponds to the value of the second bit, and the current amount flowing from the K current sources CS electrically connected to the wiring DW[K] corresponds to the value of the K-th bit. The circuit WCS with K of 2 is considered. For example, when the value of the first bit is “1” and the value of the second bit is “0”, a high-level potential is supplied to the wiring DW[1], and a low-level potential is supplied to the wiring DW[2]. In this case, the constant current I_{Wut} flows into the second terminal of the transistor F3 of the circuit SWS1 from the circuit WCS. For example, when the value of the first bit is “0” and value of the second bit is “1”, a low-level potential is supplied to the wiring DW[1], and a high-level potential is supplied to the wiring DW[2]. In this case, the constant current 2I_{Wut} flows from the circuit WCS to the second terminal of the transistor F3 of the circuit SWS1. For example, when the value of the first bit is “1” and the value of the second bit is “1”, a high-level potential is supplied to the wiring DW[1] and the wiring DW[2]. In this case, the constant current 3I_{Wut} flows from the circuit WCS to the second terminal of the transistor F3 of the circuit SWS1. For example, when the value of the first bit is “0” and the value of the second bit is “0”, a low-level potential is supplied to the wiring DW[1] and the wiring DW[2]. In this case, the constant current does not flow from the circuit WCS into the second terminal of the transistor F3 of the circuit SWS1.

FIG. 6A shows the circuit WCS when K is an integer of 3 or more; when K is 1, the current sources CS electrically connected to the wiring DW[2] to the wiring DW[K] are not provided in the circuit WCS in FIG. 6A. When K is 2, the current sources CS electrically connected to the wiring DW[3] (not shown) to the wiring DW[K] are not provided in the circuit WCS in FIG. 6A.

Next, a specific configuration example of the current source CS is described.

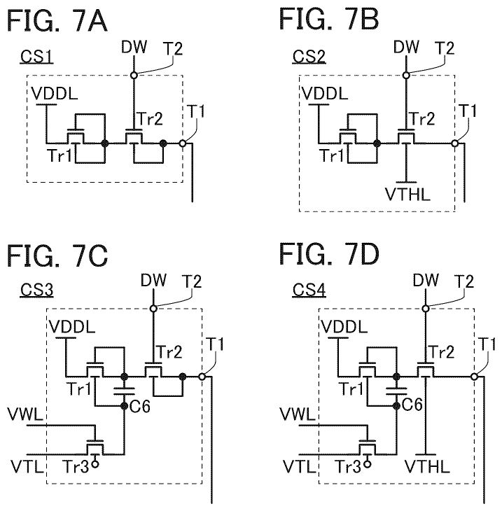

A current source CS1 shown in FIG. 7A can be used as the current source CS included in the circuit WCS in FIG. 6A; the current source CS1 includes a transistor Tr1 and a transistor Tr2.

A first terminal of the transistor Tr1 is electrically connected to a wiring VDDL, and a second terminal of the transistor Tr1 is electrically connected to a gate of the transistor Tr1, a back gate of the transistor Tr1, and a first terminal of the transistor Tr2. A second terminal of the transistor Tr2 is electrically connected to a back gate of the transistor Tr2 and the terminal T1, and a gate of the transistor Tr2 is electrically connected to the terminal T2. The terminal T2 is electrically connected to the wiring DW.

The wiring DW is any one of the wiring DW[1] to the wiring DW[K] in FIG. 2A.

The wiring VDDL functions as a wiring for supplying a constant potential. The constant potential can be a high-level potential or the like.

When a constant potential supplied by the wiring VDDL is set at a high-level potential, a high-level potential is input to the first terminal of the transistor Tr1. The potential of the second terminal of the transistor Tr1 is lower than the high-level potential. At this time, the first terminal of the transistor Tr1 functions as a drain, and the second terminal of the transistor Tr1 functions as a source. Since the gate of the transistor Tr1 and the second terminal of the transistor Tr1 are electrically connected to each other, the gate-source voltage of the transistor Tr1 is 0 V. When the threshold voltage of the transistor Tr1 is within an appropriate range, current in the current range in which the transistor Tr1 operates in the subthreshold region flows between the first terminal and the second terminal of the transistor Tr1. The amount of the current is preferably smaller than or equal to 1.0×10⁻⁸ A, more preferably smaller than or equal to 1.0×10⁻¹² A, and further more preferably smaller than or equal to 1.0×10⁻¹⁵ A when the transistor Tr1 is an OS transistor. For example, the current is preferably within a range in which the current exponentially increases with respect to a gate-source voltage. The transistor Tr1 functions as a current source to supply current within a current range of the transistor Tr1 operating in the subthreshold region. The current corresponds to the above-described I_{Wut} or I_{Xut} described later.

The transistor Tr2 functions as a switching element. When the potential of the first terminal of the transistor Tr2 is higher than the potential of the second terminal of the transistor Tr2, the first terminal of the transistor Tr2 functions as a drain and the second terminal of the transistor Tr2 functions as a source. Since a back gate of the transistor Tr2 and the second terminal of the transistor Tr2 are electrically connected to each other, a back gate-source voltage becomes 0 V. When the threshold voltage of the transistor Tr2 is within an appropriate range and a high-level potential is input to the gate of the transistor Tr2, the transistor Tr2 is turned on, and when a low-level potential is input to the gate of the transistor Tr2, the transistor Tr2 is turned off. Specifically, when the transistor Tr2 is in the on state, current within the current range in which the transistor Tr2 operates in the subthreshold region flows from the second terminal of the transistor Tr1 to the terminal T1, and when the transistor Tr2 is in the off state, the current does not flow from the second terminal of the transistor Tr1 to the terminal T1.

As each of the transistor Tr1 and the transistor Tr2, a Si transistor or an OS transistor can be used, for example. As another example, the transistor usable for the transistor F1, the transistor F2, the transistor F3, or the transistor F4 can be used.

The circuit that can be used for the current source CS included in the circuit WCS in FIG. 6A is not limited to the current source CS1 in FIG. 7A. For example, in the current source CS1, the back gate of the transistor Tr2 and the second terminal of the transistor Tr2 are electrically connected, but the back gate of the transistor Tr2 may be electrically connected to another wiring. Such a configuration example is shown in FIG. 7B. In a current source CS2 shown in FIG. 7B, the back gate of the transistor Tr2 is electrically connected to a wiring VTHL. When the wiring VTHL of the current source CS2 is electrically connected to an external circuit or the like, the external circuit supplies a predetermined potential to the wiring VTHL and the back gate of the transistor Tr2 can be supplied with the predetermined potential. This can change the threshold voltage of the transistor Tr2. The off-state current of the transistor Tr2 can be reduced by increasing the threshold voltage of the transistor Tr2.

For example, in the current source CS1, the back gate of the transistor Tr1 and the second terminal of the transistor Tr1 are electrically connected; however, the voltage between the back gate and the second terminal of the transistor Tr1 can be retained with a capacitor. Such a configuration example is shown in FIG. 7C. A current source CS3 shown in FIG. 7C includes a transistor Tr3 and a capacitor C6 in addition to the transistor Tr1 and the transistor Tr2. The current source CS3 is different from the current source CS1 in that the second terminal of the transistor Tr1 and the back gate of the transistor Tr1 are electrically connected through the capacitor C6, and the back gate of the transistor Tr1 and a first terminal of the transistor Tr3 are electrically connected. In the current source CS3, a second terminal of the transistor Tr3 is electrically connected to a wiring VTL, and a gate of the transistor Tr3 is electrically connected to a wiring VWL. In the current source CS3, the wiring VWL is supplied with a high-level potential to turn the transistor Tr3 on, so that the wiring VTL and the back gate of the transistor Tr1 can be in the conduction state. In this case, a predetermined potential can be input to the back gate of the transistor Tr1 from the wiring VTL. By supplying a low-level potential to the wiring VWL to turn the transistor Tr3 off, voltage between the second terminal of the transistor Tr1 and the back gate of the transistor Tr1 can be retained with the capacitor C6. The threshold voltage of the transistor Tr1 can be changed by setting the potential supplied to the back gate of the transistor Tr1 with the wiring VTL, and the threshold voltage of the transistor Tr1 can be fixed with the transistor Tr3 and the capacitor C6.

For example, a current source CS4 shown in FIG. 7D can be used as the current source CS included in the circuit WCS in FIG. 6A. In the current source CS4, the back gate of the transistor Tr2 is electrically connected not to the second terminal of the transistor Tr2 as in the current source CS3 in FIG. 7C but to the wiring VTHL. The current source CS4 can change the threshold voltage of the transistor Tr2 with the potential supplied by the wiring VTHL, as in the current source CS2 in FIG. 7B.

When large current flows between the first terminal and the second terminal of the transistor Tr1 in the current source CS4, the on resistance of the transistor Tr2 needs to be reduced to supply the current from the terminal T1 out of the current source CS4. In this case, in the current source CS4, the wiring VTHL is supplied with a high-level potential to decrease the threshold voltage of the transistor Tr2 and reduce the on resistance of the transistor Tr2, whereby large current flowing between the first terminal and the second terminal of the transistor Tr1 can be supplied from the terminal T1 out of the current source CS4.

By using the current source CS1 to the current source CS4 shown in FIG. 7A to FIG. 7D as the current sources CS included in the circuit WCS in FIG. 6A, the circuit WCS can output current corresponding to the K-bit first data. The above-mentioned current amount can be the amount of current flowing between the first terminal and the second terminal of the transistor Tr1 that operates within the subthreshold region.

As the circuit WCS in FIG. 6A, the circuit WCS shown in FIG. 6B can be used. In the circuit WCS in FIG. 6B, one current source CS in FIG. 7A is connected to each of the wiring DW[1] to the wiring DW[K]. Note that FIG. 6B shows a transistor Tr1[1] and a transistor Tr2[1] which are included in the current source WCS connected to the wiring DW[1], a transistor Tr1[2] and a transistor Tr2[2] which are included in the current source WCS connected to the wiring DW[2], and a transistor Tr1[K] and a transistor Tr2[K] which are included in the current source WCS connected to the wiring DW[K]. When the channel width of a transistor Tr1[1] is w[1], the channel width of a transistor Tr1[2] is w[2], and the channel width of a transistor Tr1[K] is w[K], the ratio of the channel widths is w[1]:w[2]:w[K]=1:2:2^{K-1}. Since current flowing between a source and a drain of a transistor that operates in the subthreshold region is proportional to the channel width, the circuit WCS shown in FIG. 6B can output current corresponding to the K-bit first data like the circuit WCS in FIG. 6A.

As each of the transistors Tr1 (including the transistor Tr1[1] to the transistor Tr1[K]), the transistors Tr2 (including the transistor Tr2[1] to the transistor Tr2[K]), and the transistor Tr3, a Si transistor or an OS transistor can be used, for example. As another example, the transistor usable for the transistor F1, the transistor F2, the transistor F3, or the transistor F4 can be used.

Next, a specific example of the circuit XCS is described.

FIG. 6C is a block diagram showing an example of the circuit XCS. In FIG. 6C, to show the electrical connection between the circuit XCS and its nearby circuits, the wiring XCL is shown. The wiring XCL is any one of the wiring XCL[1] to the wiring XCL[m] included in the arithmetic circuit MAC1 in FIG. 5.

The circuit XCS shown in FIG. 6C includes a switch SWX, for example. A first terminal of the switch SWX is electrically connected to the wiring XCL and a plurality of current sources CS, and a second terminal of the switch SWX is electrically connected to a wiring VINIL2. The wiring VINIL2 functions as a wiring for supplying an initialization potential to the wiring XCL, and the initialization potential can be set to a ground potential (GND), a low-level potential, a high-level potential, or the like. The initialization potential supplied by the wiring VINIL2 can be the same as the potential supplied by the wiring VINIL1. The switch SWX is turned on only when the initialization potential is supplied to the wiring XCL; otherwise, the switch is turned off.

As the switch SWX, a switch that can be used as the switch SWW can be used, for example.

The circuit XCS in FIG. 6C can have almost the same configuration as that of the circuit WCS in FIG. 7A. Specifically, the circuit XCS has a function of outputting reference data as the current amount (reference current), and a function of outputting L-bit second data (2^{L} values) (L is an integer of 1 or more) as the current amount, and the circuit XCS includes 2^{L}−1 current sources CS at that time. The circuit XCS includes one current source CS which outputs current corresponding to data of the first bit value, two current sources CS which output current corresponding to data of the second bit value, and 2^{L-1} current sources CS which output current corresponding to data of the L-th bit value.

The reference data output by the circuit XCS as current can be data in which the first bit value is “1” and the second and subsequent bit values are “0”, for example.

In FIG. 6C, the terminal T2 of the one current source CS is electrically connected to a wiring DX[1], the terminals T2 of the two current sources CS are electrically connected to a wiring DX[2], and the terminals T2 of the 2^{L-1} current sources CS are electrically connected to a wiring DX[L].

The plurality of current sources CS included in the circuit XCS has a function of outputting the same constant current I_{Xut} from the terminals T1. The wiring DX[1] to the wiring DX[L] which are electrically connected to the current sources CS function as wirings for sending control signals to make the current sources CS output I_{Xut}. In other words, the circuit XCS has a function of supplying the current amount corresponding to the L-bit data sent from the wiring DX[1] to the wiring DX[L] to the wiring XCL.

Specifically, the circuit XCS with L of 2 is considered. For example, when the value of the first bit is “1” and the value of the second bit is “0”, a high-level potential is supplied to the wiring DX[1], and a low-level potential is supplied to the wiring DX[2]. In this case, the constant current I_{Xut} flows from the circuit XCS to the circuit XCL. For example, when the value of the first bit is “0” and the value of the second bit is “1”, a low-level potential is supplied to the wiring DX[1], and a high-level potential is supplied to the wiring DX[2]. In this case, the constant current 2I_{Xut} flows from the circuit XCS to the wiring XCL. For example, when the value of the first bit is “1” and the value of the second bit is “1”, a high-level potential is supplied to the wiring DX[1] and the wiring DX[2]. In this case, the constant current 3I_{Xut} flows from the circuit XCS to the wiring XCL. For example, when the value of the first bit is “0” and value of the second bit is “0”, a low-level potential is supplied to the wiring DX[1] and the wiring DX[2]. In this case, the constant current does not flow from the circuit XCS to the wiring XCL. In this case, in this specification and the like, it is also said that the current amount 0 flows from the circuit XCS to the wiring XCL, in some cases. The current amount output from the circuit XCS (e.g., 0, I_{Xut}, 2I_{Xut}, 3I_{Xut}, or the like) can be the second data output from the circuit XCS; particularly, the current amount I_{Xut} from the circuit XCS can be the reference data output from the circuit XCS.

When the transistors in the current sources CS included in the circuit XCS have different electrical characteristics and this yields errors, the errors of the constant current I_{Xut} output from the terminals T1 of the plurality of current sources CS are preferably within 10%, more preferably within 5%, and further preferably within 1%. In this embodiment, the description is made based on the assumption that there is no error in the constant current I_{Xut} output from the terminals T1 of the plurality of current sources CS included in the circuit XCS.

As the current source CS of the circuit XCS, any of the current source CS1 to the current source CS4 in FIG. 7A to FIG. 7D can be used as the current source CS of the circuit WCS. In that case, the wiring DW in FIG. 7A to FIG. 7D is replaced with the wiring DX. This allows the circuit XCS to supply current within the current range in which the transistors operate in the subthreshold region to the wiring XCL as the reference data or the L-bit second data.

As the circuit XCS in FIG. 6C, the circuit configuration similar to that of the circuit WCS shown in FIG. 6B can be used. In this case, the circuit WCS in FIG. 6B is replaced with the circuit XCS, the wiring DW[1] is replaced with the wiring DX[1], the wiring DW[2] is replaced with the wiring DX[2], the wiring DW[K] is replaced with the wiring DX[Z], the switch SWW is replaced with the switch SWX, and the wiring VINIL1 is replaced with the wiring VINIL2.

### <<Converter Circuit ITRZ[1] to Converter Circuit ITRZ[n]>>

A specific example of a circuit which can be used as the converter circuit ITRZ[1] to the converter circuit ITRZ[n] included in the arithmetic circuit MAC1 in FIG. 5 is described.

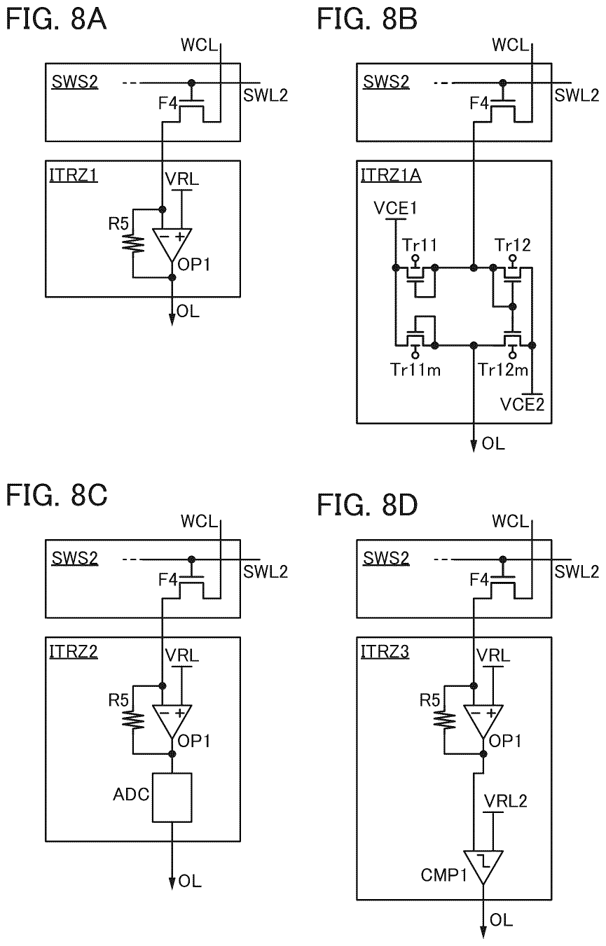

The converter circuit ITRZ1 in FIG. 8A is an example of a circuit which can be used as the converter circuit ITRZ[1] to the converter circuit ITRZ[n] in FIG. 5. In FIG. 8A, to show the electrical connection between the converter circuit ITRZ1 and its nearby circuits, the circuit SWS2, the wiring WCL, the wiring SWL2, and the transistor F4 are shown. The wiring WCL is any one of the wiring WCL[1] to the wiring WCL[n] included in the arithmetic circuit MAC1 in FIG. 5, and the transistor F4 is any one of the transistor F4[1] to the transistor F4[n] included in the arithmetic circuit MAC1 in FIG. 5.

The converter circuit ITRZ1 in FIG. 8A is electrically connected to the wiring WCL through the transistor F4. The converter circuit ITRZ1 is electrically connected to the wiring OL. The converter circuit ITRZ1 has a function of converting the amount of current flowing from the converter circuit ITRZ1 to the wiring WCL, or the amount of current flowing from the wiring WCL to the converter circuit ITRZ1 into an analog voltage and outputting the analog voltage to the wiring OL. The converter circuit ITRZ1 includes a current-voltage converter circuit.

The converter circuit ITRZ1 in FIG. 8A includes a resistor R5 and an operational amplifier OP1, for example.

An inverting input terminal of the operational amplifier OP1 is electrically connected to a first terminal of the resistor R5 and a second terminal of the transistor F4. A non-inverting input terminal of the operational amplifier OP1 is electrically connected to a wiring VRL. An output terminal of the operational amplifier OP1 is electrically connected to a second terminal of the resistor R5 and the wiring OL.

The wiring VRL functions as a wiring for supplying a constant potential. The constant potential can be a ground potential (GND) or a low-level potential, for example.

The converter circuit ITRZ1 with the configuration in FIG. 8A can convert the amount of current flowing from the wiring WCL to the converter circuit ITRZ1 through the transistor F4 or the amount of current flowing from the converter circuit ITRZ1 to the wiring WCL through the transistor F4 into an analog voltage to output it to the wiring OL.

In particular, by setting the constant potential supplied by the wiring VRL to a ground potential (GND), the inverting input terminal of the operational amplifier OP1 is virtually grounded, and the analog voltage output to the wiring OL can be a voltage with reference to the ground potential (GND).

Although the converter circuit ITRZ1 in FIG. 8A is configured to output analog voltage, the converter circuit ITRZ[1] to the converter circuit ITRZ[n] shown in FIG. 5 may be configured to output analog current.

A converter circuit ITRZ1A in FIG. 8B is a circuit for supplying the wiring OL with current with the same amount as the analog current flowing through the wiring WCL. The converter circuit ITRZ1A includes a transistor Tr11, a transistor Tr11m, a transistor Tr12, and a transistor Tr12m.

As each of the transistor Tr11, the transistor Tr11m, the transistor Tr12, and the transistor Tr12m, a Si transistor or an OS transistor can be used, for example. As another example, the transistor usable for the transistor F1, the transistor F2, the transistor F3, or the transistor F4 can be used.

A first terminal of the transistor Tr11 is electrically connected to a wiring VCE1; a second terminal of the transistor Tr11 is electrically connected to a gate of the transistor Tr11, a first terminal of the transistor Tr12, a gate of the transistor Tr12, a gate of the transistor Tr12m, and a second terminal of the transistor F4 in the circuit SWS2; and a second terminal of the transistor Tr12 is electrically connected to a wiring VCE2.

A first terminal of the transistor Tr11m is electrically connected to the wiring VCE; a second terminal of the transistor Tr11m is electrically connected to a gate of the transistor Tr11m, a first terminal of the transistor Tr12m, and the wiring OL; and a second terminal of the transistor Tr12m is electrically connected to the wiring VCE2.

The wiring VCE1 functions as a wiring supplying a potential to the first terminals of the transistor Tr11 and the transistor Tr11m. The constant potential can be a high-level potential, for example.

The wiring VCE2 functions as a wiring supplying a potential to the second terminals of the transistor Tr12 and the transistor Tr12m. The constant potential can be, for example, the ground potential, a low-level potential, or a negative potential.

The gate and the second terminal of each of the transistor Tr11 and the transistor Tr11m are electrically connected, and the first terminal thereof and the wiring VCE1 that supplies a high-level potential are electrically connected. Thus, the gate-source voltage of each of the transistor Tr11 and the transistor Tr11m is 0 V, and when the threshold voltages of the transistor Tr11 and the transistor Tr11m are within an appropriate range, current within the current range in which the transistors operate in the subthreshold region flows between the first terminal and the second terminal of each of the transistor Tr11 and the transistor Tr11m. In other words, the transistor Tr11 and the transistor Tr11m function as constant current sources.

In FIG. 8B, the first terminal of the transistor Tr12 is electrically connected to the gate of the transistor Tr12 and the gate of the transistor Tr12m; thus, the connection structure between the transistor Tr12 and the transistor Tr12m forms a current mirror circuit. In other words, ideally, the amount of current flowing between a source and a drain of the transistor Tr12 is equal to the amount of current flowing between a source and a drain of the transistor Tr12m.

The current mirror circuit formed with the connection between the transistor Tr12 and the transistor Tr12m in FIG. 8B may be replaced with a current mirror circuit with a cascode connection (not shown).

In the case where the amount of current flowing between the source and the drain of each of the transistor Tr11 and the transistor Tr11m is I_{SC} and the amount of current flowing from the circuit ITRZ1A to the wiring WCL is I_{OP} when the transistor F4 is in an on state, the amount of current flowing between a source and a drain of the transistor Tr12 is I_{SC}−I_{OP}. Accordingly, the amount of current flowing between the source and the drain of the transistor Tr11m is also I_{SC}−I_{OP}. Hence, the amount of current flowing from the circuit ITRZ1A to the wiring OL is I_{SC}−(I_{SC}−I_{OP})=I_{OP}. With such a configuration, the circuit ITRZ1A can output current with the amount equated with the amount of current flowing through the wiring WCL, to the wiring OL.

The circuit configuration applicable to the converter circuit ITRZ[1] to the converter circuit ITRZ[n] in FIG. 5 is not limited to the configuration of the converter circuit ITRZ1 outputting analog voltage in FIG. 8A and the converter circuit ITRZ1A outputting analog current in FIG. 8B. For example, the converter circuit ITRZ1 may include an analog-digital converter circuit ADC as shown in FIG. 8B. Specifically, in a converter circuit ITRZ2 in FIG. 8C, an input terminal of the analog-digital converter circuit ADC is electrically connected to an output terminal of the operational amplifier OP1 and the second terminal of the resistor R5, and an output terminal of the analog-digital converter circuit ADC is electrically connected to the wiring OL. With such a structure, the converter circuit ITRZD2 in FIG. 8C can output a digital signal to the wiring OL.

When the digital signal output to the wiring OL is 1 bit (binary) in the converter circuit ITRZ2, the converter circuit ITRZ2 may be replaced with a converter circuit ITRZ3 shown in FIG. 8D. The converter circuit ITRZ3 in FIG. 8D has a configuration in which the converter circuit ITRZ1 in FIG. 8A includes a comparator CMP1. Specifically, the converter circuit ITRZ3 has a configuration in which a first input terminal of the comparator CMP1 is electrically connected to the output terminal of the operational amplifier OP1 and the second terminal of the resistor R5, a second input terminal of the comparator CMP1 is electrically connected to a wiring VRL2, and an output terminal of the comparator CMP1 is electrically connected to the wiring OL. The wiring VRL2 functions as a wiring for supplying a potential compared to the potential of the first terminal of the comparator CMP1. With such a configuration, the converter circuit ITRZ3 in FIG. 8D can output a low-level potential or a high-level potential (a binary digital signal) to the wiring OL in accordance with the large-small relation between the voltage converted with the current-voltage converter circuit from the amount of current flowing between the source and the drain of the transistor F4 and the voltage supplied by the wiring VRL2.

The converter circuit ITRZ[1] to the converter circuit ITRZ[n] which can be used for the arithmetic circuit MAC1 in FIG. 5 are not limited to the converter circuit ITRZ1 to the converter circuit ITRZ3 shown in FIG. 8A to FIG. 8D. When the arithmetic circuit MAC1 is used for an arithmetic operation of the hierarchical neural network, for example, the converter circuit ITRZ1 to the converter circuit ITRZ3 preferably have arithmetic circuits of a function system. As an arithmetic circuit of a function system, an arithmetic circuit with a sigmoid function, a tanh function, a softmax function, a ReLU function, a threshold function, or the like can be used.

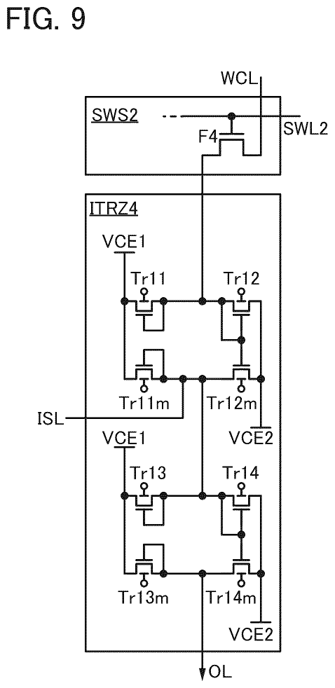

For example, when a ReLU function is employed for an arithmetic circuit of a function system, a converter circuit ITRZ4 shown in FIG. 9 may be used as each of the converter circuit ITRZ[1] to the converter circuit ITRZ[n].

The converter circuit ITRZ4 is a variation example of the converter circuit ITRZ1A in FIG. 8B, and the converter circuit ITRZ4 includes a transistor Tr13, a transistor Tr13m, a transistor Tr14, and a transistor Tr14m, in addition to the transistor Tr11, the transistor Tr11m, the transistor Tr12, and the transistor Tr12m.

As each of the transistor Tr13, the transistor Tr13m, the transistor Tr14, and the transistor Tr14m, a Si transistor or an OS transistor can be used, for example. As another example, the transistor usable for the transistor F1, the transistor F2, the transistor F3, or the transistor F4 can be used.

A first terminal of the transistor Tr13 is electrically connected to the wiring VCE1; a second terminal of the transistor Tr13 is electrically connected to a gate of the transistor Tr13, a first terminal of the transistor Tr14, a gate of the transistor Tr14, a gate of the transistor Tr14m, the second terminal of the transistor Tr11m, the gate of the transistor Tr11m, the first terminal of the transistor Tr12m, and a wiring ISL; and a second terminal of the transistor Tr14 is electrically connected to the wiring VCE2.

A first terminal of the transistor Tr13m is electrically connected to the wiring VCE1; a second terminal of the transistor Tr13m is electrically connected to a gate of the transistor Tr13m, a first terminal of the transistor Tr14m, and the wiring OL; and a second terminal of the transistor Tr14m is electrically connected to the wiring VCE2.

In other words, the transistor Tr13 and the transistor Tr13m in the converter circuit ITRZ4 each functions as a constant current source, like the transistor Tr11 and the transistor Tr11m. The transistor Tr14 and the transistor Tr14m in the converter circuit ITRZ4 each functions as a current mirror circuit, like the transistor Tr12 and the transistor Tr12m.

The wiring ISL functions as a wiring discharging constant current with a current amount I_{STD} from the converter circuit ITRZ4. I_{STD} corresponds to a reference value of a ReLU function in the converter circuit ITRZ4.

In the case where the current with the amount I_{OP} is output from the converter circuit ITRZ4 to the wiring WCL, the converter circuit ITRZ4 outputs the current with the amount I_{OP}−I_{STD} to the wiring OL when I_{OP} is larger than I_{STD}. When I_{OP} is less than or equal to I_{STD}, the converter circuit ITRZ4 does not output current to the wiring OL.

One embodiment of the present invention is not limited to the circuit configuration of the arithmetic circuit MAC1 described in this embodiment. The circuit configuration of the arithmetic circuit MAC1 can be changed depending on circumstances.

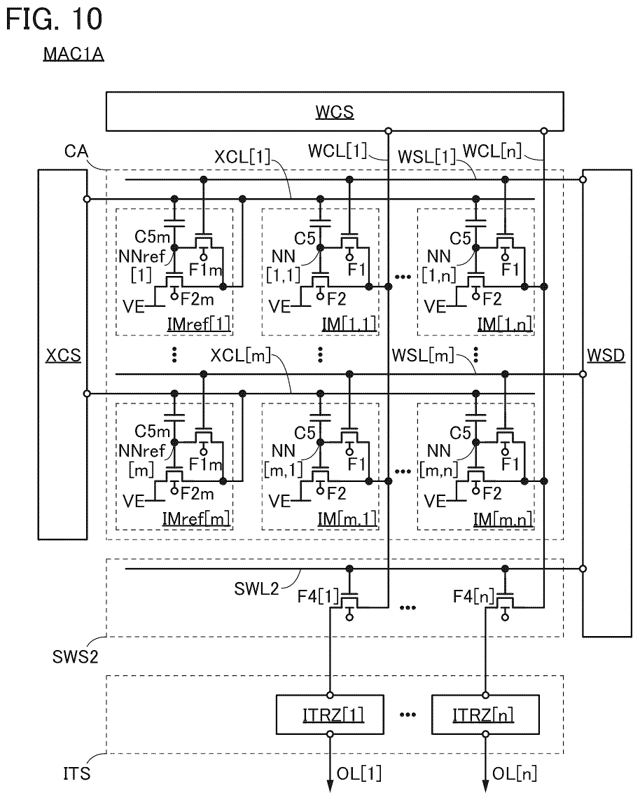

For example, the arithmetic circuit MAC1 may be changed to a configuration without the circuit SWS1 like an arithmetic circuit MAC1A shown in FIG. 10. The arithmetic circuit MAC1 can stop current flowing from the circuit WCS to the wiring WCL[1] to the wiring WCL[n] with the circuit SWS1; the arithmetic circuit MAC1A stops current flowing from the circuit WCS to the wiring WCL[1] to the wiring WCL[n] with the circuit WCS. Specifically, when the circuit WCS in FIG. 6A is used as the circuit WCS included in the arithmetic circuit MAC1A and the current source CS1 in FIG. 7A is used as the current source CS, a low-level potential is input to the wiring DW[1] to the wiring DW[K] and the switch SWW is turned off. By performing operations of the circuit WCS in this manner, current flowing from the circuit WCS to the wiring WCL[1] to the wiring WCL[n] can be stopped. In this manner, current flowing from the circuit WCS to the wiring WCL[1] to the wiring WCL[n] is stopped with the circuit WCS, whereby the arithmetic circuit MAC1A can be used instead of the arithmetic circuit MAC1 for an arithmetic operation.

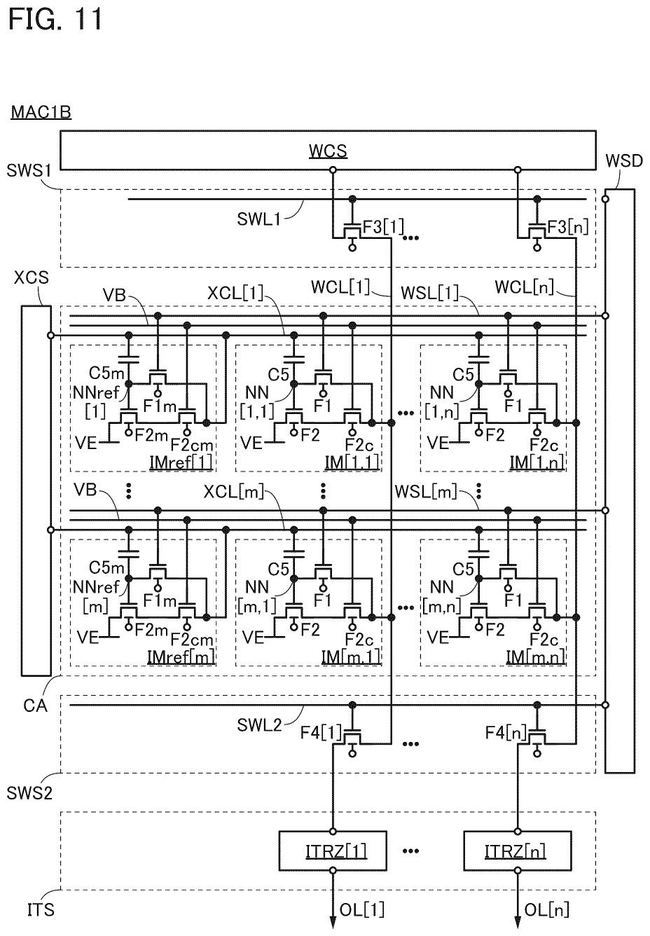

Alternatively, for example, the arithmetic circuit MAC1 may include a transistor F2c between the transistor F2 and the wiring WCL in each of the cells IM and a transistor F2cm between the transistor F2m and the wiring XCL in each of the cells IMref, like an arithmetic circuit MAC1B shown in FIG. 11. The transistor F2c and the transistor F2cm each function as a clamp transistor (also called a clamp FET in some cases), for example. Thus, a constant potential is preferably applied to the gates of the transistor F2c and the transistor F2cm. In FIG. 11, a wiring VB is electrically connected to the gates of the transistor F2c and the transistor F2cm, and as described above, the wiring VB is preferably supplied with a constant potential. Providing the transistor F2c and the transistor F2cm can prevent drain-induced barrier lowering (DIBL) in the transistor F2 and the transistor F2m.

As each of the transistor F2c and the transistor F2cm, for example, a transistor usable for each of the transistor F2 and the transistor F2m can be used.

### <Operation Example 1 of Arithmetic Circuit>

Next, an operation example of the arithmetic circuit MAC1 will be described.

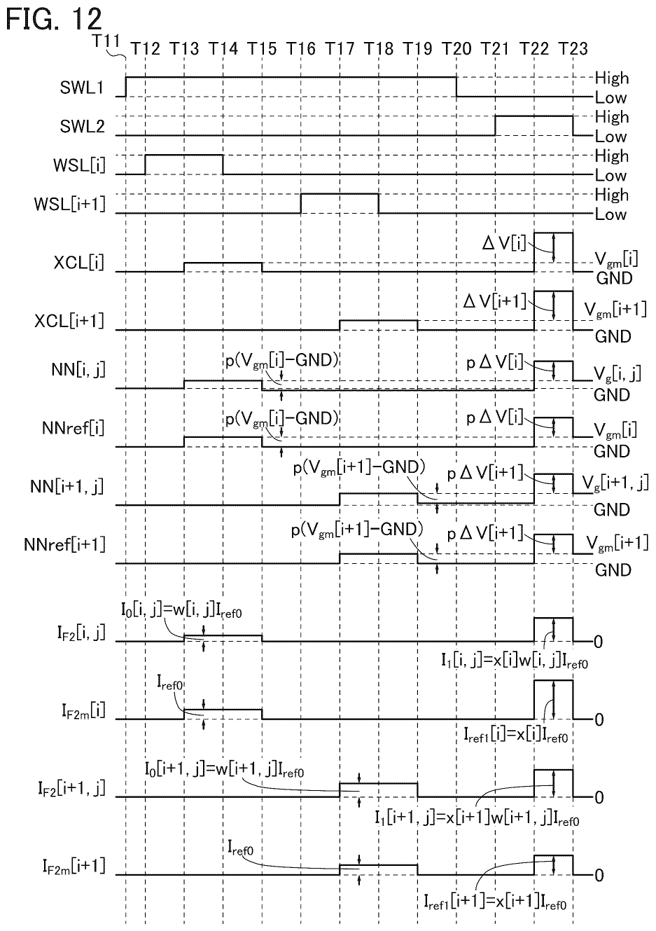

FIG. 12 is a timing chart showing an operation example of the arithmetic circuit MAC1. The timing chart in FIG. 12 shows changes in the potentials of the wiring SWL1, the wiring SWL2, the wiring WSL[i] (i is an integer greater than or equal to 1 and less than or equal to m−1), the wiring WSL[i+1], the wiring XCL[i], the wiring XCL[i+1], the node NN[i, j] (j is an integer greater than or equal to 1 and less than or equal to n−1), the node NN[i+1, j], the node NNref[i], and the node NNref[i+1] in the period from Time T11 to Time T23 and the vicinity thereof. The timing chart in FIG. 12 also shows changes in the amount of current I_{F2}[i, j] flowing between the first terminal and the second terminal of the transistor F2 included in the cell IM[i, j]; the amount of current I_{F2m}[i] flowing between the first terminal and the second terminal of the transistor F2m included in the cell IMref[i]; the amount of current I_{F2}[i+1, j] flowing between the first terminal and the second terminal of the transistor F2 included in the cell IM[i+1, j]; and the amount of current I_{F2m}[i+1] flowing between the first terminal and the second terminal of the transistor F2m included in the cell IMref[i+1]. Note that although not shown in FIG. 5 and the like, a given cell is denoted as a cell IM[i, 1], a cell IM[i, j], a cell IM[i, n], a cell IM[i+1, 1], a cell IM[i+1, j], a cell IM[i+1, n], or the like. In addition, i is an integer greater than or equal to 1 and less than or equal to m, and j is an integer greater than or equal to 1 and less than or equal to n. Moreover, a given cell is denoted as a cell IMref[i], a cell IMref[i+1], or the like. Furthermore, the node NN in a given cell is denoted as a node NN[i, 1], a node NN[i, n], a node NN[i+1, 1], a node NN[i+1, n], or the like. A given converter circuit ITRZ is denoted as a converter circuit ITRZ[j] or the like.

The circuit WCS in FIG. 6A is used as the circuit WCS of the arithmetic circuit MAC1, and the circuit XCS in FIG. 6C is used as the circuit XCS of the arithmetic circuit MAC1.

Note that in this operation example, the potential of the wiring VE is a ground potential GND. Before Time T11, each potential of the node NN[i, j], the node NN[i+1, j], the node NNref[i], and the node NNref[i+1] is the ground potential GND. Specifically, for example, the initialization potential of the wiring VINIL1 in FIG. 6A is set to the ground potential GND, and the switch SWW, the transistor F3, and each transistor F1 in the switch SWW, the transistor F3, the cell IM[i, j], and the cell IM[i+1, j] are turned on, whereby the potentials of the node NN[i, j] and the node NN[i+1, j] can be set to the ground potential GND. For example, the initialization potential of the wiring VINIL2 in FIG. 6C is set to the ground potential GND, and the switch SWX and each transistor F1m in the switch SWX, the cell IMref[i], and the cell IMref[i+1] are turned on, whereby the potentials of the node NNref[i, j] and the node NNref[i+1, j] can be set to the ground potential GND.

### <<From Time T11 to Time T12>>

In the period from Time T11 to Time T12, a high-level potential (denoted with High in FIG. 12) is applied to the wiring SWL1, and a low-level potential (denoted with Low in FIG. 12) is applied to the wiring SWL2. Accordingly, the high-level potential is applied to each of the gates of the transistor F3[1] to the transistor F3[n] and the transistor F3[1] to the transistor F3[n] are turned on, and the low-level potential is applied to each of the gates of the transistor F4[1] to the transistor F4[n] and the transistor F4[1] to the transistor F4[n] are turned off.

In the period from Time T11 to Time T12, a low-level potential is applied to each of the wiring WSL[i] and the wiring WSL[i+1]. Accordingly, in the i-th row of the cell array CA, a low-level potential is applied to each of the gates of the transistors F1 included in a cell IM[i, 1] to a cell IM[i, n] and the gate of the transistor F1m included in the cell IMref[i], and the transistors F1 and the transistor F1m are turned off. In addition, in the i+1-th row of the cell array CA, the low-level potential is applied to each of the gates of the transistors F1 included in a cell IM[i+1, 1] to a cell IM[i+1, n] and the gate of the transistor F1m included in the cell IMref[i+1], and the transistors F1 and the transistor F1m are turned off.

In the period from Time T11 to Time T12, the ground potential GND is applied to the wiring XCL[i] and the wiring XCL[i+1]. Specifically, for example, when the wiring XCL shown in FIG. 6C is the wiring XCL[i] and the wiring XCL[i+1], the initialization potential of the wiring VINIL2 is set to the ground potential GND, and the switch SWX is turned on, the potential of the wiring XCL[i] and the wiring XCL[i+1] can be set to the ground potential GND.

In the period from Time T11 to Time T12, when the wiring WCL shown in FIG. 6A is the wiring WCL[1] to the wiring WCL[n], the first data is not input to the wiring DW[1] to the wiring DW[K]. When the wiring XCL in FIG. 6C is the wiring XCL[1] to the wiring XCL[m], the second data is not input to the wiring DX[1] to the wiring DX[L]. In this case, in the circuit WCS in FIG. 6A, a low-level potential is input to the wiring DW[1] to the wiring DW[K], and in the circuit XCS in FIG. 6C, a low-level potential is input to the wiring DX[1] to the wiring DX[L].

In the period from Time T11 to Time T12, current does not flow through a wiring WCL[j], the wiring XCL[i], and the wiring XCL[i+1]. Therefore, I_{F2}[i, j], I_{F2m}[i], I_{F2}[i+1, j], and I_{F2m}[i+1] are each 0.

### <<From Time T12 to Time T13>>

In the period from Time T12 to Time T13, a high-level potential is applied to the wiring WSL[i]. Accordingly, in the i-th row of the cell array CA, a high-level potential is applied to each of the gates of the transistors F1 included in the cell IM[i, 1] to the cell IM[i, n] and the gate of the transistor F1m included in the cell IMref[i], and the transistors F1 and the transistor F1m are turned on. Furthermore, in the period from Time T12 to Time T13, a low-level potential is applied to each of the wiring WSL[1] to the wiring WSL[m] except the wiring WSL[i], and in the cell array CA, the transistors F1 included in the cell IM[1, 1] to the cell IM[m, n] in the rows other than the i-th row and the transistors F1m included in the cell IMref[1] to the cell IMref[m] in the rows other than the i-th row are in the off state.

The ground potentials GND have been applied to the wiring XCL[1] to the wiring XCL[m] since before Time T12.

### <<From Time T13 to Time T14>>

In the period from Time T13 to Time T14, the current amount I₀[i, j] flows as the first data from the circuit WCS to the cell array CA through the transistor F3[j]. Specifically, when the wiring WCL shown in FIG. 6A is the wiring WCL[j], signals corresponding to the first data are input to the wiring DW[1] to the wiring DW[K], whereby the current I₀[i, j] flows from the circuit WCS to the second terminal of the transistor F3[j]. When the value of the K bit signal input as the first data is α[i, j] (α[i, j] is an integer more than or equal to 0 and less than or equal to 2^{K}−1), I₀[i, j] is equal to α[i, j]×I_{Wut}.

When α[i, j] is 0, I₀[i, j] is equal to 0; in a strict sense, current does not flow from the circuit WCS to the cell array CA through the transistor F3[j], but in this specification and the like, it may be referred to as “the current with I₀[i, j]=0 flows” or the like.

Between Time T13 and Time T14, a conduction state is made between the wiring WCL[j] and the first terminal of the transistor F1 included in the cell IM[i, j] in the i-th row of the cell array CA, and a non-conduction state is made between the wiring WCL[j] and the first terminals of the transistors F1 included in a cell IM[1, j] to a cell IM[m, j] in the rows except the i-th row of the cell array CA; accordingly, the current amount I₀[i, j] flows from the wiring WCL[j] to the cell IM[i, j].

When the transistor F1 included in the cell IM[i, j] is turned on, the transistor F2 included in the cell IM[i, j] has a diode-connected structure. Therefore, when current flows from the wiring WCL[j] to the cell IM[i, j], the potentials of the gate of the transistor F2 and the second terminal of the transistor F2 are substantially equal to each other. The potential is determined by the amount of current flowing from the wiring WCL[j] to the cell IM[i, j], the potential of the first terminal of the transistor F2 (here, GND), and the like. In this operation example, the current of I₀[i, j] flows from the wiring WCL[j] to the cell IM[i, j], whereby the potential of the gate of the transistor F2 (the node NN[i, j]) becomes V_{g}[i, j]. That is, a voltage between the gate and the source of the transistor F2 is V_{g}[i, j]-GND, and the current amount I₀[i, j] is set for a current flowing between the first terminal and the second terminal of the transistor F2.

Here, the current amount I₀[i, j] in the case where the threshold voltage of the transistor F2 is Vₜₕ[i, j] and the transistor F2 operates in a subthreshold region can be expressed with the following formula.

[Formula 1]

I₀[i,j]=Iₐ exp{J(V_{g}[i,j]−Vₜₕ[i,j])} (1.1)

Note that Iₐ is drain current for the case where V_{g}[i, j] is Vₜₕ[i, j], and J is a correction coefficient determined with the temperature, the device structure, and the like.

In the period from Time T13 to Time T14, current with the current amount I_{ref0} flows as the reference data from the circuit XCS to the wiring XCL[i]. Specifically, when the wiring XCL shown in FIG. 6C is the wiring XCL[i], a high-level potential is input to the wiring DX[1], a low-level potential is input to the wiring DX[2] to the wiring DX[L], and the current I_{ref0} flows from the circuit XCS to the wiring XCL[i]. In other words, I_{ref0}=I_{Xut}.

In the period from Time T13 to Time T14, since electrical continuity is established between the first terminal of the transistor F1m included in the cell IMref[i] and the wiring XCL[i], the current with the current amount I_{ref0} flows from the wiring XCL[i] to the cell IMref[i].

As in the cell IM[i, j], when the transistor F1m included in the cell IMref[i] is turned on, the transistor F2m included in the cell IMref[i] has a diode-connected structure. Thus, when current flows from the wiring XCL[i] to the cell IMref[i], the potentials of the gate of the transistor F2m and the second terminal of the transistor F2m are substantially equal to each other. The potentials are determined by the amount of current flowing from the wiring XCL[i] to the cell IMref[i], the potential of the first terminal of the transistor F2m (here, GND), and the like. In this operation example, the current with the current amount I_{ref0} flows from the wiring XCL[i] to the cell IMref[i], whereby the potential of the gate of the transistor F2m (the node NNref[i]) becomes V_{gm}[i]; at this time, the potential of the wiring XCL[i] is also V_{gm}[i]. That is, the gate-source voltage of the transistor F2m is V_{gm}[i]−GND, and the current with the amount I_{ref0} is set as current flowing between the first terminal and the second terminal of the transistor F2m.

Here, when the threshold voltage of the transistor F2m is Vₜₕₘ[i], the current amount I_{ref0} in the case where the transistor F2m operates in the subthreshold region can be expressed by the following formula. Note that the correction coefficient J is the same as that of the transistor F2 included in the cell IM[i, j]. For example, the same device structure and the same size (channel length and channel width) are employed for the transistors. Furthermore, although variations in manufacturing cause variations in the correction coefficient J among the transistors, the variations are suppressed to the extent that the argument described later can be made with sufficient precision for practical purposes.

[Formula 2]

I_{ref0}=Iₐ exp{J(V_{gm}[i]−Vₜₕₘ[i])} (1.2)

Here, w[i, j] that is the first data is defined as follows.

[Formula 3]

w[i,j]=exp{J(V_{g}[i,j]−Vₜₕ[i,j]−V_{gm}[i]+Vₜₕₘ[i])} (1.3)

Thus, Formula (1.1) can be rewritten into the following formula with use of Formula (1.3), Formula (1.4), I₀[i, j]=α[i, j]×I_{Wut}, and I_{ref0}=I_{Xut}.

$$\begin{matrix}[ Formula 4 ] & \\ {I}_{0} [ i , j ] = w [ i , j ] {I}_{ref 0} ↔ α [ i , j ] {I}_{W u t} = w [ i , j ] {I}_{X u t} & ( 1.4 )\end{matrix}$$

When the current I_{Wut} output from the current source CS of the circuit WCS in FIG. 6A and the current I_{Xut} output from the current source CS of the circuit XCS in FIG. 6C are equal, w[i, j] is equal to α[i, j]. That is, when I_{Wut} and I_{Xut} are equal, α[i, j] corresponds to the value of the first data; I_{Wut} and I_{Xut} are preferably equal.

### <<From Time T14 to Time T15>>

In the period from Time T14 to Time T15, a low-level potential is applied to the wiring WSL[i]. Accordingly, in the i-th row of the cell array CA, a low-level potential is applied to each of the gates of the transistors F1 included in a cell IM[i, 1] to a cell IM[i, n] and the gate of the transistor F1m included in the cell IMref[i], and the transistors F1 and the transistor F1m are turned off.

When the transistor F1 included in the cell IM[i, j] is turned off, V_{g}[i, j]−V_{gm}[i], which is a difference between the potential of the gate of the transistor F2 (the node NN[i, j]) and the potential of the wiring XCL[i], is retained in the capacitor C5. When the transistor F1m included in the cell IMref[i] is turned off, 0, which is a difference between the potential of the gate of the transistor F2m (the node NNref[i]) and the potential of the wiring XCL[i], is retained in the capacitor C5m. In the operation from Time T13 to Time T14, the voltage retained in the capacitor C5m might be a voltage that is not 0 (e.g., Vas) depending on transistor characteristics of the transistor F1m and the transistor F2m and the like. In this case, the potential of the node NNref[i] is a potential obtained by adding Vas to the potential of the wiring XCL[i].

### <<From Time T15 to Time T16>>

In the period from Time T15 to Time T16, GND is applied to the wiring XCL[i]. Specifically, for example, when the wiring XCL shown in FIG. 6C is the wiring XCL[i], the initialization potential of the wiring VINIL2 is set to the ground potential GND, and the switch SWX is turned on, the potential of the wiring XCL[i] can be set to the ground potential GND.

Thus, the potentials of the node NN[i, 1] to the node NN[i, n] change because of capacitive coupling of the capacitors C5 included in the cell IM[i, 1] to the cell IM[i, n] in the i-th row, and the potential of the node NNref[i] changes because of capacitive coupling of the capacitor C5m included in the cell IMref[i].

The amount of change in the potentials of the node NN[i, 1] to the node NN[i, n] is a potential obtained by multiplying the amount of change in the potential of the wiring XCL[i] by the coefficient of capacitive coupling determined through the configurations of the cell IM[i, 1] to the cell IM[i, n] included in the cell array CA. The coefficient of capacitive coupling is calculated using the capacitance of the capacitor C5, the gate capacitance of the transistor F2, and the parasitic capacitance. When the coefficient of capacitive coupling due to the capacitor C5 is p in each of the cell IM[i, 1] to the cell IM[i, n], the potential of the node NN[i, j] in the cell IM[i, j] decreases by p (V_{gm}[i]−GND) from the potential of the period from Time T14 to Time T15.

Similarly, when the potential of the wiring XCL[i] changes, the potential of the node NNref[i] also changes because of capacitive coupling of the capacitor C5m included in the cell IMref[i]. The potential of the node NNref[i] of the cell IMref[i] in the case where the capacitive coupling coefficient due to the capacitor C5m is p like that due to the capacitor C5 decreases from the potential in the period from Time T14 to Time T15 by p (V_{gm}[i]−GND). In the timing chart in FIG. 12, p is equal to 1, for example. The potential of the node NNref[i] is GND in the period from Time T15 to Time T16.

Accordingly, the potential of the node NN[i, j] of the cell IM[i, j] decreases, so that the transistor F2 is turned off; similarly, the potential of the node NNref[i] of the cell IMref[i] decreases, so that the transistor F2m is also turned off. Therefore, I_{F2}[i, j] and I_{F2m}[i] are each 0 in the period from Time T15 to Time T16.

### <<From Time T16 to Time T17>>

In the period from Time T16 to Time T17, a high-level potential is applied to the wiring WSL[i+1]. Accordingly, in the i+1-th row of the cell array CA, a high-level potential is applied to each of the gates of the transistors F1 included in the cell IM[i+1, 1] to the cell IM[i+1, n] and the gate of the transistor F1m included in the cell IMref[i+1], and the transistors F1 and the transistor F1m are turned on. Furthermore, in the period from Time T16 to Time T17, a low-level potential is applied to each of the wiring WSL[1] to the wiring WSL[m] except the wiring WSL[i+1], and in the cell array CA, the transistors F1 included in the cell IM[1, 1] to the cell IM[m, n] in the rows other than the i+1-th row and the transistors F1m included in the cell IMref[1] to the cell IMref[m] in the rows other than the i+1-th row are in an off state.

The ground potential GND has been applied to the wiring XCL[1] to the wiring XCL[m] since the timing before Time T16.

### <<From Time T17 to Time T18>>

In the period from Time T17 to Time T18, the current amount I₀[i+1, j] flows as the first data from the circuit WCS to the cell array CA through the transistor F3[j]. Specifically, when the wiring WCL shown in FIG. 6A is the wiring WCL[j+1], signals corresponding to the first data are input to the wiring DW[1] to the wiring DW[K], whereby the current I₀[i+1, j] flows from the wiring WCS to the second terminal of the transistor F3[j]. When the value of the K bit signal input as the first data is α[i+1, j] (α[i+1, j] is an integer more than or equal to 0 and less than or equal to 2^{K}−1), I₀[i+1, j] is equal to α[i+1, j]×I_{Wut}.

When α[i+1, j] is 0, I₀[i+1, j] is 0; in a strict sense, current does not flow from the circuit WCS to the cell array CA through the transistor F3[j] but in this specification and the like, it may be referred to as “the current with I₀[i+1, j]=0 flows” or the like as in the case of I₀[i, j]=0.

At this time, a conduction state is made between the wiring WCL[j] and the first terminal of the transistor F1 included in the cell IM[i+1, j] in the i+1-th row of the cell array CA, and a non-conduction state is made between the wiring WCL[j] and the first terminals of the transistors F1 included in the cell IM[1, j] to the cell IM[m, j] in the rows except the i+1-th row of the cell array CA; accordingly, the current amount I₀[i+1, j] flows from the wiring WCL[j] to the cell IM[i+1, j].

When the transistor F1 included in the cell IM[i+1, j] is turned on, the transistor F2 included in the cell IM[i+1, j] has a diode-connected structure. Therefore, when current flows from the wiring WCL[j] to the cell IM[i+1, j], the potentials of the gate of the transistor F2 and the second terminal of the transistor F2 are substantially equal to each other. The potential is determined by the amount of current flowing from the wiring WCL[j] to the cell IM[i+1, j], the potential of the first terminal of the transistor F2 (here, GND), and the like. In this operation example, the current of I₀[i+1, j] flows from the wiring WCL[j] to the cell IM[i+1, j], whereby the potential of the gate of the transistor F2 (the node NN[i+1, j]) becomes V_{g}[i+1, j]. That is, the voltage between the gate and the drain of the transistor F2 is V_{g}[i+1, j]-GND, and the current amount I₀[i+1, j] as a current flowing between the first terminal and the second terminal of the transistor F2 is set.

Here, the current amount I₀[i+1, j] in the case where the threshold voltage of the transistor F2 is Vₜₕ[i+1, j] and the transistor F2 operates in a subthreshold region can be expressed by the following formula. Note that the coefficient of correction is J, which is the same as those of the transistor F2 included in the cell IM[i, j] and the transistor F2m included in the cell IMref[i].

[Formula 5]

I₀[i+1,j]=Iₐexp{J(V_{g}[i+1,j]−Vₜₕ[i+1,j])} (1.5)

In the period from Time T17 to Time T18, the current amount I_{ref0} flows as the reference data from the circuit XCS to the wiring XCL[i+1]. Specifically, as in the period from Time T13 to Time T14, when the wiring XCL shown in FIG. 6C is the wiring XCL[i+1], a high-level potential is input to the wiring DX[1], a low-level potential is input to the wiring DX[2] to the wiring DX[L], and the current I_{ref0}=I_{Xut} flows from the circuit XCS to the wiring XCL[i+1].

Between Time T17 and Time T18, since a conduction state is made between the first terminal of the transistor F1m included in the cell IMref[i+1] and the wiring XCL[i+1], the current amount I_{ref0} flows from the wiring XCL[i+1] to the cell IMref[i+1].

As in the cell IM[i+1, j], when the transistor F1m included in the cell IMref[i+1] is turned on, the transistor F2m included in the cell IMref[i+1, j] has a diode-connected structure. Therefore, when current flows from the wiring XCL[i+1] to the cell IMref[i+1], the potentials of the gate of the transistor F2m and the second terminal of the transistor F2m are substantially equal to each other. The potential is determined by the amount of current flowing from the wiring XCL[i+1] to the cell IMref[i+1], the potential of the first terminal of the transistor F2m (here, GND), and the like. In this operation example, the current amount I_{ref0} flows from the wiring XCL[i+1] to the cell IMref[i+1], whereby the potential of the gate of the transistor F2m (the node NNref[i+1]) becomes V_{gm}[i+1], and the potential of the wiring XCL[i+1] is also V_{gm}[i+1]. That is, the voltage between the gate and the source of the transistor F2m is V_{gm}[i+1]-GND, and the current amount I_{ref0} as current flowing between the first terminal and the second terminal of the transistor F2m is set.

Here, the amount of current I_{ref0} in the case where the threshold voltage of the transistor F2m is Vₜₕₘ[i+1, j] and the transistor F2m operates in a subthreshold region can be expressed with the following formula. Note that the coefficient of correction J is the same as that of the transistor F2 included in the cell IM[i+1, j].

[Formula 6]

I_{ref0}=Iₐ exp{J(V_{gm}[i+1]−Vₜₕₘ[i+1])} (1.6)

Here, w[i+1, j] that is the first data is defined as follows.

$$\begin{matrix}[ Formula 7 ] & \\ w [ i + 1 , j ] = exp \{ J ( {V}_{g} [ i + 1 , j ] - {V}_{t h} [ i + 1 , j ] - {V}_{g m} [ i + 1 ] + {V}_{t h m} [ i + 1 ] ) \} & ( 1.7 )\end{matrix}$$

Thus, Formula (1.5) can be rewritten into the following formula with use of Formula (1.3), Formula (1.6), I₀[i+1, j]=α[i+1, j]×I_{Wut}, and I_{ref0}=I_{Xut}.

$$\begin{matrix}[ Formula 8 ] & \\ {I}_{0} [ i + 1 , j ] = w [ i + 1 , j ] {I}_{ref 0} \\ ↔ α [ i + 1 , j ] {I}_{W u t} = w [ i + 1 , j ] {I}_{X u t} & ( 1.8 )\end{matrix}$$

When the current I_{Wut} output from the current source CS of the circuit WCS in FIG. 6A and the current I_{Xut} output from the current source CS of the circuit XCS in FIG. 6C are equal, w[i+1, j] is equal to α[i+1, j]. That is, when I_{Wut} and I_{Xut} are equal, α[i+1, j] corresponds to the value of the first data; accordingly, I_{Wut} and I_{Xut} are preferably equal.

### <<From Time T18 to Time T19>>

In the period from Time T18 to Time T19, a low-level potential is applied to the wiring WSL[i+1]. Accordingly, in the i+1-th row of the cell array CA, a low-level potential is applied to each of the gates of the transistors F1 included in the cell IM[i+1, 1] to the cell IM[i+1, n] and the gate of the transistor F1m included in the cell IMref[i+1], and the transistors F1 and the transistor F1m are turned off.

When the transistor F1 included in the cell IM[i+1, j] is turned off, V_{g}[i+1, j]−V_{gm}[i+1], which is a difference between the potential of the gate of the transistor F2 (the node NN[i+1, j]) and the potential of the wiring XCL[i+1], is retained in the capacitor C5. Moreover, when the transistor F1m included in the cell IMref[i+1] is turned off, 0, which is a difference between the potential of the gate of the transistor F2m (the node NNref[i+1]) and the potential of the wiring XCL[i+1], is retained in the capacitor C5m. In the operation from Time T18 to Time T19, the voltage retained in the capacitor C5m might be a voltage that is not 0 (e.g., V_{ds}) depending on transistor characteristics of the transistor F1m and the transistor F2m and the like. In this case, the potential of the node NNref[i+1] is the potential obtained by adding Vas to the potential of the wiring XCL[i+1].

### <<From Time T19 to Time 20>>

In the period from Time T19 to Time T20, the ground potential GND is applied to the wiring XCL[i+1]. Specifically, for example, when the wiring XCL in FIG. 6C is the wiring XCL[i+1], the potential of the wiring XCL[i+1] can be set to the ground potential GND by setting the initialization potential of the wiring VINIL2 to the ground potential GND and turning on the switch SWX.

Thus, the potentials of the node NN[i+1, 1] to the node NN[i+1, n] change because of capacitive coupling of the capacitors C5 included in the cell IM[i+1, 1] to the cell IM[i+1, n] in the i+1-th row, and the potential of the node NNref[i+1] changes because of capacitive coupling of the capacitor C5m included in the cell IMref[i+1].

The amount of change in the potentials of the node NN[i+1, 1] to the node NN[i+1, n] equals to a potential obtained by multiplying the amount of change in the potential of the wiring XCL[i+1] by a capacitive coupling coefficient determined by the structures of the cell IM[i+1, 1] to the cell IM[i+1, n] included in the cell array CA. The capacitive coupling coefficient is calculated using the capacitance of the capacitor C5, the gate capacitance of the transistor F2, the parasitic capacitance, and the like. In the case where the capacitive coupling coefficient due to the capacitor C5 in each of the cell IM[i+1, 1] to the cell IM[i+1, n] is p, which is the same as the capacitive coupling coefficient due to the capacitor C5 in each of the cell IM[i, 1] to the cell IM[i, n], the potential of the node NN[i+1, j] of the cell IM[i+1, j] decreases from the potential in the period from Time T18 to Time T19 by p (V_{gm}[i+1]-GND).

Similarly, when the potential of the wiring XCL[i+1] changes, the potential of the node NNref[i+1] also changes because of capacitive coupling of the capacitor C5m included in the cell IMref[i+1]. The potential of the node NNref[i+1] of the cell IMref[i+1] in the case where the capacitive coupling coefficient due to the capacitor C5m is p like that due to the capacitor C5 decreases from the potential in the period from Time T18 to Time T19 by p (V_{gm}[i+1]−GND). In the timing chart in FIG. 12, p is 1 as an example. Accordingly, the potential of the node NNref[i+1] is GND between Time T20 and Time T21.

Accordingly, the potential of the node NN[i+1, j] of the cell IM[i+1, j] decreases, so that the transistor F2 is turned off; similarly, the potential of the node NNref[i+1] of the cell IMref[i+1] decreases, so that the transistor F2m is also turned off. Therefore, I_{F2}[i+1, j] and I_{F2m}[i+1] are each 0 in the period from Time T19 to Time T20.

### <<From Time T20 to Time T21>>

In the period from Time T20 to Time T21, a low-level potential is applied to the wiring SWL1. Accordingly, a low-level potential is applied to each of the gates of the transistor F3[1] to the transistor F3[n], whereby the transistor F3[1] to the transistor F3[n] are brought into an off state.

### <<From Time T21 to Time T22>>

In the period from Time T21 to Time T22, a high-level potential is applied to the wiring SWL2. Accordingly, a high-level potential is applied to each of the gates of the transistor F4[1] to the transistor F4[n], whereby the transistor F4[1] to the transistor F4[n] are brought into an on state.

### <<From Time T22 to Time T23>>

In the period from Time T22 to Time T23, current x[i]I_{ref0}, which is x[i] times the current amount I_{ref0}, flows as the second data from the circuit XCS to the wiring XCL[i]. That is, the current flowing from the circuit XCS to the wiring XCL[i] is changed from the current amount I_{ref0} to the current amount x[i]I_{ref0}. Specifically, for example, when the wiring XCL shown in FIG. 6C is the wiring XCL[i], a high-level potential or a low-level potential is input to the wiring DX[1] to the wiring DX[Z] in accordance with the value of x[i], and the current with the amount x[i]I_{ref0}=x[i]I_{Xut} flows from the circuit XCS to the wiring XCL[i]. In this operation example, x[i] corresponds to the value of the second data. At this time, the potential of the wiring XCL[i] changes from 0 to V_{gm}[i]+ΔV[i].

When the potential of the wiring XCL[i] changes, the potentials of the node NN[i, 1] to the node NN[i, n] also change because of the capacitive coupling of the capacitors C5 included in the cell IM[i, 1] to the cell IM[i, n] in the i-th row of the cell array CA. Thus, the potential of the node NN[i, j] of the cell IM[i, j] becomes V_{g}[i, j]+pΔV[i].

Similarly, when the potential of the wiring XCL[i] changes, the potential of the node NNref[i] also changes because of capacitive coupling of the capacitor C5m included in the cell IMref[i]. Thus, the potential of the node NNref[i] of the cell IMref[i] becomes V_{gm}[i]+pΔV[i].

Accordingly, a current amount I₁[i, j] of a current flowing between the first terminal and the second terminal of the transistor F2 and a current amount I_{ref1}[i, j] of a current flowing between the first terminal and the second terminal of the transistor F2m in the period from Time T22 to Time T23 can be described as follows.

$$\begin{matrix}[ Formula 9 ] & \\ \begin{matrix}{I}_{1} [ i , j ] = {I}_{a} exp \{ J ( {V}_{g} [ i , j ] + p Δ V [ i ] - {V}_{t h} [ i , j ] ) \} \\ = {I}_{0} [ i , j ] exp ( Jp Δ V [ i ] )\end{matrix} & ( 1.9 )\end{matrix}$$

$$\begin{matrix}[ Formula 10 ] & \\ \begin{matrix}{I}_{ref 1} [ i ] = {I}_{a} exp \{ J ( {V}_{g m} [ i ] + p Δ V [ i ] - {V}_{t h m} [ i ] ) \} \\ = x [ i ] {I}_{ref 0}\end{matrix} & ( 1.1 )\end{matrix}$$

According to Formula (1.9) and Formula (1.10), α[i] can be expressed by the following formula.

[Formula 11]

x[i]=exp(JpΔV[i]) (1.11)

Thus, Formula (1.9) can be rewritten into the following formula.

[Formula 12]

I₁[i,j]=x[i]w[i,j]I_{ref0} (1.12)

That is, the amount of current flowing between the first terminal and the second terminal of the transistor F2 included in the cell IM[i, j] is proportional to the product of the first data w[i, j] and the second data α[i].

In the period from Time T22 to Time T23, current x[i+1]I_{ref0}, which is x[i+1] times the current amount I_{ref0}, flows as the second data from the circuit XCS to the wiring XCL[i+1]. That is, the current flowing from the circuit XCS to the wiring XCL[i+1] is changed from the current amount I_{ref0} to the current amount x[i+1]I_{ref0}. Specifically, for example, when the wiring XCL shown in FIG. 6C is the wiring XCL[i+1], a high-level potential or a low-level potential is input to the wiring DX[1] to the wiring DX[L] in accordance with the value of α[i+1], and the current with the amount x[i+1]I_{ref0}=x[i+1]I_{Xut} flows from the circuit XCS to the wiring XCL[i+1]. In this operation example, x[i+1] corresponds to the value of the second data. At this time, the potential of the wiring XCL1[i+1] changes from 0 to V_{gm}[i+1]+ΔV[i+1].

When the potential of the wiring XCL[i+1] changes, the potentials of the node NN[i+1, 1] to the node NN[i+1, n] also change because of the capacitive coupling of the capacitors C5 included in the cell IM[i+1, 1] to the cell IM[i+1, n] in the i+1-th row of the cell array CA. Thus, the potential of the node NN[i+1, j] of the cell IM[i+1, j] becomes V_{g}[i+1, j]+pΔV[i+1].

Similarly, when the potential of the wiring XCL[i+1] changes, the potential of the node NNref[i+1] also changes because of capacitive coupling of the capacitor C5m included in the cell IMref[i+1]. Thus, the potential of the node NNref[i+1] of the cell IMref[i+1] becomes V_{gm}[i+1]+pΔV[i+1].

Accordingly, a current amount I₁[i+1, j] of current flowing between the first terminal and the second terminal of the transistor F2 and a current amount I_{ref1}[i+1, j] of current flowing between the first terminal and the second terminal of the transistor F2m in the period from Time T22 to Time T23 can be described as follows.

$$\begin{matrix}[ Formula 13 ] & \\ {I}_{1} [ i + 1 , j ] = {I}_{a} exp \{ J ( {V}_{g} [ i + 1 , j ] + p Δ V [ i + 1 ] - {V}_{t h} [ i + 1 , j ] ) \} = {I}_{0} [ i + 1 , j ] exp ( Jp Δ V [ i + 1 ] ) & ( 1.13 )\end{matrix}$$

$$\begin{matrix}[ Formula 14 ] & \\ {I}_{ref 1} [ i + 1 ] = {I}_{a} exp \{ J ( {V}_{g m} [ i ] + p Δ V [ i ] - {V}_{t h m} [ i ] ) \} = x [ i ] {I}_{ref 0} & ( 1.14 )\end{matrix}$$

According to Formula (1.13) and Formula (1.14), α[i+1] can be expressed by the following formula.

[Formula 15]

x[i+1]=exp(JpΔV[i+1]) (1.15)

Thus, Formula (1.13) can be rewritten into the following formula.

[Formula 16]

I₁[i+1,j]=x[i+1]w[i+1,j]I_{ref0} (1.16)

That is, the amount of current flowing between the first terminal and the second terminal of the transistor F2 included in the cell IM[i+1, j] is proportional to the product of the first data w[i+1, j] and the second data x[i+1].

Here, the sum of the amounts of current flowing from the converter circuit ITRZ[j] to the cell IM[i, j] and the cell IM[i+1, j] through the transistor F4[j] and the wiring WCL[j] is considered. When the sum of the amounts of current is I_{S}[j], I_{S}[j] can be expressed by the following formula according to Formula (1.12) and Formula (1.16).

$$\begin{matrix}[ Formula 17 ] & \\ \begin{matrix}{I}_{S} [ j ] = {I}_{1} [ i , j ] + {I}_{1} [ i + 1 , j ] \\ = {I}_{ref 0} ( x [ i ] w [ i , j ] + x [ i + 1 ] w [ i + 1 , j ] )\end{matrix} & ( 1.17 )\end{matrix}$$

Thus, the amount of current output from the converter circuit ITRZ[j] is the amount of current proportional to the sum of products of w[i, j] and w[i+1, j], which are the first data, and x[i] and x[i+1] that are the second data.

Although the sum of the amounts of current flowing to the cell IM[i, j] and the cell IM[i+1, j] is described in the above-described operation example, the sum of the amounts of current flowing to a plurality of cells, the cell IM[1, j] to the cell IM[m, j], may also be dealt with. In that case, Formula (1.17) can be rewritten into the following formula.

$$\begin{matrix}[ Formula 18 ] & \\ {I}_{S} [ j ] = {I}_{ref 0} {\sum }_{i = 1}^{m} x [ i ] w [ i , j ] & ( 1.18 )\end{matrix}$$

Thus, even in the case of the arithmetic circuit MAC1 including the cell array CA with three or more rows and two or more columns, product-sum operation can be performed in the above-described manner. In the arithmetic circuit MAC1 of such a case, cells in one of the plurality of columns are used for retaining I_{ref0} and xI_{ref0} as the amount of current, whereby product-sum operations, the number of which corresponds to the number of rest of the columns among the plurality of columns, can be executed concurrently. That is, when the number of columns in a memory cell array is increased, a semiconductor device that achieves high-speed product-sum processing can be provided.

The above operation example of the arithmetic circuit MAC1 is suitable when product-sum operation of the positive first data and the positive second data is performed. Embodiment 3 will describe an operation example in which product-sum operation of the positive or the negative first data and the positive second data is performed, and an operation example in which product-sum operation of the positive or the negative first data and the positive or the negative second data is performed.

Although this embodiment describes the case where the transistors included in the arithmetic circuit MAC1 are OS transistors or Si transistors, one embodiment of the present invention is not limited thereto. The transistor included in the arithmetic circuit MAC1 can be, for example, a transistor including Ge or the like in a channel formation region, a transistor including a compound semiconductor such as ZnSe, CdS, GaAs, InP, GaN, or SiGe in a channel formation region, a transistor including a carbon nanotube in a channel formation region, or a transistor including an organic semiconductor in a channel formation region.

Note that this embodiment can be combined with any of the other embodiments and the like in this specification or the like as appropriate.

### Embodiment 3

In Embodiment 2, the arithmetic circuit that performs the product-sum operation of the positive or “0” first data and the positive or “0” second data and its operation example are described; in this embodiment, an arithmetic circuit that can perform product-sum operation of the positive, negative, or “0” first data and the positive or “0” second data, and product-sum operation of the positive, negative, or “0” first data and the positive, negative, or “0” second data is described.

### <Configuration Example 1 of Arithmetic Circuit>

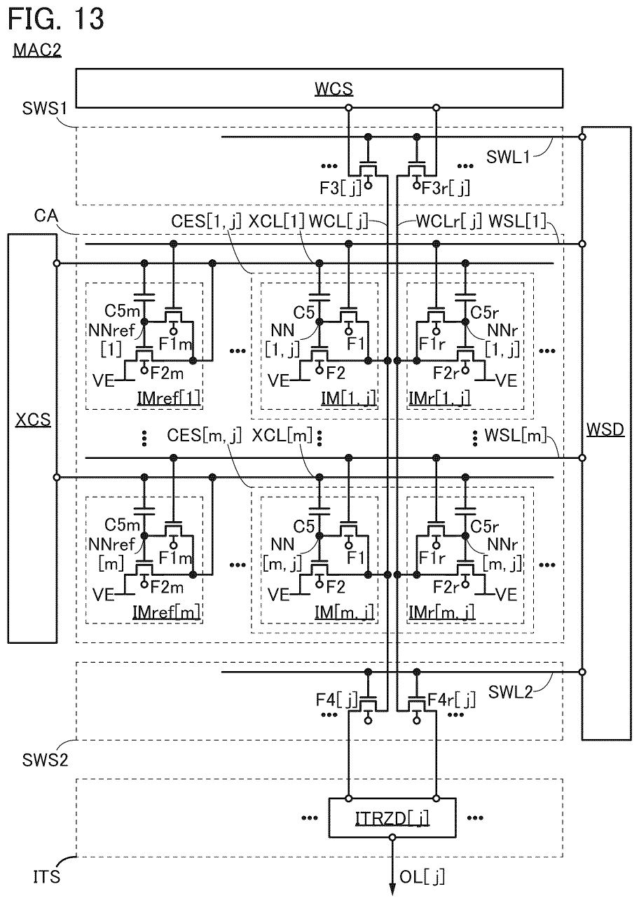

FIG. 13 shows a configuration example of an arithmetic circuit that performs product-sum operation of positive, negative, or “0” first data and positive or “0” second data. An arithmetic circuit MAC2 shown in FIG. 13 has a configuration in which the arithmetic circuit MAC1 in FIG. 5 is changed. Thus, the portions in the arithmetic circuit MAC2 that are the same as those in the arithmetic circuit MAC1 are not described.

The cell array CA shown in FIG. 13 includes a circuit CES[1, j] to a circuit CES[m, j], the circuit CES[1, j] includes the cell IM[1, j] and a cell IMr[1, j], and the circuit CES[m, j] includes the cell IM[m, j] and a cell IMr[m, j]. FIG. 13 selectively shows the circuit CES[1, j] and the circuit CES[m, j]. Furthermore, the gate of the transistor F2 included in the cell IM[1, j] is denoted as the node NN[1, j], the gate of the transistor F2r included in the cell IMr[1, j] is denoted as the node NNr[1, j], the gate of the transistor F2 included in the cell IM[m, j] is denoted as a node NN[m, j], the gate of the transistor F2r included in the cell IMr[m, j] is denoted as a node NNr[m, j], the gate of the transistor F2m included in the cell IMref[1] is denoted as the node NNref[1], and the gate of the transistor F2m included in the cell IMref[m] is denoted as the node NNref[m]. In this specification and the like, when the circuit CES[1, j] to the circuit CES[m, j], the cell IM[1, j], the cell IMr[1, j], the cell IM[m, j], the cell IMr[m, j], and the like are described, [m, n] and the like added to reference numerals are sometimes omitted.

The cells IM can have a configuration similar to that of the cell IM[1, 1] to the cell IM[m, n] included in the cell array CA in the arithmetic circuit MAC1 in FIG. 5.

The cells IMr can have a configuration similar to that of the cells IM. FIG. 13 shows the cells IMr having a configuration similar to that of the cells IM, for example. To distinguish the transistors, the capacitors, and the like included in the cells IM and the cells IMr, “r” is added to the reference numerals representing the transistors and the capacitors included in the cells IMr.

Specifically, the cell IMr includes a transistor F1r, a transistor F2r, and a capacitor C5r. The transistor F1r corresponds to the transistor F1 in the cell IM, the transistor F2r corresponds to the transistor F2 in the cell IM, and the capacitor C5r corresponds to the capacitor C5 in the cell IM. Thus, for the electrical connection configuration between the transistor F1r, the transistor F2r, and the capacitor C5r, the descriptions on IM[1, 1] to the cell IM[m, n] in Embodiment 2 are referred to.

In the cell IMr, a connection portion of the first terminal of the transistor F1r, the gate of the transistor F2r, and the first terminal of the capacitor C5r is a node NNr.

In the circuit CES[1, j], the second terminal of the capacitor C5 is electrically connected to the wiring XCL[1], the gate of the transistor F1 is electrically connected to the wiring WSL[1], and the second terminal of the transistor F1 and the second terminal of the transistor F2 are electrically connected to the wiring WCL[j]. A second terminal of the capacitor C5r is electrically connected to the wiring XCL[1], a gate of the transistor F1r is electrically connected to the wiring WSL[1], and a second terminal of the transistor F1r and a second terminal of the transistor F2r are electrically connected to a wiring WCLr[j].

Similarly, in the circuit CES[m, j], the second terminal of the capacitor C5 is electrically connected to the wiring XCL[m], the gate of the transistor F1 is electrically connected to the wiring WSL[m], and the second terminal of the transistor F1 and the second terminal of the transistor F2 are electrically connected to the wiring WCL[j]. The second terminal of the capacitor C5r is electrically connected to the wiring XCL[m], the gate of the transistor F1r is electrically connected to the wiring WSL[m], and the second terminal of the transistor F1r and the second terminal of the transistor F2r are electrically connected to the wiring WCLr[j].

The wiring WCL[j] and the wiring WCLr[j] function as, for example, wirings through which current flows from the circuit WCS to the cell IM and the cell IMr included in the circuit CES like the wiring WCL[1] to the wiring WCL[n] described in Embodiment 2. As an example, the wiring WCL[j] and the wiring WCLr[j] function as wirings through which current flows from a converter circuit ITRZD[j] to the cell IM and the cell IMr included in the circuit CES.

In the arithmetic circuit MAC2 in FIG. 13, the circuit SWS1 includes the transistor F3[j] and a transistor F3r[j]. A first terminal of the transistor F3[j] is electrically connected to the wiring WCL[j], the second terminal of the transistor F3[j] is electrically connected to the circuit WCS, and a gate of the transistor F3[j] is electrically connected to the wiring SWL1. A first terminal of the transistor F3r[j] is electrically connected to the wiring WCLr[j], a second terminal of the transistor F3r[j] is electrically connected to the circuit WCS, and a gate of the transistor F3r[j] is electrically connected to the wiring SWL1.

In the arithmetic circuit MAC2 in FIG. 13, the circuit SWS2 includes the transistor F4[j] and a transistor F4r[j]. A first terminal of the transistor F4[j] is electrically connected to the wiring WCL[j], a second terminal of the transistor F4[j] is electrically connected to the converter circuit ITRZD[j], and a gate of the transistor F4[j] is electrically connected to the wiring SWL2. A first terminal of the transistor F4r[j] is electrically connected to the wiring WCLr[j], a second terminal of the transistor F4r[j] is electrically connected to the converter circuit ITRZD[j], and a gate of the transistor F4r[j] is electrically connected to the wiring SWL2.

The converter circuit ITRZD[j] corresponds to the converter circuit ITRZ[1] to the converter circuit ITRZ[n] in the arithmetic circuit MAC1; for example, the converter circuit ITRZD[j] has a function of generating a voltage corresponding to the difference between the amount of current flowing from the converter circuit ITRZD[j] to the wiring WCL[j] and the amount of current flowing from the converter circuit ITRZD[j] to the wiring WCLr[j] and outputting the voltage to the wiring OL[j].

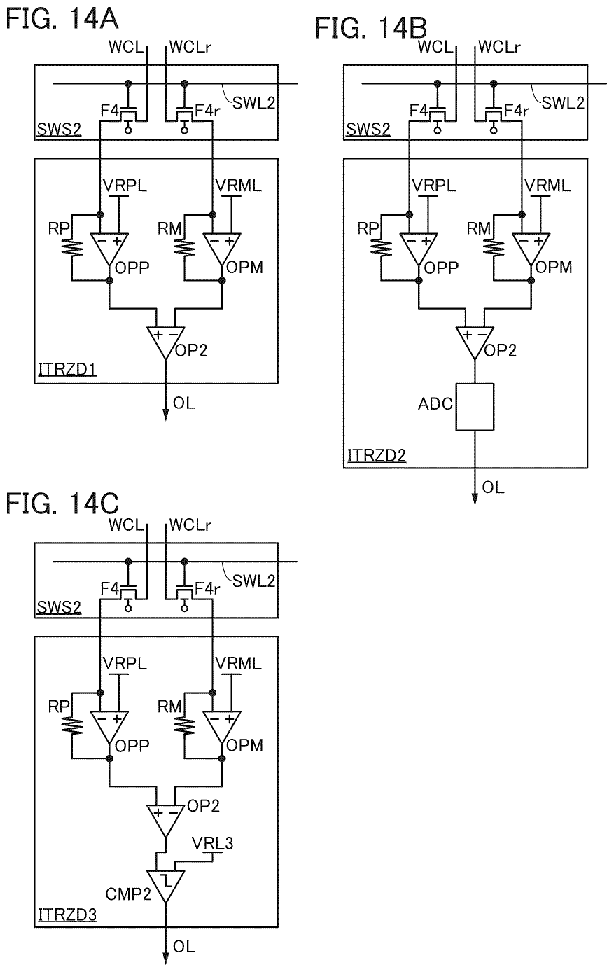

FIG. 14A illustrates a specific configuration example of the converter circuit ITRZD[j]. A converter circuit ITRZD1 shown in FIG. 14A is an example of a circuit which can be used as the converter circuit ITRZD[j] in FIG. 13. FIG. 14A also illustrates the circuit SWS2, the wiring WCL, the wiring WCLr, the wiring SWL2, the transistor F4, and the transistor F4r to show the electrical connections between the converter circuit ITRZD1 and its nearby circuits. The wiring WCL[j] and the wiring WCLr[j] included in the arithmetic circuit MAC2 in FIG. 13 can be respectively used as the wiring WCL and the wiring WCLr, for example, and the transistor F4[j] and the transistor F4r[j] included in the arithmetic circuit MAC2 in FIG. 13 can be respectively used as the transistor F4 and the transistor F4r, for example.

The converter circuit ITRZD1 in FIG. 14A is electrically connected to the wiring WCL through the transistor F4. The converter circuit ITRZD1 is electrically connected to the wiring WCLr through the transistor F4r. The converter circuit ITRZD1 is electrically connected to the wiring OL. The converter circuit ITRZD1 has a function of converting the amount of current flowing from the converter circuit ITRZD1 to the wiring WCL or the amount of current flowing from the wiring WCL to the converter circuit ITRZD1 into a first voltage, a function of converting the amount of current flowing from the converter circuit ITRZD1 to the wiring WCLr or the amount of current flowing from the wiring WCLr to the converter circuit ITRZD1 into a second voltage, and a function of outputting to the wiring OL an analog voltage corresponding to the difference between the first voltage and the second voltage.

The converter circuit ITRZD1 in FIG. 14A includes a resistor RP, a resistor RM, an operational amplifier OPP, an operational amplifier OPM, and an operational amplifier OP2, for example.

An inverting input terminal of the operational amplifier OPP is electrically connected to a first terminal of the resistor RP and the second terminal of the transistor F4. A non-inverting input terminal of the operational amplifier OPP is electrically connected to a wiring VRPL. An output terminal of the operational amplifier OPP is electrically connected to a second terminal of the resistor RP and a non-inverting input terminal of the operational amplifier OP2. An inverting input terminal of the operational amplifier OPM is electrically connected to a first terminal of the resistor RM and a second terminal of the transistor F4r. A non-inverting input terminal of the operational amplifier OPM is electrically connected to a wiring VRML. An output terminal of the operational amplifier OPM is electrically connected to a second terminal of the resistor RM and an inverting input terminal of the operational amplifier OP2. An output terminal of the operational amplifier OP2 is electrically connected to the wiring OL.

The wiring VRPL functions as a wiring for supplying a constant potential. The constant potential can be a ground potential (GND), a low-level potential, or a high-level potential, for example. The wiring VRML functions as a wiring for supplying a constant potential. The constant potential can be a ground potential (GND), a low-level potential, or a high-level potential, for example. The constant potentials provided by the wiring VRPL and the wiring VRML may be equal or different. In particular, by setting the constant potentials supplied by the wiring VRPL and the wiring VRML to ground potentials (GND), the inverting input terminal of the operational amplifier OPP and the inverting input terminal of the operational amplifier OPM are virtually grounded.

The converter circuit ITRZD1 with the configuration in FIG. 14A can convert the amount of current flowing from the wiring WCL to the converter circuit ITRZD1 through the transistor F4 or the amount of current flowing from the converter circuit ITRZD1 to the wiring WCL through the transistor F4 into the first voltage. The converter circuit ITRZD1 can convert the amount of current flowing from the wiring WCLr to the converter circuit ITRZD1 through the transistor F4r or the amount of current flowing from the converter circuit ITRZD1 to the wiring WCLr through the transistor F4r into the second voltage. Then, the converter circuit ITRZD1 can output to the wiring OL an analog voltage corresponding to the difference between the first voltage and the second voltage.

The converter circuit ITRZD1 in FIG. 14A outputs an analog voltage; however, the circuit configuration which can be used for the converter circuit ITRZD[j] in FIG. 13 is not limited thereto. For example, the converter circuit ITRZD1 may include, as in FIG. 8C, the analog-digital converter circuit ADC as shown in FIG. 14B. Specifically, in a converter circuit ITRZD2 in FIG. 14B, the input terminal of the analog-digital converter circuit ADC is electrically connected to the output terminal of the operational amplifier OP2 and the output terminal of the analog-digital converter circuit ADC is electrically connected to the wiring OL. With such a configuration, the converter circuit ITRZD2 in FIG. 14B can output a digital signal to the wiring OL.

When the digital signal output to the wiring OL is 1 bit (binary) in the converter circuit ITRZD2, the converter circuit ITRZ2 may be replaced with a converter circuit ITRZD3 in FIG. 14C. The converter circuit ITRZ3 in FIG. 14C has a configuration in which the converter circuit ITRZD1 in FIG. 14A further includes a comparator CMP2, as in FIG. 8C. Specifically, the converter circuit ITRZD3 has a configuration in which a first input terminal of the comparator CMP2 is electrically connected to the output terminal of the operational amplifier OP2, and a second input terminal of the comparator CMP2 is electrically connected to a wiring VRL3, and an output terminal of the comparator CMP2 is electrically connected to the wiring OL. The wiring VRL3 functions as a wiring for supplying a potential to be compared to the potential of the first terminal of the comparator CMP2. With such a structure, the converter circuit ITRZD3 in FIG. 14C can output to the wiring OL a low-level potential or a high-level potential (a binary digital signal) in accordance with the large-small relation between the voltage supplied by the wiring VRL3 and the difference of the first voltage converted from the amount of current flowing between the source and the drain of the transistor F4 and the second voltage converted from the amount of current flowing between the source and the drain of the transistor F4r.

### <<Example of Retaining First Data>>

Next, In the arithmetic circuit MAC2 in FIG. 13, an example of the circuit CES retaining the first data to perform a product-sum operation of the positive, negative, or “0” first data and the positive or “0” second data is described.

Since the circuit CES includes the cell IM and the cell IMr, the circuit CES can use the two circuits, i.e., the cell IM and the cell IMr to retain the first data. Two current amounts are set for the circuit CES and potentials corresponding to the current amounts can be retained in the cell IM and the cell IMr. The first data can be represented with the current amount set in the cell IM and the current amount set in the cell IMr. The positive first data, the negative first data, or the “0” first data to be retained in the circuit CES is defined as follows.

To retain the positive first data in the circuit CES[1, j], the cell IM[1, j] is set such that the current amount corresponding to the absolute value of the positive first data flows between the first terminal and the second terminal of the transistor F2 in the cell IM[1, j], for example. Specifically, the potential corresponding to the current amount is retained in the gate of the transistor F2 (the node NN[1, j]). In contrast, the cell IMr[1, j] is set such that current does not flow between the first terminal and the second terminal of the transistor F2r in the cell IMr[1, j]. Specifically, the gate of the transistor F2r (node NNr[1, j]) retains the potential supplied by the wiring VE or the initialization potential supplied by the wiring VINIL1 of the circuit WCS in FIG. 6A, for example.

To retain the negative first data in the circuit CES[1, j], the cell IMr[1, j] is set such that the current amount corresponding to the absolute value of the negative first data flows through the transistor F2r in the cell IMr[1, j], for example. Specifically, a potential corresponding to the current amount is retained in the gate of the transistor F2r (node NNr[1, j]). In contrast, the cell IM[1, j] is set such that current does not flow through the transistor F2 in the cell IM[1, j]. Specifically, the gate of the transistor F2 (node NN[1, j]) retains the potential supplied by the wiring VE or the initialization potential supplied by the wiring VINIL1 of the circuit WCS in FIG. 6A, for example.

To retain the “0” first data in the circuit CES[1, j], the transistor F2 of the cell IM[1, j] and the transistor F2r of the cell IMr[1, j] are set such that current do not flow through these transistors, for example. Specifically, the gate of the transistor F2 (node NN[1, j]) and the gate of the transistor F2r (node NNr[1, j]) retains the potential supplied by the wiring VE or the initialization potential supplied by the wiring VINIL1 of the circuit WCS in FIG. 6A, for example.

To retain the positive first data or the negative first data in another circuit CES, it is set that current with the current amount corresponding to the first data flows through one of the path between the cell IM and the wiring WCL and the path between the cell IMr and the wiring WCLr while current does not flow through the other of the path between the cell IM and the wiring WCL and the path between the cell IMr and the wiring WCLr, as in the circuit CES[1, j]. To retain the “0” first data in another circuit CES, it is set that current does not flow between the cell IM and the wiring WCL and between the cell IMr and the wiring WCLr as in the circuit CES[1, j].

For example, to retain each case of “+3”, “+2”, “+1”, “0”, “−1”, “−2”, and “−3” in the circuit CES as the first data, the amount of current flowing from the wiring WCL to the cell IM and the amount of current flowing from the wiring WCLr to the cell IMr are set as described above, whereby each of “+3”, “+2”, “+1”, “0”, “−1”, “−2”, and “−3” as the first data can be defined as shown in the following table.

TABLE 1

| | Current flowing from wiring | Current flowing from wiring |
|---|---|---|
| First data | WCL to cell IM | WCLr to cell IMr |
| +3 | 3 I_{Wut} | 0 |
| +2 | 2 I_{Wut} | 0 |
| +1 | I_{Wut} | 0 |
| 0 | 0 | 0 |
| −1 | 0 | I_{Wut} |
| −2 | 0 | 2 I_{Wut} |
| −3 | 0 | 3 I_{Wut} |

Here, the case is considered in which each of the circuit CES[1, j] to the circuit CES[m, j] retains the first data and the second data is input to each of the wiring XCL[1] to the wiring XCL[m] in the arithmetic circuit MAC2 in FIG. 13. In that case, a low-level potential is supplied to the wiring SWL1 to turn off the transistor F3[j] and the transistor F3r[j], and a high-level potential is supplied to the wiring SWL2 to turn on the transistor F4[j] and the transistor F4r[j]. Electrical continuity is thus established between the converter circuit ITRZD[j] and the wiring WCL[j], and current sometimes flows from the converter circuit ITRZD[j] to the wiring WCL[j]. In addition, electrical continuity is established between the converter circuit ITRZD[j] and the wiring WCLr[j], and current sometimes flows from the converter circuit ITRZD[j] to the wiring WCLr[j]. When the sum of the amounts of current flowing from the converter circuit ITRZD[j] to the wiring WCL[j] is I_{S}[j] and the sum of the amounts of current flowing from the converter circuit ITRZD[j] to the wiring WCLr[j] is I_{Sr}[j], I_{S}[j] and I_{Sr}[j] can be expressed by the following formulae, according to the operation example of the arithmetic circuit MAC1 described in Embodiment 2.

$$\begin{matrix}[ Formula 19 ] & \\ {I}_{S} [ j ] = {I}_{ref 0} {\sum }_{i = 1}^{m} x [ i ] w [ i , j ] & ( 2.1 )\end{matrix}$$

$${I}_{S r} [ j ] = {I}_{ref 0} {\sum }_{i = 1}^{m} x [ i ] {w}_{r} [ i , j ] \qquad ( 2.2 )$$

Note that w[i, j] shown in Formula (2.1) is the value of the first data written to the cell IM[i, j], and wᵣ[i, j] shown in Formula (2.2) is the value of the first data written to the cell IMr[i, j]. When the value of one of w[i, j] and wᵣ[i, j] is not “0”, the other of w[i, j] and wᵣ[i, j] is set to the value “0”, whereby the first data retained in the circuit CES[i, j] can follow the definition shown in Table 1, for example.

The converter circuit ITRZD[j] convert the sum I_{S}[j] of the amount of current flowing in the wiring WCL into the first voltage, and the sum I_{Sr}[j] of the amount of current flowing in the wiring WCLr into the second voltage, for example. Then, the converter circuit ITRZD[j] can output a voltage corresponding to the difference between the first voltage and the second voltage to the wiring OL.

The converter circuit ITRZD1 to the converter circuit ITRZD3 shown in FIG. 14A to FIG. 14C each have a circuit configuration which outputs a voltage to the wiring OL; however, one embodiment of the present invention is not limited thereto. For example, the converter circuit ITRZD[j] included in the arithmetic circuit MAC2 in FIG. 13 may have a circuit configuration outputting a current.

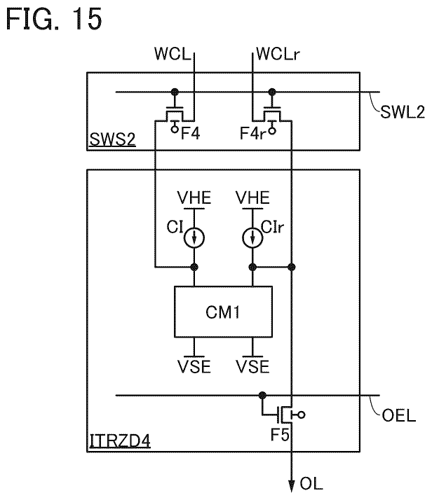

A converter circuit ITRZD4 shown in FIG. 15 can be used for the converter circuit ITRZD[j] included in the arithmetic circuit MAC2 in FIG. 13, and has a circuit configuration of outputting the results of a product-sum operation and an activation function operation in the form of a current amount.

FIG. 15 shows the circuit SWS2, the wiring WCL, the wiring WCLr, the wiring OL, the transistor F4, and the transistor F4r to show the electrical connections between the converter circuit ITRZD4 and its nearby circuits. The wiring WCL[j] and the wiring WCLr[j] included in the arithmetic circuit MAC2 in FIG. 13 can be respectively used as the wiring WCL and the wiring WCLr, for example, and the transistor F4[j] and the transistor F4r[j] included in the arithmetic circuit MAC2 in FIG. 13 can be respectively used as the transistor F4 and the transistor F4r, for example

The converter circuit ITRZD4 in FIG. 15 is electrically connected to the wiring WCL through the transistor F4. The converter circuit ITRZD4 is electrically connected to the wiring WCLr through the transistor F4r. The converter circuit ITRZD4 is electrically connected to the wiring OL. The converter circuit ITRZD4 has a function of obtaining the difference current of one of the amount of current flowing from the converter circuit ITRZD4 to the wiring WCL and the amount of current flowing from the wiring WCL to the converter circuit ITRZD4, and one of the amount of current flowing from the converter circuit ITRZD4 to the wiring WCLr and the amount of current flowing from the wiring WCLr to the converter circuit ITRZD4. The converter circuit ITRZD4 has a function of making the difference current flow between the converter circuit ITRZD4 and the wiring OL.

The converter circuit ITRZD4 in FIG. 15 includes, for example, a transistor F5, a current source CI, a current source CIr, and a current mirror circuit CM1.

The second terminal of the transistor F4 is electrically connected to a first terminal of the current mirror circuit CM1 and an output terminal of the current source CI, and the second terminal of the transistor F4r is electrically connected to a second terminal of the current mirror circuit CM1, an output terminal of the current source CIr, and a first terminal of the transistor F5. An input terminal of the current source CI is electrically connected to a wiring VHE, and an input terminal of the current source CIr is electrically connected to the wiring VHE. A third terminal of the current mirror circuit CM1 is electrically connected to a wiring VSE, and a fourth terminal of the current mirror circuit CM1 is electrically connected to the wiring VSE.

The second terminal of the transistor F5 is electrically connected to the wiring OL and the gate of the transistor F5 is electrically connected to the wiring OEL.

The current mirror circuit CM1 has, for example, a function of making the current amount corresponding to the potential of the first terminal of the current mirror circuit CM1 flow between the first terminal and the third terminal of the current mirror circuit CM1 and between the second terminal and the fourth terminal of the current mirror circuit CM1.

The wiring VHE functions as a wiring for supplying a constant potential, for example. Specifically, the constant potential can be a high-level potential or the like, for example.

The wiring VSE functions as a wiring for supplying a constant potential, for example. Specifically, the constant potential can be, for example, a low-level potential, a ground potential, or the like.

The wiring OEL functions, for example, as a wiring for sending a signal to switch the on state and the off state of the transistor F5. Specifically, for example, a high-level potential or a low-level potential may be input to the wiring OEL.

The current source CI has a function of making a constant current flow between the input terminal and the output terminal of the current source CI. The current source CIr has a function of making a constant current flow between the input terminal and the output terminal of the current source CIr. The magnitude of the current flowing from the current source CI and the magnitude of the current flowing from the current source CIr are preferably equal in the converter circuit ITRZD4 in FIG. 15.

An operation example of the converter circuit ITRZD4 in FIG. 15 is described.

First, the amount of current flowing from the converter circuit ITRZD4 to the wiring WCL through the transistor F4 is, and the amount of current flowing from the converter circuit ITRZD4 to the wiring WCLr through the transistor F4r is I_{Sr}. The current amount flowing from each of the current source CI and the current source CIr is I₀.

I_{S} the sum of the amount of current flowing through the cell IM[1, j] to the cell IM[m, j] positioned in the j-th column in the arithmetic circuit MAC2 in FIG. 13, for example. I_{Sr} is the sum of the amount of current flowing through the cell IMr[1, j] to the cell IMr[m, j] positioned in the j-th column in the arithmetic circuit MAC2 in FIG. 13, for example.

When a high-level potential is input to the wiring SWL2, the transistor F4 and the transistor F4r are turned on. Accordingly, the amount of current flowing from the first terminal to the third terminal of the current mirror circuit CM1 is I₀−I_{S}. Due to the current mirror circuit CM1, the current amount I₀−I_{S} flows from the fourth terminal to the second terminal of the current mirror circuit CM1.

Next, a high-level potential is input to the wiring OEL to turn on the transistor F5. When the amount of current flowing through the wiring OL is Iₒᵤₜ, Iₒᵤₜ is I₀−(I₀−I_{S})−I_{Sr}=I_{S}−I_{Sr}.

In the arithmetic circuit MAC2 in FIG. 13, for retaining the first data in the circuit CES to perform a product-sum operation of the positive, negative, or “0” first data and the positive or “0” second data, the above example of retaining the first data is referred to.

That is, to retain the positive first data in the circuit CES[i, j], the cell IM[i, j] is set such that the current amount corresponding to the absolute value of the positive first data flows between the first terminal and the second terminal of the transistor F2 of the cell IM[i, j], and the cell IMr[i, j] is set such that current does not flow between the first terminal and the second terminal of the transistor F2r of the cell IMr[i, j]. To retain the negative first data in the circuit CES[i, j], the cell IM[i, j] is set such that current does not flow between the first terminal and the second terminal of the transistor F2 of the cell IM[i, j], and the cell IMr[i, j] is set such that the current amount corresponding to the absolute value of the negative first data flows between the first terminal and the second terminal of the transistor F2r of the cell IMr[i, j]. To retain “0” first data in the circuit CES[i, j], the cell IM[i, j] is set such that current does not flow between the first terminal and the second terminal of the transistor F2 of the cell IM[i, j], and the cell IMr[i, j] is set such that current does not flow between the first terminal and the second terminal of the transistor F2r of the cell IMr[i, j]

When the second data is input to each of the wiring XCL[1] to the wiring XCL[m] of the arithmetic circuit MAC2 in FIG. 13, the current amount flowing between the first terminal and the second terminal of the transistor F2 of the cell IM[i, j] and the current amount flowing between the first terminal and the second terminal of the transistor F2 of the cell IMr[i, j] are each proportional to the second data.

I_{S} the sum of the amount of current flowing through the cell IM[1, j] to the cell IM[m, j] positioned in the j-th column. Thus, I_{S} the sum of the amount of current flowing in the cells IM included in the circuits CES in which the positive first data is retained out of the circuit CES[1, j] to the circuit CES[m, j]; I_{S} can be represented in a manner similar to Formula (2.1), for example. That is, I_{S} corresponds to the result of product-sum operation of the absolute value of the positive first data and the second data. I_{Sr} is the sum of the amount of current flowing through the cell IMr[1, j] to the cell IMr[m, j] positioned in the j-th column. Thus, I_{Sr} is the sum of the amount of current flowing in the cells IMr included in the circuits CES in which the negative first data is retained out of the circuit CES[1, j] to the circuit CES[m, j]; I_{Sr} can be represented in a manner similar to Formula (2.2), for example. That is, I_{Sr} corresponds to the result of a product-sum operation of the absolute value of the negative first data and the second data.

Thus, the current amount Iₒᵤₜ=I_{S}−I_{Sr} flowing to the wiring OL corresponds to the difference between the result of the product-sum operation of the absolute value of the positive first data and the second data and the result of the product-sum operation of the absolute value of the negative first data and the second data. That is, Iₒᵤₜ=I_{S}−I_{Sr} corresponds to the result of the product-sum operation of the negative, “0”, or positive first data retained in the circuit CES[1, j] to the circuit CES[m, j] and the second data input to each of the wiring XCL[1] to the wiring XCL[m].

When the sum of the amount of current flowing in the cell IM[1, j] to the cell IM[m, j] is larger than the sum of the amount of current flowing in the cell IMr[1, j] to the cell IMr[m, j], or I_{S} larger than I_{Sr}, Iₒᵤₜ is the current amount larger than 0 and flows from the converter circuit ITRZD4 to the wiring OL. In contrast, when the sum of the amount of current flowing in the cell IM[1, j] to the cell IM[m, j] is smaller than the sum of the amount of current flowing in the cell IMr[1, j] to the cell IMr[m, j], or I_{S} smaller than I_{Sr}, current does not flow from the converter circuit ITRZD4 to the wiring OL in some cases. That is, when I_{S} smaller than I_{Sr}, Iₒᵤₜ can be approximately 0. Therefore, the converter circuit ITRZD4 can be regarded as a ReLU function, for example.

A ReLU function can be used as an activation function in a hierarchical neural network, for example. In the arithmetic operation in a hierarchical neural network, a product sum of the signal values (e.g., second data) from the neurons in the previous layer and the corresponding coefficient of weight (e.g., first data) is required to be calculated. In response to the result of the product sum, the value of an activation function is required to be calculated. Thus, when the activation function in a hierarchical neural network is the ReLU function, the arithmetic operation of the neural network can be performed with the arithmetic circuit MAC2 including the converter circuit ITRZD4.

The hierarchical neural network will be described in Embodiment 4.

Next, a specific circuit configuration example of the converter circuit ITRZD4 in FIG. 15 is described.

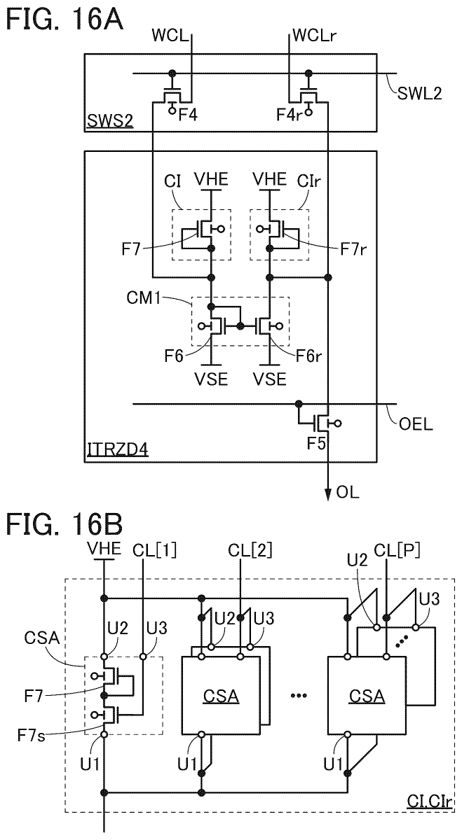

The converter circuit ITRZD4 shown in FIG. 16A is an example of the converter circuit ITRZD4 in FIG. 15. Specifically, FIG. 16A shows configuration examples of the current mirror circuit CM1, the current source CI, and the current source CIr.

In the converter circuit ITRZD4 in FIG. 16A, the current mirror circuit CM1 includes a transistor F6 and a transistor For, the current source CI includes a transistor F7, and the current source CIr includes a transistor F7r, for example. The transistor F6, the transistor For, the transistor F7, and the transistor F7r are n-channel transistors.

For example, the first terminal of the current mirror circuit CM1 is electrically connected to a first terminal of the transistor F6, a gate of the transistor F6, and a gate of the transistor For, and the third terminal of the current mirror circuit CM1 is electrically connected to a second terminal of the transistor F6. The second terminal of the current mirror circuit CM1 is electrically connected to a first terminal of the transistor For, and a fourth terminal of the current mirror circuit CM1 is electrically connected to a second terminal of the transistor F6r.

The output terminal of the current source CI is electrically connected to a first terminal of the transistor F7 and a gate of the transistor F7, and the input terminal of the current source CI is electrically connected to a second terminal of the transistor F7, for example.

The output terminal of the current source CIr is electrically connected to a first terminal of the transistor F7r and a gate of the transistor F7r, and the input terminal of the current source CIr is electrically connected to a second terminal of the transistor F7r.

The gate and the first terminal of each of the transistor F7 and the transistor F7r are electrically connected, and the second terminal thereof and the wiring VHE are electrically connected. Thus, the voltage between the gate and the source of each of the transistor F7 and the transistor F7r is 0 V, and when the threshold voltages of the transistor F7 and the transistor F7r are within an appropriate range, current within the current range in which the transistors operate in the subthreshold region flows between the first terminal and the second terminal of each of the transistor F7 and the transistor F7r. In other words, the transistor F7 and the transistor F7r function as constant current sources.

The configurations of the current source CI and the current source CIr included in the converter circuit ITRZD4 in FIG. 15 are not limited to the current source CI and the current source CIr shown in FIG. 16A. The configurations of the current source CI and the current source CIr included in the converter circuit ITRZD4 can be changed depending on circumstances.

For example, the structure shown in FIG. 16B can be used as the current source CI and the current source CIr included in the converter circuit ITRZD4 in FIG. 15.

The current source CI (current source CIr) in FIG. 16B has a plurality of current sources CSA, for example. Each of the plurality of current sources CSA includes the transistor F7, a transistor F7s, a terminal U1, a terminal U2, and a terminal U3.

For example, the current source CSA has a function of making the current amount I_{CSA} flow between the terminal U2 and the terminal U1. When the current source CI (current source CIr) includes 2^{P}−1 current source(s) CSA (P is an integer greater than or equal to 1), the current source CI (current source CIr) can make the current amount s×I_{CSA} (s is an integer more than or equal to 0 and less than or equal to 2^{P}−1) flow to the output terminal.

When the current source CI (current source CIr) is manufactured, the transistors in each current sources CSA may have different electrical characteristics, resulting in errors in some cases. The errors of the constant current I_{CSA} output from the terminals U1 of the plurality of current sources CSA are preferably within 10%, more preferably within 5%, and further preferably within 1%. In this embodiment, the description is made based on the assumption that there is no error in the constant current I_{CSA} output from the terminals U1 of the plurality of current sources CSA included in the current source CI (current source CIr).

One of the plurality of current sources CSA, a first terminal of the transistor F7s is electrically connected to the terminal U1, and a gate of the transistor F7s is electrically connected to the terminal U3. A first terminal of the transistor F7 is electrically connected to a gate of the transistor F7 and a second terminal of the transistor F7s. A second terminal of the transistor F7 is electrically connected to the terminal U2.

Each terminal U1 of the plurality of current sources CSA is electrically connected to the output terminal of the current source CI (current source CIr). Each terminal U2 of the plurality of current sources CSA is electrically connected to the input terminal of the current source CI (current source CIr). That is, each terminal U2 of the plurality of current sources CSA is electrically continuous with the wiring VHE.

The terminal U3 of one current source CL[1] is electrically connected to the wiring CL[1], the terminals U3 of two current sources CS are electrically connected to the wiring CL[2], and the terminals U3 of 2^{P-1} current sources CS are electrically connected to the wiring CL[P].

The wiring CL[1] to the wiring CL[P] each function as a wiring for sending a control signal to make the current source(s) CSA, to which the wiring is connected, output the constant current I_{CSA}. Specifically, for example, when a high-level potential is supplied to the wiring CL[1], the current source CSA electrically connected to the wiring CL[1] supplies I_{CSA} as a constant current to the terminal U1, and when a low-level potential is supplied to the wiring CL[1], the current source CSA electrically connected to the wiring CL[1] does not output I_{CSA}. When a high-level potential is supplied to the wiring CL[2], two current sources CSA electrically connected to the wiring CL[2] supply 2I_{CSA} in total as a constant current to the terminal U1, and when a low-level potential is supplied to the wiring CL[2], the current source CSA electrically connected to the wiring CL[2] does not output 2I_{CSA} in total, for example. When a high-level potential is supplied to the wiring CL[P], 2^{P-1} current sources CSA electrically connected to the wiring CL[P] supply 2^{P-1}I_{CSA} in total as a constant current to the terminal U1, and when a low-level potential is supplied to the wiring CL[P], the current source CSA electrically connected to the wiring CL[P] does not output 2^{P-1}I_{CSA} in total, for example.

Accordingly, when one or more wirings selected from the wiring CL[1] to the wiring CL[P] is/are supplied with high potentials, current flows to the output terminal of the current source CI (current source CIr). The current amount can be determined through the combination of one or more wirings to which a high-level potential is supplied that are selected from the wiring CL[1] to the wiring CL[P]. For example, when a high-level potential is supplied to the wiring CL[1] and the wiring CL[2] and a low-level potential is supplied to the wiring CL[3] (not shown) to the wiring CL[P], the current with 3I_{CSA} in total flows to the output terminal of the current source CI (current source CIr).

As described above, with the use of the current source CI (current source CIr) in FIG. 16B, the current amount flowing by the current source CI (current source CIr) to its output terminal can be changed depending on circumstances.

When the converter circuit ITRZD4 in FIG. 16A is used as the converter circuit ITRZD4 in FIG. 15, all the transistors included in the converter circuit ITRZD4 can be OS transistors. The cell array CA, the circuit WCS, the circuit XCS, and the like in the arithmetic circuit MAC2 can be formed using only OS transistors; the converter circuit ITRZD4 can be formed at the same time as the cell array CA, the circuit WCS, the circuit XCS, and the like. Thus, the manufacturing process of the arithmetic circuit MAC2 can be shortened in some cases. The same applies to the case where the current source CI (current source CIr) in FIG. 16B is used as the current source CI and the current source CIr of the converter circuit ITRZD4 in FIG. 16A.

For example, since the current source CI and the current source CIr included in the converter circuit ITRZD4 in FIG. 15 need to make the same current flow, the current source CI and the current source CIr can be replaced with a current mirror circuit.

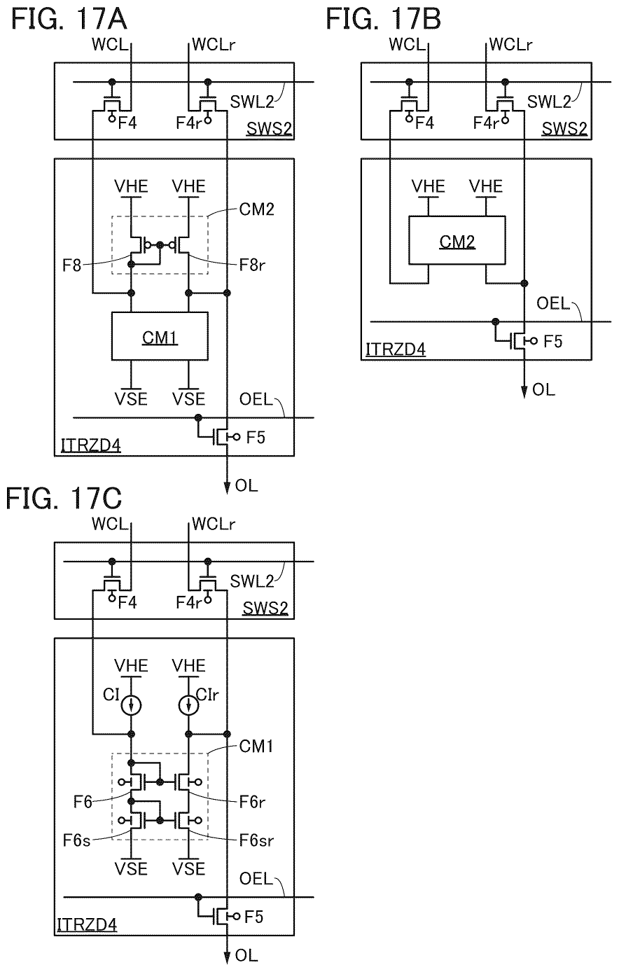

The converter circuit ITRZD4 in FIG. 17A has a configuration in which the current source CI and the current source CIr included in the converter circuit ITRZD4 in FIG. 15 are replaced with a current mirror circuit CM2. The current mirror circuit CM2 includes a transistor F8 and a transistor F8r, for example. Note that the transistor F8 and the transistor F8r are p-channel transistors.

A first terminal of the transistor F8 is electrically connected to a gate of the transistor F8, a gate of the transistor F8r, the second terminal of the transistor F4, and the first terminal of the current mirror circuit CM1. A second terminal of the transistor F8 is electrically connected to the wiring VHE. A first terminal of the transistor F8r is electrically connected to the second terminal of the transistor F4r and the second terminal of the current mirror circuit CM1. A second terminal of the transistor F8r is electrically connected to the wiring VHE.

As shown in the converter circuit ITRZD4 in FIG. 17A, the current source CI and the current source CIr included in the converter circuit ITRZD4 in FIG. 15 are replaced with the current mirror circuit CM2, whereby current with substantially the same current amount can flow through the connection point of the second terminal of the transistor F4 and the first terminal of the current mirror circuit CM1 and the connection point of the second terminal of the transistor F4r, the second terminal of the current mirror circuit CM1, and the first terminal of the transistor F5.

The current mirror circuit CM2 includes the transistor F8 and the transistor F8r in FIG. 17A; however, the circuit configuration of the current mirror circuit CM2 is not limited thereto. For example, as in FIG. 17C described later, the current mirror circuit CM2 may have a configuration in which the transistors included in the current mirror circuit CM2 have a cascode connection. As described above, the circuit configuration of the current mirror circuit CM2 in FIG. 17A may be changed depending on circumstances.

As in the configuration of the converter circuit ITRZD4 in FIG. 17B, the converter circuit ITRZD4 in FIG. 17A does not necessarily include the current mirror circuit CM1. In the converter circuit ITRZD4 in FIG. 17B, the amount of current flowing from the first terminal of the current mirror circuit CM2 to the second terminal of the transistor F4 can be substantially equal to the amount of current flowing from the second terminal of the current mirror circuit CM2 to the connection point of the second terminal of the transistor F4r and the first terminal of the transistor F5. Therefore, in the case where I_{S} larger than the I_{Sr}, the amount of current flowing through the wiring OL in FIG. 17B can be I_{S}−I_{Sr} as in the converter circuit ITRZD4 in FIG. 15.

The converter circuit ITRZD4 in FIG. 17B does not include the current mirror circuit CM1, and thus can have a circuit area smaller than that of the converter circuit ITRZD4 in FIG. 17A. Since no constant current flows from the current mirror circuit CM2 to the current mirror circuit CM1, the converter circuit ITRZD4 in FIG. 17B can have lower power consumption than the converter circuit ITRZD4 in FIG. 17A.

In FIG. 17B, the transistor F8 and the transistor F8r are not shown, and the current mirror circuit CM2 is shown as a block diagram. Thus, the configuration of the current mirror circuit CM2 in FIG. 17B can be determined depending on circumstances, as is the case with the current mirror circuit CM2 in FIG. 17A.

The current mirror circuit CM1 included in the converter circuit ITRZD4 in FIG. 15 is not limited to the current mirror circuit CM1 in FIG. 16A. The configuration of the current mirror circuit CM1 included in the converter circuit ITRZD4 in FIG. 16A can be changed depending on circumstances.

For example, the current mirror circuit CM1 shown in FIG. 17C can be used as the current mirror circuit CM1 included in the converter circuit ITRZD4 in FIG. 15. In the current mirror circuit CM1 shown in FIG. 17C, an n-channel transistor F6s and an n-channel transistor F6sr are further provided in the current mirror circuit CM1 in FIG. 16A; the transistor F6 and the transistor F6s are cascode-connected, and the transistor For and the transistor F6sr are cascode-connected. As shown in FIG. 17C, the transistors included in the current mirror circuit are cascode-connected, whereby the stability of the operation of the current mirror circuit can be improved.

### <Configuration Example 2 of Arithmetic Circuit>

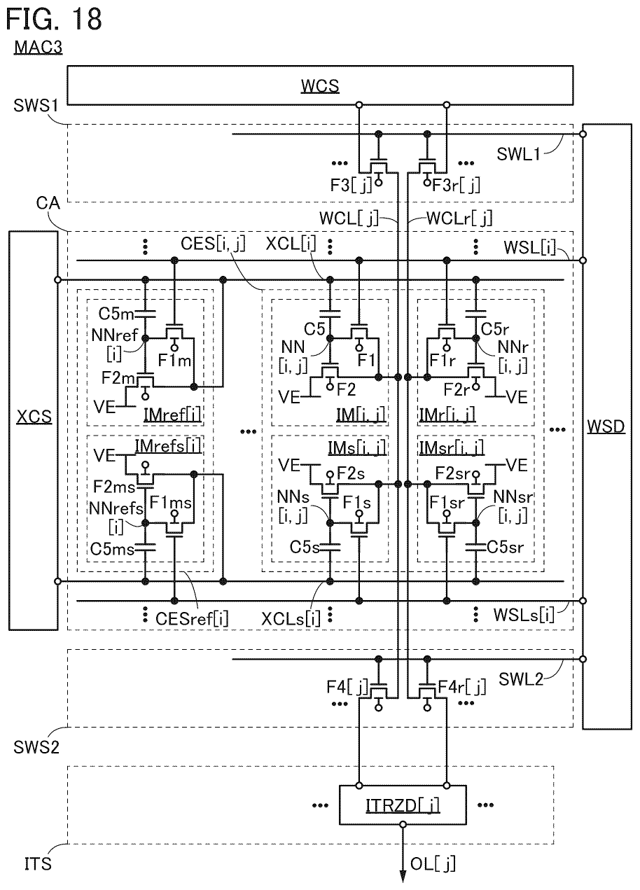

FIG. 18 shows a configuration example of an arithmetic circuit which performs a product-sum operation of the positive, negative, or “0” first data and the positive, negative, or “0” second data. An arithmetic circuit MAC3 shown in FIG. 18 has a structure in which the arithmetic circuit MAC2 in FIG. 13 is changed. Thus, the portions in the arithmetic circuit MAC3 that are the same as in the arithmetic circuit MAC1 and the arithmetic circuit MAC2 are not described.

The circuit CES[i, j] shown in FIG. 18 includes a cell IMs[i, j] and a cell IMsr[i, j] in addition to the cell IM[i, j] and the cell IMr[i, j]. In FIG. 18, the circuit CES[i, j] is shown, and the other circuit CES are omitted. In this specification and the like, when the circuit CES[i, j], the cell IM[i, j], the cell IMr[i, j], the cell IMs[i, j], the cell IMsr[i, j] and the like are described, [i, j] and the like that are added to the reference letters may be omitted.

The cell IMs and the cell IMsr can have configurations similar to that of the cell IM. FIG. 18 illustrates the cell IMs and the cell IMsr having configurations similar to that of the cell IM, for example. To distinguish the transistors, the capacitors, and the like included in the cell IM, the cell IMs, and the cell IMsr, “s” is added to the reference numerals representing the transistors and the capacitor included in the cell IMs and “sr” is added to the reference numerals representing the transistors and the capacitor included in the cell IMsr.

Specifically, the cell IMs includes a transistor F1s, a transistor F2s, and a capacitor C5s. The transistor F1s corresponds to the transistor F1 in the cell IM, the transistor F2s corresponds to the transistor F2 in the cell IM, and the capacitor C5s corresponds to the capacitor C5 in the cell IM. Thus, for the electrical connection configuration between the transistor F1s, the transistor F2s, and the capacitor C5s, the descriptions on IM[1, 1] to the cell IM[m, n] in Embodiment 2 are referred to.

Furthermore, the cell IMsr includes a transistor F1sr, a transistor F2sr, and a capacitor C5sr. The transistor F1sr corresponds to the transistor F1 in the cell IM, the transistor F2sr corresponds to the transistor F2 in the cell IM, and the capacitor C5sr corresponds to the capacitor C5 in the cell IM. Thus, for the electrical connection configuration between the transistor F1sr, the transistor F2sr, and the capacitor C5sr, the descriptions on IM[1, 1] to the cell IM[m, n] in Embodiment 2 are referred to, as in the case with the cell IMr.

In the cell IMs, a connection portion of the first terminal of the transistor F1s, a gate of the transistor F2s, and a first terminal of the capacitor C5s is a node NNs, and in the cell IMsr, the connection portion of a first terminal of the transistor F1sr, a gate of the transistor F2sr, and a first terminal of the capacitor C5sr is a node NNsr.

In the circuit CES[i, j], the second terminal of the capacitor C5 is electrically connected to the wiring XCL[i], the gate of the transistor F1 is electrically connected to the wiring WSL[i], and the second terminal of the transistor F1 and the second terminal of the transistor F2 are electrically connected to the wiring WCL[j]. The second terminal of the capacitor C5r is electrically connected to the wiring XCL[i], the gate of the transistor F1r is electrically connected to the wiring WSL[i], and the second terminal of the transistor F1r and the second terminal of the transistor F2r are electrically connected to the wiring WCLr[j].

A second terminal of the capacitor C5s is electrically connected to a wiring XCLs[i], a gate of the transistor F1s is electrically connected to a wiring WSLs[i], and a second terminal of the transistor F1s and a second terminal of the transistor F2s are electrically connected to the wiring WCL[j]. A second terminal of the capacitor C5sr is electrically connected to the wiring XCLs[i], a gate of the transistor F1sr is electrically connected to the wiring WSLs[i], and a second terminal of the transistor F1sr and a second terminal of the transistor F2sr are electrically connected to the wiring WCLr[j].

The circuit CESref[i] shown in FIG. 18 includes a cell IMrefs[i] in addition to the cell IMref[i]. In FIG. 18, the circuit CESref[i] is shown, and the other circuits CESref are omitted. In this specification and the like, when the circuit CESref[i], the cell IMref[i], the cell IMrefs[i] and the like are described, [i] and the like that are added to the reference letters may be omitted.

The cell IMrefs can have a configuration similar to that of the cell IMref. FIG. 18 shows the cell IMrefs having a similar configuration to that of the cell IMref, for example. To distinguish the transistors, the capacitors, and the like included in the cell IMref and the cell IMrefs, “s” is added to the reference letters representing the transistors and the capacitor included in the cell IMrefs.

Specifically, the cell IMrefs includes a transistor F1ms, a transistor F2ms, and a capacitor C5ms. The transistor F1ms corresponds to the transistor F1m in the cell IMref, the transistor F2ms corresponds to the transistor F2m in the cell IMref, and the capacitor C5ms corresponds to the capacitor C5m in the cell IMref. Thus, for the electrical connection configuration between the transistor F1ms, the transistor F2ms, and the capacitor C5ms, the descriptions on IMref[1] to the cell IMref[m] in Embodiment 2 are referred to.

In the cell IMrefs, a connection portion of a first terminal of the transistor F1ms, a gate of the transistor F2ms, and the first terminal of the capacitor C5ms is a node NNrefs.

In the circuit CESref[i], a second terminal of the capacitor C5m is electrically connected to the wiring XCL[i], the gate of the transistor F1m is electrically connected to the wiring WSL[i], and the second terminal of the transistor F1m and the second terminal of the transistor F2m are electrically connected to the wiring XCL[i]. A second terminal of the capacitor C5ms is electrically connected to the wiring XCLs[i], a gate of the transistor F1ms is electrically connected to the wiring WSLs[i], and a second terminal of the transistor F1ms and a second terminal of the transistor F2ms are electrically connected to the wiring XCLs[i].

Like the wiring XCL[1] to the wiring XCL[m] described in Embodiment 2, the wiring XCL[i] and the wiring XCLs[i] function as wirings which supply current from the circuit XCS to the cell IM, the cell IMr, the cell IMs, and the cell IMsr included in the circuit CES, and as wirings which supply current from the circuit XCS to the cell IMref and the cell IMrefs included in the circuit CESref, for example.

Like the wiring WSL[1] to the wiring WSL[m] described in Embodiment 2, the wiring WSL[i] and the wiring WSLs[i] function as wirings to send a selection signal for writing the first data from the circuit WSD to the cell IM, the cell IMr, the cell IMs, and the cell IMsr included in the circuit CES, and wirings to send a selection signal for writing reference data from the circuit WSD to the cell IMref and the cell IMrefs included in the circuit CESref, for example.

As the converter circuit ITRZD[j] included in the arithmetic circuit MAC3 in FIG. 18, a circuit that can be used for the converter circuit ITRZD[j] included in the arithmetic circuit MAC2 in FIG. 13 can be used. In other words, as the converter circuit ITRZD[j] included in the arithmetic circuit MAC3, the converter circuit ITRZD1 to the converter circuit ITRZD3 shown in FIG. 14A to FIG. 14C can be used.

### <<Example of Retaining First Data and Inputting Second Data>>

Next, an example in which the first data is retained in the circuit CES and an example in which the second data is input to the circuit CES, which are for performing a product-sum operation of the positive, negative, or “0” first data and the positive, negative, or “0” second data in the arithmetic circuit MAC3 in FIG. 18, are described.

Since the circuit CES includes the cell IM, the cell IMr, the cell IMs, and the cell IMsr, the circuit CES can use the four circuits, i.e., the cell IM, the cell IMr, the cell IMs, and the cell IMsr, to retain the first data. In other words, four current amounts are set for the circuit CES and potentials corresponding to the current amounts can be retained in the cell IM, the cell IMr, the cell IMs, and the cell IMsr. Thus, the first data can be represented with the current amount set in the cell IM, the current amount set in the cell IMr, the current amount set in the cell IMs, and the current amount set in the cell IMsr. The positive first data, the negative first data, or the “0” first data to be retained in the circuit CES is defined as follows.

To retain the positive first data in the circuit CES[i, j], the cell IM[i, j] is set such that the current amount corresponding to the absolute value of the positive first data flows through the transistor F2 in the cell IM[i, j] and the current amount corresponding to the absolute value of the positive first data flows through the transistor F2sr in the cell IMsr[i, j] for example. Specifically, the potential corresponding to the current amount is retained in the gate of the transistor F2 (node NN[i, j]) and the gate of the transistor F2sr (node NNsr[i, j]). The cell IMr[i, j] is set such that current does not flow through the transistor F2r in the cell IMr[i, j] and current does not flow through the transistor F2s in the cell IMs[i, j]. Specifically, the gate of the transistor F2r (node NNr[i, j]) and the gate of the transistor F2s (node NNs[i, j]) retain the potential supplied by the wiring VE or the initialization potential supplied by the wiring VINIL1 of the circuit WCS in FIG. 6A, for example.

To retain the negative first data in the circuit CES[i, j], the cell IMr[i, j] is set such that the current amount corresponding to the absolute value of the negative first data flows through the transistor F2r in the cell IMr[i, j], and the current amount corresponding to the absolute value of the negative first data flows through the transistor F2s in the cell IMs[i, j] for example. Specifically, the potential corresponding to the current amount is retained in the gate of the transistor F2r (node NNr[i, j]) and the gate of the transistor F2s (node NNs[i, j]). The cell IM[i, j] is set such that current does not flow through the transistor F2 in the cell IM[i, j] and current does not flow through the transistor F2sr in the cell IMsr[i, j]. Specifically, the gate of the transistor F2 (node NN[i, j]) and the gate of the transistor F2sr (node NNsr[i, j]) retains the potential supplied by the wiring VE or the initialization potential supplied by the wiring VINIL1 of the circuit WCS in FIG. 6A, for example.

To retain the “0” first data in the circuit CES[i, j], the transistor F2 of the cell IM[i, j], the transistor F2r of the cell IMr[i, j], the transistor F2s of the cell IMs[i, j], and the transistor F2sr of the cell IMsr[i, j] are set such that current do not flow through these transistors, for example. Specifically, the gate of the transistor F2 (node NN[i, j]), the gate of the transistor F2r (node NNr[i, j]), the gate of the transistor F2s (node NNs[i, j]), and the gate of the transistor F2sr (node NNsr[i, j]) retain the potential supplied by the wiring VE or the initialization potential supplied by the wiring VINIL1 of the circuit WCS in FIG. 6A, for example.

To retain the positive first data or the negative first data in another circuit CES, it is set that current with the current amount corresponding to the first data flow through one of the following pairs of the paths: a pair of the paths between the cell IM and the wiring WCL and between the cell IMsr and the wiring WCLr and a pair of the paths between the cell IMr and the wiring WCLr and between the cell IMs and the wiring WCL while current do not flow between the other pair of the paths, as in the circuit CES[i, j] described above. To retain the “0” first data in another circuit CES, it is set that current do not flow between the cell IM and the wiring WCL, between the cell IMr and the wiring WCLr, between the cell IMs and the wiring WCL, and between the cell IMsr and the wiring WCLsr, as in the circuit CES[i, j] described above.

To retain each of “+3”, “+2”, “+1”, “0”, “−1”, “−2”, and “−3” in the circuit CES as the first data, for example, the amount of current flowing from the wiring WCL to the cell IM, the amount of current flowing from the wiring WCLr to the cell IMr, the amount of current flowing from the wiring WCL to the cell IMs, and the amount of current flowing from the wiring WCLsr to the cell IMsr are set as described above, whereby each “+3”, “+2”, “+1”, “0”, “−1”, “−2”, and “−3” as the first data can be defined as shown in the following table.

TABLE 2

| | Current flowing | Current flowing | Current flowing | Current flowing |
|---|---|---|---|---|
| | from wiring | from wiring | from wiring | from wiring |
| First data | WCL to cell IM | WCLr to cell IMr | WCL to cell IMs | WCLr to cell IMsr |
| +3 | 3 I_{Wut} | 0 | 0 | 3 I_{Wut} |
| +2 | 2 I_{Wut} | 0 | 0 | 2 I_{Wut} |
| +1 | I_{Wut} | 0 | 0 | I_{Wut} |
| 0 | 0 | 0 | 0 | 0 |
| −1 | 0 | I_{Wut} | I_{Wut} | 0 |
| −2 | 0 | 2 I_{Wut} | 2 I_{Wut} | 0 |
| −3 | 0 | 3 I_{Wut} | 3 I_{Wut} | 0 |

On the other hand, as a wiring for inputting the second data, the wiring XCL and the wiring XCLs are electrically connected to the circuit CES. Thus, two signals can be input as the second data to the circuit CES. In other words, the second data can be represented by the signal input to the wiring XCL and the signal input to the wiring XCLs and input to the circuit CES. The positive second data, the negative second data, or the “0” second data to be input to the circuit CES is defined as follows.

To input the positive second data in the circuit CES[i, j], the cell IMref[i] is set such that the current amount corresponding to the absolute value of the positive second data flows through the transistor F2m in the cell IMref[i], for example. Specifically, the potential corresponding to the current amount is retained in the gate of the transistor F2m (node NNref[i]). In contrast, the cell IMrefs[i] is set such that current does not flow through the transistor F2ms in the cell IMrefs[i]. Specifically, the gate of the transistor F2ms (node NNrefs[i]) retains the potential supplied by the wiring VE or the initialization potential supplied by the wiring VINIL2 of the circuit XCS in FIG. 6C, for example.

To input the negative second data in the circuit CES[i, j], the cell IMrefs[i] is set such that the current amount corresponding to the absolute value of the negative second data flows through the transistor F2ms in the cell IMrefs[i], for example. Specifically, the potential corresponding to the current amount is retained in the gate of the transistor F2ms (node NNrefs[i]). In contrast, the cell IMref[i] is set such that current does not flow through the transistor F2m in the cell IMref[i]. Specifically, the gate of the transistor F2m (node NNref[i]) retains the potential supplied by the wiring VE or the initialization potential supplied by the wiring VINIL2 of the circuit XCS in FIG. 6C, for example.

To input the “0” second data in the circuit CES[i, j], the transistor F2m of the cell IMref[i] and the transistor F2ms of the cell IMrefs[1] are set such that current do not flow through these transistors, for example. Specifically, the gate of the transistor F2m (node NNref[i]) and the gate of the transistor F2ms (node NNrefs[i]) retains the potential supplied by the wiring VE or the initialization potential supplied by the wiring VINIL2 of the circuit XCS in FIG. 6C, for example.

To input the positive second data or the negative second data in another circuit CES, it is set that current with the current amount corresponding to the second data flows through one of the path between the cell IMref and the wiring XCL and the path between the cell IMrefs and the wiring XCLs while current does not flow through the other of the path between the cell IMref and the wiring XCL and the path between the cell IMrefs and the wiring XCLs, as in the circuit CESref[i]. To input the “0” second data in another circuit CES, it is set that current does not flow between the cell IMref and the wiring XCL and between the cell IMrefs and the wiring XCLs, as in the circuit CESref[i].

For example, to store each case of “+3”, “+2”, “+1”, “0”, “−1”, “−2”, and “−3” in the circuit CES as the second data, the amount of current flowing from the wiring XCL to the cell IMref and the amount of current flowing from the wiring XCLs to the cell IMrefs are set as described above, whereby each of “+3”, “+2”, “+1”, “0”, “−1”, “−2”, and “−3” as the second data can be defined as shown in the following table.

TABLE 3

| | Current flowing | Current flowing |
|---|---|---|
| | from wiring XCL | from wiring XCLs |
| Second data | to cell IMref | to cell IMrefs |
| +3 | 3 I_{Xut} | 0 |
| +2 | 2 I_{Xut} | 0 |
| +1 | I_{Xut} | 0 |
| 0 | 0 | 0 |
| −1 | 0 | I_{Xut} |
| −2 | 0 | 2 I_{Xut} |
| −3 | 0 | 3 I_{Xut} |

When one of “+3”, “+2”, “+1”, “0”, “−1”, “−2”, and “−3” is retained in the circuit CES as the first data and one of “+1”, “0”, and “−1” is input to the circuit CES as the second data, the amount of current flowing from the wiring WCL to the cell IM and the cell IMs in the circuit CES, and the amount of current flowing from the wiring WCLr to the cell IMr and the cell IMsr in the circuit CES are considered.

For example, when the second data input to the circuit CES is “+1”, the potential corresponding to the absolute value of the “+1” second data is input to each of the second terminals of the capacitor C5 and the capacitor C5r from the wiring XCL, and the potential corresponding to the ground potential (GND) is input to each of the second terminals of the capacitor C5s and the capacitor C5sr of the circuit CES from the wiring XCLs. When the first data retained in the circuit CES is “+3”, the potential corresponding to the absolute value of the “+3” first data is retained in each of the node NN and the node NNsr, and the ground potential (GND) is retained in each of the node NNr and the node NNs. Between the first terminal and the second terminal of the transistor F2 in the circuit CES, the current amount 3I_{ref0} flows according to Formula (1.12) or Formula (1.16). Between the first terminals and the second terminals of the transistor F2r, the transistor F2s, and the transistor F2sr, current do not flow. In other words, current with the current amount 3I_{ref0} flows from the wiring WCL to the cell IM, and current do not flow from the wiring WCL to the cell IMs, from the wiring WCLr to the cell IMr, and does from the wiring WCLr to the cell IMsr.

For example, the second data input to the circuit CES is “+1” and the first data retained in the circuit CES is “−3”. Thus, the potential corresponding to the absolute value of the “−3” first data is retained in each of the node NNr and the node NNs, and the ground potential (GND) is retained in each of the node NN and the node NNsr. Between the first terminals and the second terminals of the transistor F2r in the circuit CES, the current amount 3I_{ref0} flows according to Formula (1.12) or Formula (1.16). Between the first terminals and the second terminals of the transistor F2, the transistor F2s, and the transistor F2sr, currents do not flow. In other words, the current amount 3I_{ref0} flows from the wiring WCLr to the cell IMr, and currents do not flow from the wiring WCL to the cell IM, from the wiring WCL to the cell IMs, and from the wiring WCLr to the cell IMsr.

For example, when the second data input to the circuit CES is “−1”, the potential corresponding to the absolute value of the “−1” second data is input to each of the second terminals of the capacitor C5s and the capacitor C5sr from the wiring XCLs, and the potential corresponding to the ground potential (GND) is input to each of the second terminals of the capacitor C5 and the capacitor C5r of the circuit CES from the wiring XCL. When the first data retained in the circuit CES is “+3”, the potential corresponding to the absolute value of the “+3” first data is retained in each of the node NN and the node NNsr, and each of the node NNr and the node NNs retains a ground potential (GND). Between the first terminal and the second terminal of the transistor F2sr in the circuit CES, the current amount 3I_{ref0} flows according to Formula (1.12) or Formula (1.16). Between the first terminals and the second terminals of the transistor F2, the transistor F2r, and the transistor F2s, current do not flow. In other words, the current amount 3I_{ref0} flows from the wiring WCLr to the cell IMsr, and current do not flow from the wiring WCL to the cell IM, from the wiring WCLr to the cell IMr, and from the wiring WCL to the cell IMs.

For example, the second data input to the circuit CES is “−1” and the first data retained in the circuit CES is “−3”. The potential corresponding to the absolute value of the “−3” first data is retained in each of the node NNr and the node NNs, and the ground potential (GND) is retained in each of the node NN and the node NNsr. Between the first terminal and the second terminal of the transistor F2s in the circuit CES, the current amount 3I_{ref0} flows according to Formula (1.12) or Formula (1.16). Between the first terminals and the second terminals of the transistor F2, the transistor F2r, and the transistor F2sr, current do not flow. In other words, the current amount 3I_{ref0} flows from the wiring WCL to the cell IMs, and current do not flow from the wiring WCL to the cell IM, from the wiring WCLr to the cell IMr, and from the wiring WCLr to the cell IMsr.

For example, when the second data input to the circuit CES is “0”, a ground potential (GND) is input to each of the second terminal of the capacitor C5 and the capacitor C5r of the circuit CES from the wiring XCL, and a ground potential (GND) is input to each of the second terminals of the capacitor C5s and the capacitor C5sr of the circuit CES from the wiring XCLs. At this time, even the first data retained in the circuit CES has some value, current do not flow between the first terminal and the second terminals of the transistor F2, the transistor F2r, the transistor F2s, and the transistor F2sr.

For example, when the first data retained in the circuit CES is “0”, each of the node NN, the node NNr, the node NNs, and the node NNsr retains a ground potential (GND). At this time, even the second data input to the circuit CES has some value, current do not flow between the first terminals and the second terminals of the transistor F2, the transistor F2r, the transistor F2s, and the transistor F2sr.

The cases where the first data is “+3”, “−3”, or “0” and the second data is “+1”, “−1”, or “0” have been described; when the same applies to the other cases, the amounts of current flowing in the wiring WCL and the wiring WCLr can be represented as the following table.

TABLE 4

| | | First | Current flowing | Current flowing | Current flowing | Current flowing |
|---|---|---|---|---|---|---|
| First | Second | data × Second | from wiring WCL | from wiring WCLr | from wiring WCL | from wiring WCLr |
| data | data | data | to cell IM | to cell IMr | to cell IMs | to cell IMsr |
| +3 | +1 | +3 | 3 I_{ref0} | 0 | 0 | 0 |
| +2 | +1 | +2 | 2 I_{ref0} | 0 | 0 | 0 |
| +1 | +1 | +1 | I_{ref0} | 0 | 0 | 0 |
| 0 | +1 | 0 | 0 | 0 | 0 | 0 |
| −1 | +1 | −1 | 0 | I_{ref0} | 0 | 0 |
| −2 | +1 | −2 | 0 | 2 I_{ref0} | 0 | 0 |
| −3 | +1 | −3 | 0 | 3 I_{ref0} | 0 | 0 |
| +3 | 0 | 0 | 0 | 0 | 0 | 0 |
| +2 | 0 | 0 | 0 | 0 | 0 | 0 |
| +1 | 0 | 0 | 0 | 0 | 0 | 0 |
| 0 | 0 | 0 | 0 | 0 | 0 | 0 |
| −1 | 0 | 0 | 0 | 0 | 0 | 0 |
| −2 | 0 | 0 | 0 | 0 | 0 | 0 |
| −3 | 0 | 0 | 0 | 0 | 0 | 0 |
| +3 | −1 | −3 | 0 | 0 | 0 | 3 I_{ref0} |
| +2 | −1 | −2 | 0 | 0 | 0 | 2 I_{ref0} |
| +1 | −1 | −1 | 0 | 0 | 0 | I_{ref0} |
| 0 | −1 | 0 | 0 | 0 | 0 | 0 |
| −1 | −1 | +1 | 0 | 0 | I_{ref0} | 0 |
| −2 | −1 | +2 | 0 | 0 | 2 I_{ref0} | 0 |
| −3 | −1 | +3 | 0 | 0 | 3 I_{ref0} | 0 |

As described above, product-sum operation of the positive, the negative, or “0” first data and the positive or “0” second data can be performed using the arithmetic circuit MAC2. In addition, product-sum operation of the positive, negative, or “0” first data and the positive, negative, or “0” second data can be performed using the arithmetic circuit MAC3.

One embodiment of the present invention is not limited to the circuit configurations of the arithmetic circuit MAC2 and the arithmetic circuit MAC3 described in this embodiment. The circuit configurations of the arithmetic circuit MAC2 and the arithmetic circuit MAC3 can be changed depending on circumstances. For example, the capacitor C5, the capacitor C5r, the capacitor C5s, the capacitor C5sr, the capacitor C5m, and the capacitor C5ms included in the arithmetic circuit MAC3 can be gate capacitances of transistors (not shown). In the arithmetic circuit MAC3, the capacitor C5, the capacitor C5r, the capacitor C5s, the capacitor C5sr, the capacitor C5m, and the capacitor C5ms are not necessarily provided when parasitic capacitances between the node NN, the node NNr, the node NNs, the node NNsr, the node NNref, and the node NNrefs and their nearby wirings are large.

Note that this embodiment can be combined with any of the other embodiments and the like in this specification or the like as appropriate.

### Embodiment 4

A hierarchical neural network is described in this embodiment. An arithmetic operation of a hierarchical neural network can be performed by using the semiconductor device described in the above embodiments.

### <Hierarchical Neural Network>

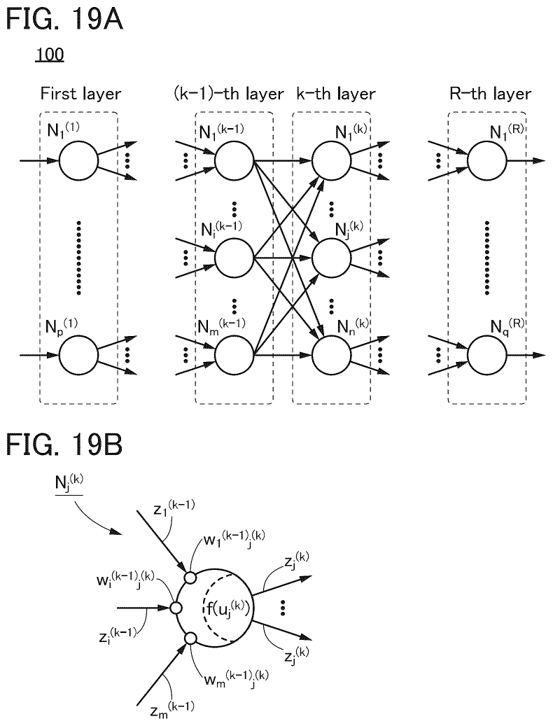

A hierarchical neural network includes one input layer, one or a plurality of intermediate layers (hidden layers), and one output layer, for example, and is configured with a total of at least three layers. A hierarchical neural network 100 shown in FIG. 19A is one example, and the neural network 100 includes a first layer to an R-th layer (here, R can be an integer greater than or equal to 4). Specifically, the first layer corresponds to the input layer, the R-th layer corresponds to the output layer, and the other layers correspond to the intermediate layers. Note that FIG. 19A shows the (k−1)-th layer and the k-th layer (here, k is an integer greater than or equal to 3 and less than or equal to R−1) as the intermediate layers, and does not show the other intermediate layers.

Each of the layers of the neural network 100 includes one or a plurality of neurons. In FIG. 19A, the first layer includes a neuron N₁⁽¹⁾ to a neuron Nₚ⁽¹⁾ (here, p is an integer greater than or equal to 1); the (k−1)-th layer includes a neuron N₁^{(k-1)} to a neuron Nₘ^{(k-1)} (here, m is an integer greater than or equal to 1); the k-th layer includes a neuron N₁^{(k)} to a neuron Nₙ^{(k)} (here, n is an integer greater than or equal to 1); and the R-th layer includes a neuron N₁^{(R)} to a neuron N_{q}^{(R)} (here, q is an integer greater than or equal to 1).

FIG. 19A shows a neuron

$${N}_{i}^{( k - 1 )}$$

(here, 1 is an integer greater than or equal to 1 and less than or equal to m) in the (k−1)-th layer and a neuron

$${N}_{j}^{( k )}$$

(here, j is an integer greater than or equal to 1 and less than or equal to n) in the k-th layer, in addition to the neuron N₁⁽¹⁾, the neuron Nₚ⁽¹⁾, the neuron N₁^{(k-1)}, the neuron Nₘ^{(k-1)}, the neuron N₁^{(k)}, the neuron Nₙ^{(k)}, the neuron N₁^{(R)}, and the neuron N_{q}^{(R)}; the other neurons are not shown.

Next, signal transmission from a neuron in one layer to a neuron in the subsequent layer and signals input to and output from the neurons are described. Note that description here is made focusing on the neuron

$${N}_{j}^{( k )}$$

in the k-th layer.

FIG. 19B shows the neuron

$${N}_{j}^{( k )}$$

in the k-th layer, signals input to the neuron

$${N}_{j}^{( k )} ,$$

and a signal output from the neuron

$${N}_{j}^{( k )} .$$

Specifically, z₁^{(k-1)} to zₘ^{(k-1)} (z₁^{(k-1)},

$${z}_{i}^{( k - 1 )}$$

(i is an integer greater than or equal to 1 and less than or equal to m), and zₘ^{(k-1)} are representatively shown in the drawing), which are respectively output signals from the neuron N₁^{(k-1)} to Nₘ^{(k-1)} in the (k−1)-th layer, are output to the neuron

$${N}_{j}^{( k )} .$$

Then, the neuron

$${N}_{j}^{( k )}$$

generates

$${z}_{j}^{( k )}$$

in accordance with z₁^{(k-1)} to zₘ^{(k-1)}, and outputs

$${z}_{j}^{( k )}$$

as the output signal to the neurons in the (k+1)-th layer (not shown).

The efficiency of transmitting a signal input from a neuron in one layer to a neuron in the subsequent layer depends on the connection strength (hereinafter referred to as a weight coefficient) of the connection of the neurons. In the neural network 100, a signal output from a neuron in one layer is multiplied by the corresponding weight coefficient and then is input to a neuron in the subsequent layer. When the weight coefficient for the connection of the neuron

$${N}_{i}^{( k - 1 )}$$

in the (k−1)-th layer and the neuron

$${N}_{j}^{( k )}$$

in the k-th layer is

$${{w}_{i}^{( k - 1 )}}_{j}^{( k )} ,$$

a signal input to the neuron

$${N}_{j}^{( k )}$$

in the k-th layer can be expressed with Formula (5.1).

$$\begin{matrix}[ Formula 20 ] & \\ {w}_{ij}^{( k - 1 ) ( k )} \cdot {z}_{i}^{( k - 1 )} & ( 5.1 )\end{matrix}$$

That is, when the signals are transmitted from the neuron

$${N}_{1}^{( k - 1 )}$$

to the neuron Nₘ^{(k-1)} in the (k−1)-th layer to the neuron

$${N}_{j}^{( k )}$$

in the k-th layer, the signals z₁^{(k-1)} to zₘ^{(k-1)} are multiplied by the respective weight coefficients

$$( {w}_{1 j}^{( k - 1 ) ( k )} to {w}_{mj}^{( k - 1 ) ( k )} ) .$$

### Then,

$${w}_{1 j}^{( k - 1 ) ( k )} .$$

z₁^{(k-1)} to

$${{w}_{m}^{( k - 1 )}}_{j}^{( k )} .$$

zₘ^{(k-1)} are input to the neuron

$${N}_{j}^{( k )}$$

in the k-th layer. At this time, the total sum

$${u}_{j}^{( k )}$$

of the signals input to the neuron

$${N}_{j}^{( k )}$$

in the k-th layer is expressed by Formula (5.2).

$$\begin{matrix}[ Formula 21 ] & \\ {u}_{j}^{( k )} = {\sum }_{i = 1}^{m} {{w}_{i}^{( k - 1 )}}_{j}^{( k )} \cdot {z}_{i}^{( k - 1 )} & ( 5.2 )\end{matrix}$$

In addition, a bias may be added to the result of the product-sum operation of the weight coefficients w₁^{(k-1)}ⱼ^{(k)} to wₘ^{(k-1)}ⱼ^{(k)} and the signals z₁^{(k-1)} to zₘ^{(k-1)} of the neurons. When the bias is denoted by b, Formula (5.2) can be rewritten as the following formula.

$$\begin{matrix}[ Formula 22 ] & \\ {u}_{j}^{( k )} = {\sum }_{i = 1}^{m} {{w}_{i}^{( k - 1 )}}_{j}^{( k )} \cdot {z}_{i}^{( k - 1 )} + b & ( 5.3 )\end{matrix}$$

The neuron

$${N}_{j}^{( k )}$$

generates the output signal

$${z}_{j}^{( k )}$$

in accordance with

$${u}_{j}^{( k )} .$$

Here, the output signal

$${z}_{j}^{( k )}$$

from the neuron

$${N}_{j}^{( k )}$$

is defined by the following formula.

$$\begin{matrix}[ Formula 23 ] & \\ {z}_{j}^{( k )} = f ( {u}_{j}^{( k )} ) & ( 5.4 )\end{matrix}$$

A function

$$f ( {u}_{j}^{( k )} )$$

is an activation function in the hierarchical neural network, and a step function, a linear ramp function, a sigmoid function, or the like can be used. Note that the activation function may be the same or different among all neurons. In addition, the neuron activation function may be the same or different between the layers.

Signals output from the neurons in the layers, the weight coefficients w, or the bias b may be an analog value or a digital value. For example, a binary or ternary digital value may be used. A value having a larger number of bits may be used. In the case of an analog value, for example, a linear ramp function or a sigmoid function is used as the activation function. In the case of a binary digital value, for example, a step function with an output of −1 or 1 or an output of 0 or 1 is used. Alternatively, the neurons in the layers may each output a ternary or higher-level signal; in this case, a function that outputs three or more values, for example, a step function with an output of −1, 0, or 1 or a step function with an output of 0, 1, or 2 is used as an activation function. Furthermore, as an activation function for outputting five values, a step function with an output of −2, −1, 0, 1, or 2 may be used, for example. Using a digital value as at least one of the signals output from the neurons in the layers, the weight coefficients w, and the bias b enables a reduction in the circuit scale, a reduction in power consumption, or an increase in operation speed, for example. In addition, the use of an analog value as at least one of a signal output from the neuron in each layer, the weight coefficient w, and the bias b can increase the accuracy of arithmetic operation.

The neural network 100 performs operation in which by input of an input signal to the first layer (the input layer), output signals are sequentially generated in the layers from the first layer (the input layer) to the last layer (the output layer) according to Formula (5.1), Formula (5.2) (or Formula (5.3)), and Formula (5.4) on the basis of the signals input from the previous layers, and the output signals are output to the subsequent layers. The signal output from the last layer (the output layer) corresponds to the calculation results of the neural network 100.

In the case where the arithmetic circuit MAC1 described in Embodiment 2 is used as the above-described hidden layer, the weight coefficient w_{s[k-1]}^{(k-1)}_{s[k]}^{(k)} (s[k−1] is an integer more than or equal to 1 and less than or equal to m, and s[k] is an integer more than or equal to 1 and less than or equal to n) is used as the first data, the current amount corresponding to the first data is stored in each of the cells IM in the same column sequentially, the output signal z_{s[k-1]}^{(k-1)} from the neuron N_{s[k-1]}^{(k-1)} in the (k−1)-th layer is used as the second data, and the current amount corresponding to the second data is supplied from the circuit XCS to the wiring XCL in each row, so that the product-sum of the first data and the second data can be obtained from the current amount I_{S} input to the converter circuit ITRZ. In addition, the value of the activation function is obtained using the product-sum value, so that the value of the activation function can be, as a signal, the output signal z_{s[k]}^{(k)} of the neuron N_{s[k]}^{(k)} in the k-th layer.

In the case where the arithmetic circuit MAC1 described in Embodiment 2 is used as the above-described output layer, the coefficient of weight w_{s[R-1]}^{(R-1)}_{s[R]}^{(R)} (s[R−1] is an integer more than or equal to 1 and s[R] is an integer more than or equal to 1 and less than or equal to q) is used as the first data, the current amount corresponding to the first data is stored in each of the cells IM in the same column sequentially, the output signal z_{s[R-1]}^{(L-1)} from the neuron N_{s[R-1]}^{(R-1)} in the (R−1)-th layer is used as the second data, and the current amount corresponding to the second data is made to flow from the circuit XCS to the wiring XCL in each row, so that the sum of products of the first data and the second data can be obtained from the current amount I_{S} input to the converter circuit ITRZ. In addition, the value of the activation function is obtained using the value of the sum of products, so that the value of the activation function can be, as a signal, the output signal z_{s[R]}^{(R)} of the neuron N_{s[R]}^{(R)} in the R-th layer.

Note that the input layer described in this embodiment may function as a buffer circuit that outputs an input signal to the second layer.

When the arithmetic circuit MAC2 described in Embodiment 3 in which the converter circuit ITRZD4 in FIG. 15 is used as the converter circuit ITRZD[j] is used as the hidden layer, the coefficient of weight w_{s[k-1]}^{(k-1)}_{s[k]}^{(k)} is the first data, the amount of current corresponding to the first data is stored consecutively in the cells IM and the cells IMr of the circuit CES in the same row, an output signal z_{s[k-1]}^{(k-1)} from the neuron N_{s[k-1]}^{(k-1)} in the (k−1)-th layer is the second data, and the current amount corresponding to the second data flows from the circuit XCS to the wiring XCL in each row, whereby the value of the activation function corresponding to the product-sum operation of the first data and the second data from the current amounts I_{S} and I_{Sr} input to the converter circuit ITRZD4. That is, the value can be an output signal z_{s[k]}^{(k)} from a neuron N_{s[k]}^{(k)} in the k-th layer as a signal. Since the converter circuit ITRZD4 outputs the current amount corresponding to the value, the output signal z_{s[k]}^{(k)} from the neuron N_{s[k]}^{(k)} in the k-th layer input to the (k+1)-th layer can be a current, for example. That is, in the case where the arithmetic circuit MAC2 is used as the hidden layer of the (k+1)-th layer, the output signal z_{s[k]}^{(k)} from the neuron N_{s[k]}^{(k)} in the k-th layer input to the wiring XCL of the arithmetic circuit MAC2 is not generated in the circuit XCS but can be current output from the converter circuit ITRZD4 of the arithmetic circuit MAC2 of the hidden layer in the k-th layer.

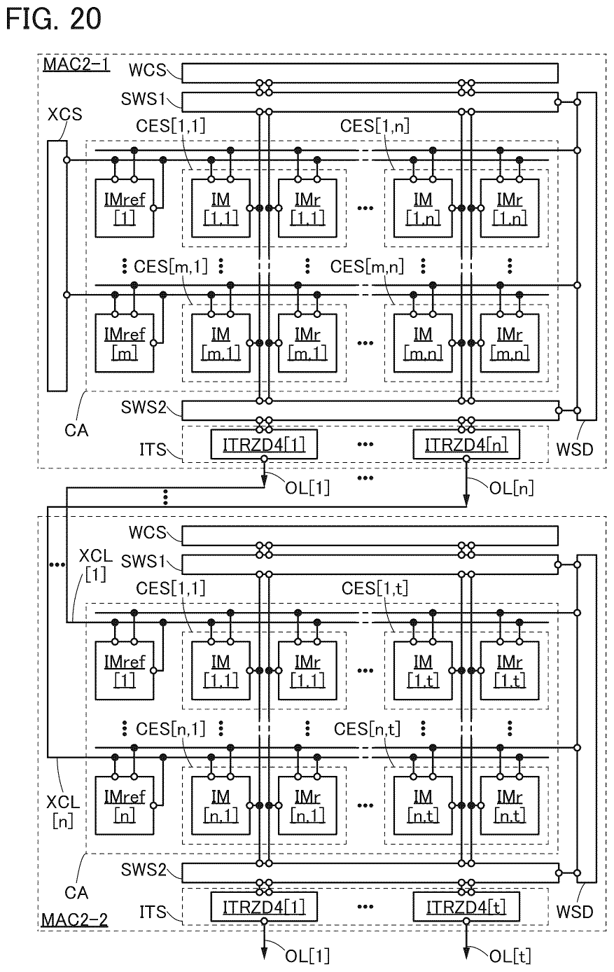

Specifically, with the use of an arithmetic circuit shown in FIG. 20, the arithmetic operation of the hierarchical neural network can be performed. The arithmetic circuit in FIG. 20 includes, for example, an arithmetic circuit MAC2-1 having a structure similar to that of the arithmetic circuit MAC2 in FIG. 13 and an arithmetic circuit MAC2-2 having a structure in which the circuit XCS in the arithmetic circuit MAC2 in FIG. 13 is not provided. In the cell array CA of the arithmetic circuit MAC2-1, m×n circuits CES are arranged in a matrix, and in the cell array CA of the arithmetic circuit MAC2-2, n×t circuits CES (t is an integer greater than or equal to 1) are arranged in a matrix. The wiring OL[1] to the wiring OL[n] of the arithmetic circuit MAC2-1 are electrically connected to the wiring XCL[1] to the wiring XCL[n] of the arithmetic circuit MAC2-2, respectively. Note that FIG. 20 shows, as a typical example, a circuit CES[1, 1], a circuit CES[1, n], a circuit CES[m, 1], a circuit CES[m, n], a converter circuit ITRZD4[1], a converter circuit ITRZD4[n], the wiring OL[1], the wiring OL[n], and the like included in the arithmetic circuit MAC2-1. In addition, the circuit CES[1, 1], a circuit CES[1, t], a circuit CES[n, 1], a circuit CES[n,t], the converter circuit ITRZD4[1], a converter circuit ITRZD4[t], the wiring OL[1], a wiring OL[t], and the like included in the arithmetic circuit MAC2-2 are shown. Moreover, the cell IM[1, 1] and a cell IMr[1, 1] included in the circuit CES[1, 1], the cell IM[1, n] and a cell IMr[1, n] included in the circuit CES[1, n], the cell IM[m, 1] and a cell IMr[m, 1] included in the circuit CES[m, 1], the cell IM[m, n] and a cell IMr[m, n] included in the circuit CES[m, n], a cell IM[1, t] and a cell IMr[1, t] included in the circuit CES[1, t], a cell IM[n, 1] and a cell IMr[n, 1] included in the circuit CES[n, 1], and a cell IM[n,t] and a cell IMr[n,t] included in the circuit CES[n,t] are shown.

For example, in the arithmetic circuit MAC2-1 in FIG. 20, the weight coefficient between the neurons in the (k−1)-th layer and the neurons in the k-th layer is used as the first data and retained in the circuit CES[1, 1] to the circuit CES[m, n] of the cell array CA, the output signal z_{s[k-1]}^{(k-1)} from the neuron N_{s[k-1]}^{(k-1)} in the (k−1)-th layer is used as the second data, and the current with the amount corresponding to the second data is made to flow from the circuit XCS to the wiring XCL in each row, whereby the output signals z₁^{(k)} to zₙ^{(k)} of the neuron N₁^{(k)} to the neuron Nₙ^{(k)} in the k-th layer can be output from the wiring OL[1] to the wiring OL[n]. The values of the output signals z₁^{(k)} to zₙ^{(k)} can be represented as the amounts of current output from the converter circuit ITRZD4[1] to the converter circuit ITRZD4[n].

In the arithmetic circuit MAC2-2 in FIG. 20, the weight coefficient between the neurons in the k-th layer and the neurons in the (k+1)-th layer is used as the first data and retained in the circuit CES[1, 1] to the circuit CES[n,t] of the cell array CA, and the amount of current flowing through the wiring XCL in each row, i.e., the output signals z₁^{(k)} to zₙ^{(k)} from the neuron N₁^{(k)} to the neuron Nₙ^{(k)} in the k-th layer, is used as the second data, whereby the wiring OL[s[k+1]] (here, s[k+1] is an integer greater than or equal to 1 and less than or equal to t) can output the output signal z_{s[k+1]}^{(k+1)} of the neuron N_{s[k+1]}^{(k+1)} in the (k+1)-th layer.

As described in Embodiment 3, any one of the converter circuits ITRZD4 in FIG. 15, FIG. 16A, and FIG. 17A to FIG. 17C is used as the converter circuit ITRZD4[1] to the converter circuit ITRZD4[n] of the arithmetic circuit MAC2-1 in FIG. 20, whereby the converter circuit ITRZD4[1] to the converter circuit ITRZD4[n] function as ReLU functions. Thus, when the result of the product-sum operation in the circuit CES[1, j] to the circuit CES[m, j] is “negative”, the amount of current flowing from the converter circuit ITRZD4 to the wiring OL[j] is preferably ideally 0. However, in some actual cases, a minute amount of current flows from the converter circuit ITRZD4 to the wiring OL[j], or a minute amount of current flows from the wiring OL[j] to the converter circuit ITRZD4.

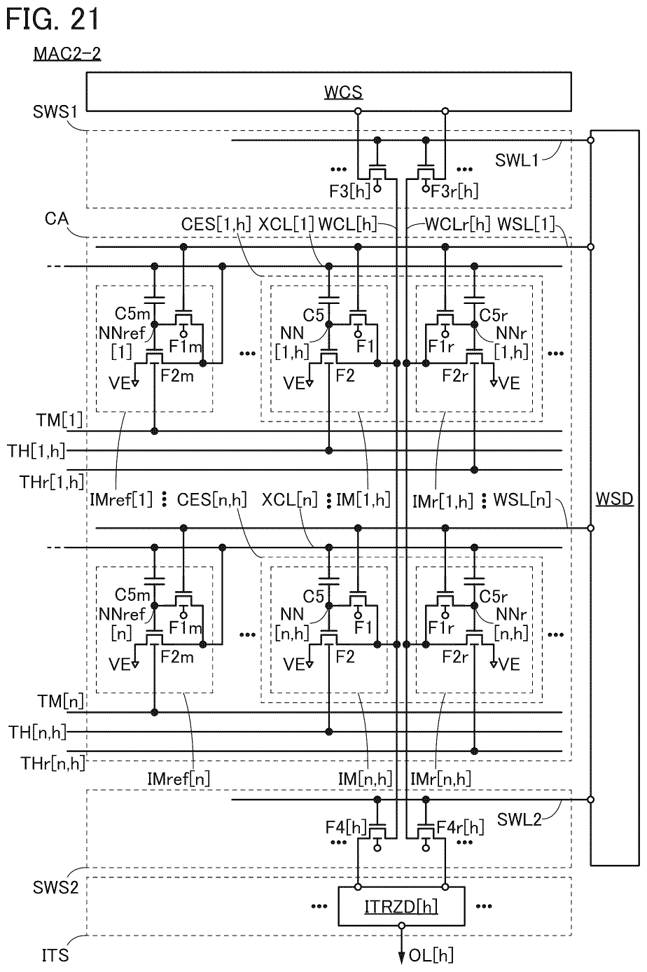

Accordingly, FIG. 21 shows a configuration example of the arithmetic circuit MAC2-2 for properly performing arithmetic operation in the subsequent layers of the hierarchical neural network. The arithmetic circuit MAC2-2 shown in FIG. 21 has a configuration in which the circuits CES arranged in a matrix of m×n in the cell array CA in the arithmetic circuit MAC2 in FIG. 13 are changed to those arranged in a matrix of n×t and the circuit XCS is not provided. Since the circuits CES in the cell array CA of the arithmetic circuit MAC2-2 are arranged in a matrix of n×t, the values in the parenthesis such as [ ] with the reference numerals of the wirings, the circuits, and the like shown in FIG. 21 are also changed. FIG. 21 shows a circuit CES[1, h] (h is an integer greater than or equal to 1 and less than or equal to t), a circuit CES[n,h] and a converter circuit ITRZD[h]. In addition, a transistor F3[h], a transistor F3r[h], a transistor F4[h], and a transistor F4r[h] are shown. Moreover, a wiring WCL[h], a wiring WCLr[h], the wiring WSL[1], a wiring WSL[n], and a wiring OL[h] are shown. Furthermore, a node NN[1, h], a node NN[n,h], a node NNr[1, h], a node NNr[n,h], a node NNref[1], and a node NNref[n] are shown.

FIG. 21 shows an example of a circuit configuration of the arithmetic circuit MAC2-2 in which a wiring TM[1], a wiring TM[n], a wiring TH[1, h], a wiring TH[n,h], a wiring THr[1, h], and a wiring THr[n,h] are provided in the arithmetic circuit MAC2-2. In the arithmetic circuit MAC2-2 in FIG. 21, the wiring TM[1] is electrically connected to the back gate of the transistor F2m in the cell IMref[1], the wiring TM[n] is electrically connected to the back gate of the transistor F2m in the cell IMref[n], the wiring TH[1, h] is electrically connected to the back gate of the transistor F2 in the cell IM[1, h], the wiring THr[1, h] is electrically connected to the back gate of the transistor F2r in the cell IMr[1, h], the wiring TH[n,h] is electrically connected to the back gate of the transistor F2 in the cell IM[n,h], and the wiring THr[n,h] is electrically connected to the back gate of the transistor F2r in the cell IMr[n,h].

A low-level potential is supplied to the wiring TM[1], the wiring TM[n], the wiring TH[1, h], the wiring TH[n,h], the wiring THr[1, h], and the wiring THr[n,h], whereby the threshold voltages of the transistors whose back gates are electrically connected to these wirings can be high. This can prevent a minute current amount flowing through the wiring OL of the arithmetic circuit MAC2-1 from flowing to the wiring VE through the cell IMref of the arithmetic circuit MAC2-2. That is, the output characteristics of the converter circuit ITRZD4[1] to the converter circuit ITRZD4[n] can be close to ReLU functions. Thus, arithmetic operations in the following layer of the hierarchical neural network can be performed properly.

For example, the configuration of the arithmetic circuit MAC2-2 in FIG. 21 can be used for the arithmetic circuit MAC2-1 in FIG. 20. With such a configuration, the threshold voltages of the transistor F2, the transistor F2r, and the transistor F2m which are included in the arithmetic circuit MAC2-1 can be changed as in the arithmetic circuit MAC2-2.

The wiring TM[1], the wiring TM[n], the wiring TH[1, h], the wiring TH[n,h], the wiring THr[1, h], and the wiring THr[n,h] are shown in FIG. 21; however, the arithmetic circuit MAC2-2 in FIG. 21 can have a configuration in which the wiring TM[1], the wiring TH[1, h], and the wiring THr[1, h] are combined to one, and the wiring TM[n], the wiring TH[n,h], and the wiring THr[n,h] are combined to one.

With the arithmetic circuit in FIG. 20, as described above, the value of the output signal of the neuron (current amount) output from the arithmetic circuit MAC2-1 can be directly input to the arithmetic circuit MAC2-2, whereby arithmetic operations of a hierarchical neural network can be performed from, for example, the first layer consecutively. The output signals from the wiring OL[1] to the wiring OL[n] of the arithmetic circuit MAC2-1 need not be temporarily stored with an external circuit or the like; thus, a memory device to temporarily store the signal need not be provided. With the arithmetic circuit in FIG. 20, the circuit area can be reduced and power necessary for transmitting data to be temporarily stored can be reduced.

Note that this embodiment can be combined with any of the other embodiments and the like in this specification or the like as appropriate.

### Embodiment 5

In this embodiment, an example of a configuration where the semiconductor devices described in the above embodiment are stacked will be described.

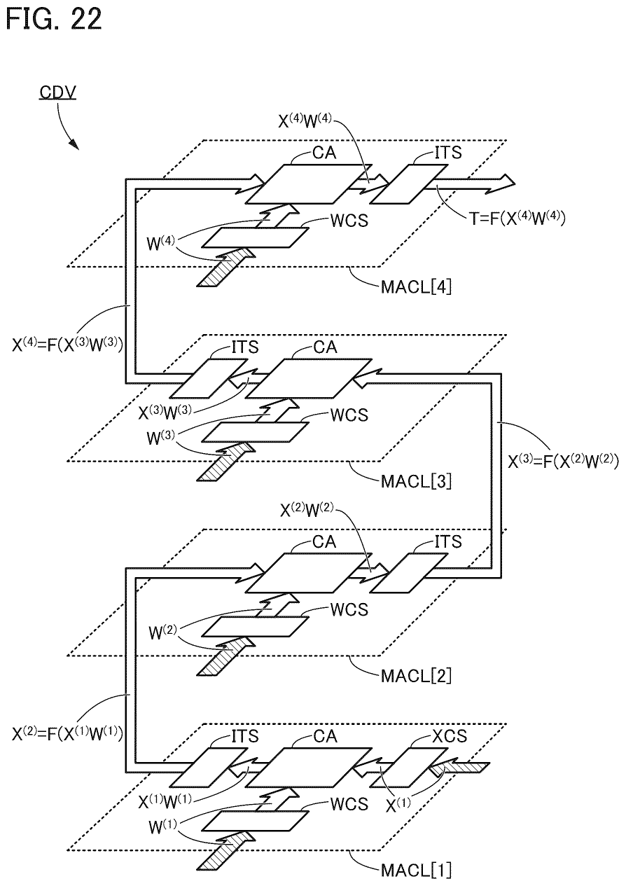

FIG. 22 is a block diagram showing an example of an arithmetic circuit that can execute a product-sum operation and an arithmetic operation of a function system in succession. A circuit CDV shown in FIG. 22 includes, for example, an arithmetic circuit MACL[1] to an arithmetic circuit MACL[4]. Note that in this specification and the like, each of the arithmetic circuit MACL[1] to the arithmetic circuit MACL[4] can also be referred to as a “layer”, “arithmetic layer”, or “circuit layer”. In the case where matters common to the arithmetic circuit MACL[1] to the arithmetic circuit MACL[4] are described, the term “arithmetic circuit MACL” is used in some cases.

In the circuit CDV, the arithmetic circuit MACL[2] is located above the arithmetic circuit MACL[1], the arithmetic circuit MACL[3] is located above the arithmetic circuit MACL[2], and the arithmetic circuit MACL[4] is located above the arithmetic circuit MACL[3].

In FIG. 22, four arithmetic circuits MACL are stacked; however, as the configuration of the circuit CDV, two or three arithmetic circuits MACL may be stacked. Alternatively, five or more arithmetic circuits MACL may be stacked as a configuration of the circuit CDV.

Each of the arithmetic circuit MACL[1] to the arithmetic circuit MACL[4] includes the cell array CA, the circuit WCS, and the circuit ITS. The arithmetic circuit MACL[1] includes the circuit XCS. Although FIG. 22 shows a configuration where the circuit XCS is not provided for the arithmetic circuit MACL[2] to the arithmetic circuit MACL[4], each of the arithmetic circuit MACL[2] to the arithmetic circuit MACL[4] may include the circuit XCS.

The circuit WCS has a function of converting first data that is digital data supplied from the outside (the data corresponds to a weight coefficient in the case of an artificial neural network) into analog data (current), for example.

The circuit XCS has a function of converting second data that is digital data supplied from the outside (the data corresponds to input data in the case of an artificial neural network) into analog data (current), for example.

The cell array CA includes a plurality of arithmetic cells for performing multiplication, for example. The arithmetic cells are arranged in an array inside the cell array CA, for example. The cell array CA has a function of performing a product-sum operation of the first data and the second data and outputting an operation result as the amount of current.

The circuit ITS has a function of acquiring the result (current) of the product-sum operation output from the cell array CA and performing an arithmetic operation of a function system. In addition, the circuit ITS has a function of outputting an arithmetic result to the outside.

Note that Embodiment 2 and Embodiment 3 described above can be referred to as appropriate for the details of the circuit WCS, the circuit XCS, the cell array CA, and the circuit ITS.

Next, data input to the circuit CDV, data subjected to arithmetic operation in the circuit CDV, and data output from the circuit CDV are described. Note that in FIG. 22, the arrows with hatching represent digital data, and the white arrows represent analog data.

In the arithmetic circuit MACL[1], first data W⁽¹⁾ that is digital data is input to the circuit WCS. Then, the circuit WCS inputs the first data W⁽¹⁾ to the cell array CA as analog data (current). Note that W⁽¹⁾ can be a matrix.

Furthermore, in the arithmetic circuit MACL[1], second data X⁽¹⁾ that is digital data is input to the circuit XCS. Then, the circuit XCS inputs the second data X⁽¹⁾ to the cell array CA as analog data (current). Note that X⁽¹⁾ can be a matrix.

The cell array CA in the arithmetic circuit MACL[1] executes a product-sum operation of the first data W⁽¹⁾ and the second data X⁽¹⁾ to output current the amount of which corresponds to X⁽¹⁾W⁽¹⁾. The current is input to the circuit ITS.

The circuit ITS in the arithmetic circuit MACL[1] acquires the current the amount of which corresponds to X⁽¹⁾W⁽¹⁾, thereby outputting current the amount of which corresponds to F(X⁽¹⁾W⁽¹⁾). Note that F(x) is a function for an arithmetic operation performed in the circuit ITS, and specifically, F(X⁽¹⁾W⁽¹⁾)=X⁽²⁾ is defined. Note that X⁽²⁾ can be a matrix. The current the amount of which corresponds to F(X⁽¹⁾W⁽¹⁾)=X⁽²⁾ flows through the cell array CA in the arithmetic circuit MACL[2].

In the arithmetic circuit MACL[2], first data W⁽²⁾ that is digital data is input to the circuit WCS. Then, the circuit WCS inputs the first data W⁽²⁾ to the cell array CA as analog data (current). Note that W⁽²⁾ can be a matrix.

The cell array CA in the arithmetic circuit MACL[2] executes a product-sum operation of the first data W⁽²⁾ and the second data X⁽²⁾ to output current the amount of which corresponds to X⁽²⁾. W⁽²⁾. The current is input to the circuit ITS, and the circuit ITS outputs current the amount of which corresponds to F(X⁽²⁾ W⁽²⁾)=X⁽³⁾.

In the arithmetic circuit MACL[3], W⁽³⁾ that is digital data is input to the circuit WCS, a product-sum operation of X⁽³⁾ W⁽³⁾ is conducted in the cell array CA, and current the amount of which corresponds to F(X⁽³⁾ W⁽³⁾)=X⁽⁴⁾ is output from the circuit ITS, in a manner similar to those of the arithmetic circuit MACL[1] and the arithmetic circuit MACL[2].

Also in the arithmetic circuit MACL[4], W⁽⁴⁾ that is digital data is input to the circuit WCS, and a product-sum operation of X⁽⁴⁾ W⁽⁴⁾ is conducted in the cell array CA, in a manner similar to those of the arithmetic circuit MACL[1] to the arithmetic circuit MACL[3]. The circuit ITS in the arithmetic circuit MACL[4] outputs current the amount of which corresponds to F(X⁽⁴⁾ W⁽⁴⁾)=T. Note that T is output data in the circuit CDV and can be a matrix.

The arithmetic circuit MACL[1] to the arithmetic circuit MACL[4] are preferably formed using OS transistors, for example. OS transistors can be formed more easily than Si transistors as long as they are formed over a film with high planarity and thus enables formation of a stacked structure of the arithmetic circuit MACL[1] to the arithmetic circuit MACL[4] shown in FIG. 22.

Although the circuit CDV in FIG. 22 has a structure where arithmetic operations are performed successively from the arithmetic circuit MACL[1] below to the arithmetic circuit MACL[4] above, the sequence of arithmetic operations may be such that arithmetic operations are performed from the arithmetic circuit MACL located above to the arithmetic circuit MACL located below, for example. In other words, the circuit CDV may have a structure such that the arithmetic circuit MACL[1] is located above the arithmetic circuit MACL[2], the arithmetic circuit MACL[2] is located above the arithmetic circuit MACL[3], and the arithmetic circuit MACL[3] is located above the arithmetic circuit MACL[4].

When the circuit CDV has a configuration where the arithmetic circuit MACL[1] to the arithmetic circuit MACL[4] are stacked, the semiconductor device whose circuits are scaled down can be achieved. In the case where the circuit CDV is architected as a model of a hierarchical neural network, weight coefficients appropriate for respective layers in the hierarchy are preferably written as the first data to the cell arrays CA in the arithmetic circuit MACL[1] to the arithmetic circuit MACL[4]. As a result, there is no need to rewrite weight coefficients for the cell arrays CA in the arithmetic circuit MACL[1] to the arithmetic circuit MACL[4] during the arithmetic operation of the neural network, whereby the power consumption needed for arithmetic operation of the neural network can be lower than that in conventional cases.

Note that this embodiment can be combined with any of the other embodiments and the like in this specification or the like as appropriate.

### Embodiment 6

In this embodiment, a transistor including an oxide semiconductor in a channel formation region (OS transistor) is described. In the description of the OS transistor, comparison with a transistor including silicon in a channel formation region (also referred to as a Si transistor) is also described simply.

### [OS Transistor]

An oxide semiconductor having a low carrier concentration is preferably used in an OS transistor. For example, the carrier concentration of an oxide semiconductor in the channel formation region is lower than or equal to 1×10¹⁸ cm⁻³, preferably lower than 1×10¹⁷ cm⁻³, further preferably lower than 1×10¹⁶ cm⁻³, still further preferably lower than 1×10¹³ cm⁻³, yet further preferably lower than 1×10¹⁰ cm⁻³, and higher than or equal to 1×10⁻⁹ cm⁻³. In order to reduce the carrier concentration in an oxide semiconductor, the impurity concentration in the oxide semiconductor is reduced so that the density of defect states in the oxide semiconductor can be reduced. In this specification and the like, a state with a low impurity concentration and a low density of defect states is referred to as a highly purified intrinsic or substantially highly purified intrinsic state. Note that an oxide semiconductor having a low carrier concentration may be referred to as a highly purified intrinsic or substantially highly purified intrinsic oxide semiconductor.

In addition, a highly purified intrinsic or substantially highly purified intrinsic oxide semiconductor has a low density of defect states and accordingly has a low density of trap states in some cases. Charge trapped by the trap states in the oxide semiconductor takes a long time to disappear and might behave like fixed charge. Thus, a transistor whose channel formation region is formed in an oxide semiconductor with a high density of trap states has unstable electrical characteristics in some cases.

Accordingly, in order to obtain stable electrical characteristics of a transistor, reducing the impurity concentration in an oxide semiconductor is effective. In order to reduce the impurity concentration in the oxide semiconductor, it is preferable that the impurity concentration in an adjacent film be also reduced. Examples of the impurity include hydrogen and nitrogen. Note that impurities in an oxide semiconductor refer to, for example, elements other than the main components of an oxide semiconductor. For example, an element with a concentration lower than 0.1 atomic % can be regarded as an impurity.

When impurities or oxygen vacancies are in a channel formation region of the oxide semiconductor included in an OS transistor, electrical characteristics of the OS transistor may vary easily and the reliability thereof may worsen. In some cases, a defect that is an oxygen vacancy into which hydrogen enters (hereinafter sometimes referred to as VoH) is formed in the oxide semiconductor of the OS transistor, which generates an electron serving as a carrier. Formation of VoH in the channel formation region may increase the donor concentration in the channel formation region of the OS transistor. An increase in the donor concentration in the channel formation region of the OS transistor may lead to a variation in threshold voltage. Thus, the oxygen vacancies in the channel formation region of the oxide semiconductor allow the OS transistor to easily have normally-on characteristics (to cause the drain current to flow at a gate voltage 0 V). Therefore, impurities, oxygen vacancies, and VoH are preferably reduced as much as possible in the channel formation region in the oxide semiconductor.

The band gap of the oxide semiconductor is preferably wider than the band gap of silicon (typically 1.1 eV), further preferably greater than or equal to 2 eV, still further preferably greater than or equal to 2.5 eV, yet still further preferably greater than or equal to 3.0 eV. With use of an oxide semiconductor having a wider band gap than silicon, the off-state current of the transistor (also referred to as Ioff) can be reduced.

In a Si transistor, a short-channel effect (SCE) appears as miniaturization of the transistor proceeds. This hinders miniaturization of a Si transistor. One factor in causing the short-channel effect is a narrow band gap of silicon. By contrast, the OS transistor includes an oxide semiconductor that is a semiconductor material having a wide band gap, and thus can suppress the short-channel effect. In other words, the OS transistor is a transistor in which the short-channel effect does not appear or hardly appears.

The short-channel effect refers to degradation of electrical characteristics that becomes obvious along with miniaturization of a transistor (a decrease in channel length). Specific examples of the short-channel effect include a decrease in threshold voltage, an increase in subthreshold swing value (sometimes referred to as S value), and an increase in leakage current. Here, the S value means the amount of change in gate voltage in the subthreshold region when the drain voltage is constant and the drain current is changed by one order of magnitude.

The characteristic length is widely used as an indicator of resistance to the short-channel effect. The characteristic length is an indicator of curving of a potential in a channel formation region. The smaller the characteristic length is, the more sharply the potential rises; thus, a smaller characteristic length indicates higher resistance to the short-channel effect.

The OS transistor is an accumulation-type transistor and the Si transistor is an inversion-type transistor. Thus, the OS transistor has a shorter characteristic length between the source region and the channel formation region and a shorter characteristic length between the drain region and the channel formation region than the Si transistor has. Accordingly, the OS transistor has higher resistance to the short-channel effect than the Si transistor. That is, the OS transistor is more suitable than the Si transistor in the case where a short-channel transistor is to be formed.

Even in the case where the carrier concentration in the oxide semiconductor is reduced until the channel formation region becomes an i-type or substantially i-type region, the conduction band minimum of the channel formation region in a short-channel transistor decreases because of the conduction band lowering (CBL) effect; thus, there is a possibility that a difference in energy of the conduction band minimum between the channel formation region and the source region or the drain region is as small as 0.1 eV or more and 0.2 eV or less. Accordingly, the OS transistor can be regarded as having an n⁺/n⁻/n⁺ accumulation-type junction-less transistor structure or an n⁺/n⁻/n⁺ accumulation-type non-junction transistor structure in which the channel formation region becomes an n⁻-type region and the source region and the drain region each become an n⁺-type region in the OS transistor.

The above-described structure enables the OS transistor to have excellent electrical characteristics even when the OS transistors are scaled down or highly integrated. For example, excellent electrical characteristics can be obtained even when the gate length of the OS transistor is less than or equal to 20 nm, less than or equal to 15 nm, less than or equal to 10 nm, less than or equal to 7 nm, or less than or equal to 6 nm and greater than or equal to 1 nm, greater than or equal to 3 nm, or greater than or equal to 5 nm. By contrast, it is sometimes difficult for the Si transistor to have a gate length less than or equal to 20 nm or less than or equal to 15 nm because of the appearance of the short-channel effect. Thus, the OS transistor can be more suitably used as a short-channel transistor than the Si transistor. Note that the gate length refers to the length of a gate electrode in a direction in which carriers move inside a channel formation region during operation of the transistor and to the width of the bottom surface of the gate electrode in a top view of the transistor.

Miniaturization of the OS transistor can improve the high frequency characteristics of the transistor. Specifically, the cutoff frequency of the transistor can be improved. When the gate length of the OS transistor is within the above-described range, the cutoff frequency of the transistor can be greater than or equal to 50 GHz, preferably greater than or equal to 100 GHz, further preferably greater than or equal to 150 GHz at room temperature, for example.

The above-described comparison of the OS transistor with the Si transistor demonstrates that the OS transistor has an effect superior to the Si transistor, such as a low off-state current and capability of short-channel transistor formation.

The structures, configurations, methods, and the like described in this embodiment can be used in combination as appropriate with the structures, configurations, methods, and the like described in the other embodiments and the like.

### Embodiment 7

In this embodiment, an electronic component, an electronic appliance, a large computer, a device for space, and a data center (also referred to as DC) for which the semiconductor device described in the above embodiments can be used will be described. An electronic component, an electronic appliance, a large computer, a device for space, and a data center each employing the semiconductor device of one embodiment of the present invention are effective in improving performance, for example, reducing power consumption.

### [Electronic Component]

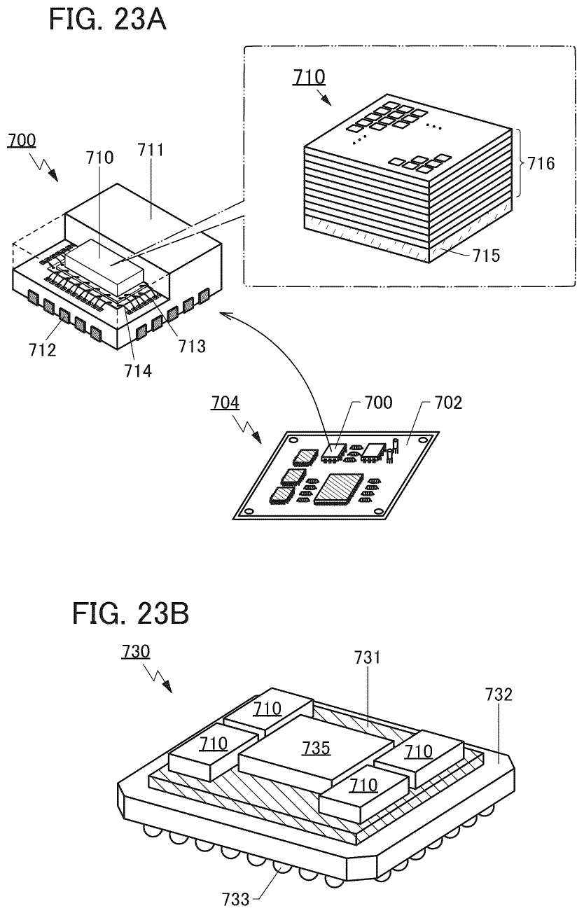

FIG. 23A is a perspective view of an electronic component 700 and a substrate (circuit board 704) on which the electronic component 700 is mounted. The electronic component 700 shown in FIG. 23A includes a semiconductor device 710 in a mold 711. FIG. 23A omits illustrations of some parts to show the inside of the electronic component 700. The electronic component 700 includes a land 712 outside the mold 711. The land 712 is electrically connected to an electrode pad 713. The electrode pad 713 is electrically connected to the semiconductor device 710 through a wire 714. The electronic component 700 is mounted on a printed circuit board 702, for example. A plurality of such electronic components are combined and electrically connected to each other on the printed circuit board 702, whereby the circuit board 704 is completed.

The semiconductor device 710 includes a driver circuit layer 715 and a storage layer 716. Note that the storage layer 716 has a structure in which a plurality of memory cell arrays are stacked. A stacked-layer structure of the driver circuit layer 715 and the storage layer 716 can be a monolithic stacked-layer structure. In the monolithic stacked-layer structure, layers can be connected to each other without using a through electrode technique such as a TSV (Through Silicon Via) and a bonding technique such as Cu—Cu direct bonding. The monolithic stacked-layer structure of the driver circuit layer 715 and the storage layer 716 enables, for example, what is called an on-chip memory structure in which a memory is directly formed on a processor. The on-chip memory structure allows an interface portion between the processor and the memory to operate at high speed.

With the on-chip memory structure, the sizes of a connection wiring and the like can be smaller than those in the case where the through electrode technique such as TSV is employed, for example; thus, the number of connection pins can be increased. An increase in the number of connection pins enables parallel operations, which can increase the bandwidth of the memory (also referred to as a memory bandwidth).

It is preferable that the plurality of memory cell arrays included in the storage layer 716 be formed using OS transistors and be monolithically stacked. The monolithic stacked-layer structure of memory cell arrays can improve the bandwidth of the memory and/or the access latency of the memory. Note that the bandwidth refers to the data transfer volume per unit time. The access latency refers to a period of time from data access to the start of data transmission. In the case where the storage layer 716 is formed using Si transistors, it is difficult to obtain the monolithic stacked-layer structure as compared with the case where the storage layer 716 is formed using OS transistors. Thus, the OS transistor is superior to the Si transistor in the monolithic stacked-layer structure.

That is, an OS transistor has an excellent effect of achieving a wide memory bandwidth as compared with a Si transistor.

Note that the semiconductor device 710 may be referred to as a die. In this specification and the like, a die refers to each of chip pieces obtained by dividing a circuit pattern formed on a circular substrate (also referred to as a wafer) or the like into dice in the manufacturing process of a semiconductor chip, for example. Examples of semiconductor materials that can be used for the die include silicon, silicon carbide, and gallium nitride. A die obtained from a silicon substrate (also referred to as a silicon wafer) may be referred to as a silicon die, for example.

FIG. 23B is a perspective view of an electronic component 730. The electronic component 730 is an example of a SiP (System in Package) or an MCM (Multi Chip Module). In the electronic component 730, an interposer 731 is provided on a package substrate 732 (a printed circuit board), and a semiconductor device 735 and a plurality of semiconductor devices 710 are provided on the interposer 731.

In the electronic component 730, the semiconductor device 710 can be used as a memory device such as a high bandwidth memory (HBM), for example. The semiconductor device 735 can be used as an integrated circuit (e.g., an arithmetic device, a control device, and a signal processing device) such as a CPU (Central Processing Unit), a GPU (Graphics Processing Unit), or an FPGA (Field Programmable Gate Array), for example.

As the package substrate 732, a ceramic substrate, a plastic substrate, or a glass epoxy substrate can be used, for example. As the interposer 731, a silicon interposer or a resin interposer can be used, for example.

The interposer 731 includes a plurality of wirings and has a function of electrically connecting a plurality of integrated circuits with different terminal pitches through the plurality of wirings. The plurality of wirings have a single-layer structure or a layered structure. The interposer 731 has a function of electrically connecting an integrated circuit provided on the interposer 731 to an electrode provided on the package substrate 732. Accordingly, the interposer 731 is sometimes referred to as a “redistribution substrate” or an “intermediate substrate”. A through electrode may be provided in the interposer 731 to be used for electrically connecting the integrated circuit and the package substrate 732. Moreover, in the case of using a silicon interposer as the interposer 731, a TSV can also be used as the through electrode.

A silicon interposer is preferably used as the interposer 731. The silicon interposer can be formed at lower cost than an integrated circuit because it is not necessary to provide an active element. Furthermore, since wirings of a silicon interposer can be formed through a semiconductor process, formation of minute wirings, which is difficult for a resin interposer, is easy.

An HBM needs to be connected to many wirings to achieve a wide memory bandwidth. Thus, an interposer on which an HBM is mounted requires minute and densely formed wirings. For this reason, a silicon interposer is preferably used as the interposer on which an HBM is mounted.

For example, in a SiP, an MCM, or the like using a silicon interposer, a decrease in reliability due to a difference in the coefficient of expansion between an integrated circuit and the interposer is less likely to occur. Furthermore, the surface of a silicon interposer has high planarity, so that a poor connection between the silicon interposer and an integrated circuit provided on the silicon interposer is less likely to occur. It is particularly preferable to use a silicon interposer for a 2.5D package (2.5-dimensional mounting) in which a plurality of integrated circuits are arranged side by side on the interposer.

For example, in the case where a plurality of integrated circuits with different terminal pitches are electrically connected with use of a silicon interposer, TSV, and the like, a space for a width of the terminal pitch and the like is needed. Thus, in the case where the size of the electronic component 730 is to be reduced, the width of the terminal pitches causes a problem, which sometimes makes it difficult to provide a large number of wirings for a wide memory bandwidth. For this reason, the above-described monolithic stacked-layer structure using OS transistors is suitable. A composite structure combining memory cell arrays stacked using a TSV and monolithically stacked memory cell arrays may be employed.

The substrate on which the electronic component 730 is mounted may be provided with a heat sink (a radiator plate) overlapping with the electronic component 730. In the case of providing a heat sink, the heights of integrated circuits provided on the interposer 731 are preferably equal to each other. In the electronic component 730 of this embodiment, the heights of the semiconductor device 710 and the semiconductor device 735 are preferably equal to each other, for example.

An electrode 733 may be provided on the bottom portion of the package substrate 732 to mount the electronic component 730 on another substrate. FIG. 23B illustrates an example in which the electrode 733 is formed of a solder ball. Solder balls are provided in a matrix on the bottom portion of the package substrate 732, whereby BGA (Ball Grid Array) mounting can be achieved in the electronic component 730. Note that the electrode 733 may be formed of a conductive pin. When conductive pins are provided in a matrix on the bottom portion of the package substrate 732, PGA (Pin Grid Array) mounting can be achieved in the electronic component 730.

The electronic component 730 can be mounted on another substrate by various mounting methods not limited to BGA or PGA. For example, a mounting method such as SPGA (Staggered Pin Grid Array), LGA (Land Grid Array), QFP (Quad Flat Package), QFJ (Quad Flat J-leaded package), or QFN (Quad Flat Non-leaded package) can be employed.

### [Electronic Device]

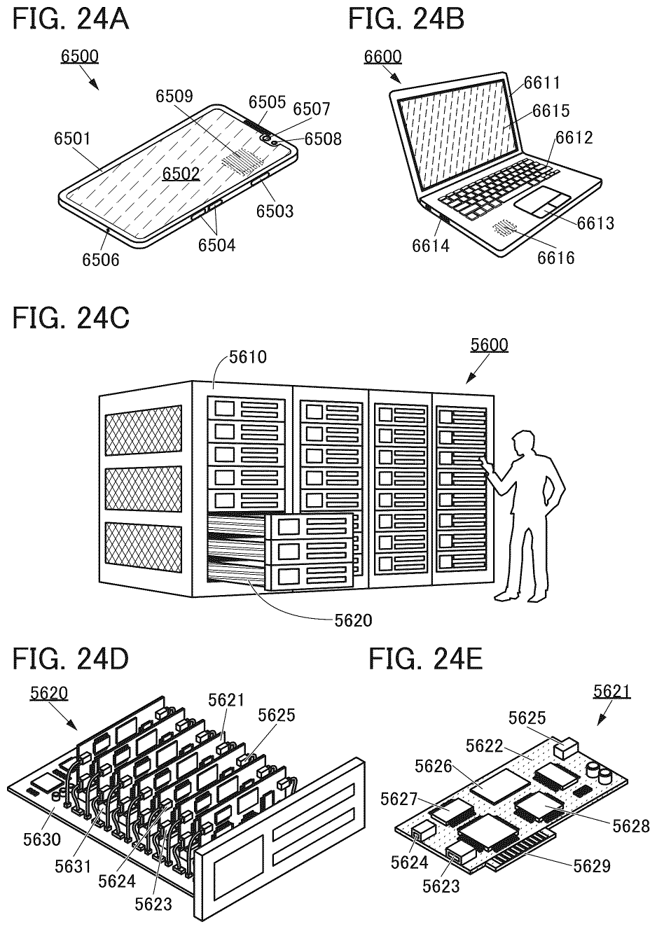

FIG. 24A is a perspective view of an electronic device 6500. The electronic appliance 6500 shown in FIG. 24A is a portable information terminal that can be used as a smartphone. The electronic appliance 6500 includes a housing 6501, a display portion 6502, a power button 6503, buttons 6504, a speaker 6505, a microphone 6506, a camera 6507, a light source 6508, a control device 6509, and the like. Note that as the control device 6509, for example, one or more selected from a CPU, a GPU, and a memory device are included. The semiconductor device of one embodiment of the present invention can be used for the display portion 6502, the control device 6509, and the like, for example. The semiconductor device of one embodiment of the present invention is preferably used for the control device 6509, in which case power consumption can be reduced.

FIG. 24B is a perspective view of an electronic device 6600. An electronic device 6600 shown in FIG. 24B is an information terminal that can be used as a notebook personal computer. The electronic appliance 6600 includes a housing 6611, a keyboard 6612, a pointing device 6613, an external connection port 6614, a display portion 6615, a control device 6616, and the like. Note that as the control device 6616, for example, one or more selected from a CPU, a GPU, and a memory device are included. The semiconductor device of one embodiment of the present invention can be used for the control device 6509, the control device 6616, or the like. The semiconductor device of one embodiment of the present invention is preferably used for the control device 6616, in which case power consumption can be reduced.

### [Large Computer]

FIG. 24C is a perspective view of a large computer 5600. In the large computer 5600 shown in FIG. 24C, a plurality of rack mount computers 5620 are stored in a rack 5610. Note that the large computer 5600 may be referred to as a supercomputer.

FIG. 24D is a perspective view showing a structure example of the computer 5620. In FIG. 24D, the computer 5620 includes a motherboard 5630. The motherboard 5630 includes a plurality of slots 5631 and a plurality of connection terminals (not shown). A PC card 5621 is inserted in the slot 5631. In addition, the PC card 5621 includes a connection terminal 5623, a connection terminal 5624, and a connection terminal 5625, each of which is connected to the motherboard 5630.

The PC card 5621 shown in FIG. 24E is an example of a processing board provided with a CPU, a GPU, a memory device, and the like, for example. The PC card 5621 includes a board 5622. The board 5622 includes the connection terminal 5623, the connection terminal 5624, the connection terminal 5625, a semiconductor device 5626, a semiconductor device 5627, a semiconductor device 5628, and a connection terminal 5629. Note that FIG. 24E also shows semiconductor devices other than the semiconductor device 5626, the semiconductor device 5627, and the semiconductor device 5628; the following description of the semiconductor device 5626, the semiconductor device 5627, and the semiconductor device 5628 is referred to for these semiconductor devices.

The connection terminal 5629 has a shape with which the connection terminal 5629 can be inserted in the slot 5631 of the motherboard 5630, and the connection terminal 5629 functions as an interface for connecting the PC card 5621 and the motherboard 5630. An example of the standard for the connection terminal 5629 is PCIe (Peripheral Component Interconnect Express).

Each of the connection terminal 5623, the connection terminal 5624, and the connection terminal 5625 can serve as, for example, an interface for performing power supply, signal input, or the like to the PC card 5621. As another example, they can serve as an interface for outputting a signal calculated by the PC card 5621. Examples of the standard for each of the connection terminal 5623, the connection terminal 5624, and the connection terminal 5625 include USB (Universal Serial Bus), SATA (Serial ATA), SCSI (Small Computer System Interface), and the like. In the case where video signals are output from the connection terminal 5623, the connection terminal 5624, and the connection terminal 5625, an example of the standard therefor is HDMI (registered trademark) (High-Definition Multimedia Interface).

The semiconductor device 5626 includes a terminal (not shown) for inputting and outputting signals, and when the terminal is inserted in a socket (not shown) of the board 5622, the semiconductor device 5626 and the board 5622 can be electrically connected to each other.

The semiconductor device 5627 includes a plurality of terminals, and when the terminals are reflow-soldered, for example, to wirings of the board 5622, the semiconductor device 5627 and the board 5622 can be electrically connected to each other. Examples of the semiconductor device 5627 include an FPGA, a GPU, and a CPU. As the semiconductor device 5627, the above-described electronic component 730 can be used, for example.

The semiconductor device 5628 includes a plurality of terminals, and when the terminals are reflow-soldered, for example, to wirings of the board 5622, the semiconductor device 5628 and the board 5622 can be electrically connected to each other. An example of the semiconductor device 5628 is a storage device or the like. As the semiconductor device 5628, the above-described electronic component 700 can be used, for example.

The large computer 5600 can also function as a parallel computer. When the large computer 5600 is used as a parallel computer, large-scale computation necessary for artificial intelligence learning and inference can be performed, for example.

### [Space Equipment]

The semiconductor device of one embodiment of the present invention can be suitably used as space equipment such as equipment that processes and stores information.

The semiconductor device of one embodiment of the present invention can include an OS transistor. A change in electrical characteristics of the OS transistor due to exposure to radiation is small. That is, the OS transistor is highly resistant to radiation, and thus can be suitably used in an environment where radiation can enter. For example, the OS transistor can be suitably used in outer space.

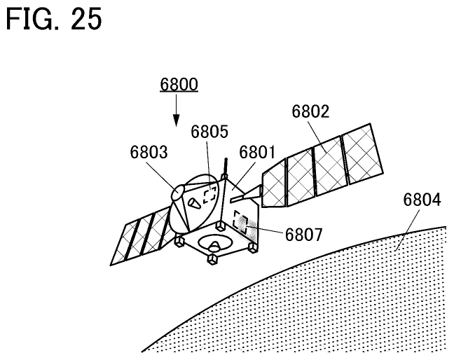

FIG. 25 shows an artificial satellite 6800 as an example of a device for space. The artificial satellite 6800 includes a body 6801, a solar panel 6802, an antenna 6803, a secondary battery 6805, and a control device 6807. In FIG. 25, a planet 6804 in outer space is shown as an example. Note that outer space refers to, for example, space at an altitude greater than or equal to 100 km, and outer space described in this specification and the like may include thermosphere, mesosphere, and stratosphere.

Although not shown in FIG. 25, a battery management system (also referred to as BMS) or a battery control circuit may be provided in the secondary battery 6805. The battery management system or the battery control circuit preferably uses the OS transistor, in which case power consumption is low and high reliability is achieved even in outer space.

The amount of radiation in outer space is 100 or more times that on the ground. Note that examples of radiation include electromagnetic waves (electromagnetic radiation) typified by X-rays or gamma rays and particle radiation typified by alpha rays, beta rays, neutron beams, proton beams, heavy-ion beams, and meson beams.

When the solar panel 6802 is irradiated with sunlight, electric power required for the operation of the artificial satellite 6800 is generated. However, for example, in the situation where the solar panel 6802 is not irradiated with sunlight or the amount of sunlight with which the solar panel 6802 is irradiated is small, the amount of electric power generated by the solar panel 6802 is small. Accordingly, a sufficient amount of electric power required for the operation of the artificial satellite 6800 might not be generated. In order to operate the artificial satellite 6800 even with a small amount of electric power generated by the solar panel 6802, the artificial satellite 6800 is preferably provided with the secondary battery 6805. Note that the solar panel 6802 is referred to as a solar cell module in some cases.

The artificial satellite 6800 can generate a signal. The signal is transmitted through the antenna 6803. The signal can be received by a ground-based receiver or another artificial satellite, for example. When the receiver receives the signal transmitted by the artificial satellite 6800, the position of the receiver can be measured. Thus, the artificial satellite 6800 can construct a satellite positioning system.

The control device 6807 has a function of controlling the artificial satellite 6800. The control device 6807 is formed with one or more selected from a CPU, a GPU, and a memory device, for example. Note that the semiconductor device including the OS transistor, which is one embodiment of the present invention, is suitably used for the control device 6807. A change in electrical characteristics due to exposure to radiation is smaller in the OS transistor than in a Si transistor. Accordingly, the OS transistor has high reliability and thus can be suitably used even in an environment where radiation can enter.

That is, the OS transistor has an excellent effect of being highly resistant to radiation as compared with a Si transistor.

The artificial satellite 6800 can include a sensor. For example, with a structure including a visible light sensor, the artificial satellite 6800 can have a function of sensing sunlight reflected by a ground-based object. With a structure including a thermal infrared sensor, the artificial satellite 6800 can have a function of sensing thermal infrared rays emitted from the surface of the earth. Thus, the artificial satellite 6800 can function as an earth observing satellite, for example.

Although the artificial satellite is described as an example of a device for space in this embodiment, one embodiment of the present invention is not limited to this example. The semiconductor device of one embodiment of the present invention can be suitably used for a device for space such as a spacecraft, a space capsule, or a space probe, for example.

### [Data Center]

The semiconductor device of one embodiment of the present invention can be suitably used for, for example, a storage system in a data center or the like. Long-term management of data, such as guarantee of data immutability, is required for the data center, for example. In the case where data is managed for a long term, installation of storages and servers for storing an enormous amount of data, stable electric power for data retention, cooling equipment for data retention, or the like is necessary, for example. Thus, for example, an increase in the scale of data center facility is necessary.

With use of the semiconductor device of one embodiment of the present invention for a storage system used in a data center, electric power used for retaining data can be reduced and the semiconductor device for retaining data can be downsized. Accordingly, downsizing of the storage system, downsizing of the power supply for retaining data, downscaling of the cooling equipment, and the like can be achieved, for example. Thus, a space of the data center can be reduced.

Since the semiconductor device of one embodiment of the present invention has low power consumption, heat generation from a circuit can be reduced. Accordingly, it is possible to reduce adverse effects of the heat generation on the circuit itself, a peripheral circuit, and a peripheral module. Furthermore, the use of the semiconductor device of one embodiment of the present invention can achieve a data center that operates stably even in a high temperature environment. Thus, the reliability of the data center can be increased.

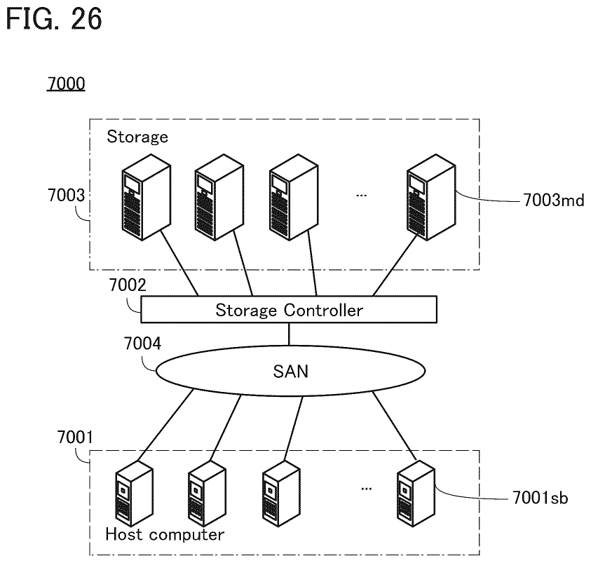

FIG. 26 illustrates a storage system that can be used in a data center. A storage system 7000 shown in FIG. 26 includes a plurality of servers 7001sb as a host 7001 (indicated as “Host Computer” in the diagram). The storage system 7000 includes a plurality of memory devices 7003md as a storage 7003 (indicated as “Storage” in the diagram). Furthermore, the host 7001 and the storage 7003 are connected to each other through a storage area network 7004 (indicated as “SAN” in the diagram) and a storage control circuit 7002 (indicated as “Storage Controller” in the diagram).

The host 7001 corresponds to a computer that accesses data stored in the storage 7003. The host 7001 may be connected to another host 7001 through a network.

The data access speed, i.e., the time taken for writing or reading data, of the storage 7003 is shortened by using a flash memory, but is still considerably longer than the data access speed of a DRAM that can be used as a cache memory in a storage. In the storage system, in order to solve the problem of low access speed of the storage 7003, a cache memory is normally provided in the storage to shorten the time taken for writing or reading data.

The above-described cache memory is used in the storage control circuit 7002 and the storage 7003. The data transmitted between the host 7001 and the storage 7003 is stored in the cache memories in the storage control circuit 7002 and the storage 7003 and then output to the host 7001 or the storage 7003.

The use of an OS transistor as a transistor for storing data in the above-described cache memory to retain a potential based on data can reduce the refresh frequency of the above-described cache memory, so that power consumption of the above-described cache memory can be reduced. Furthermore, with a structure in which memory cell arrays are stacked, the cache memory can be downsized.

The use of the semiconductor device of one embodiment of the present invention for one or more selected from an electronic component, an electronic appliance, a large computer, a device for space, and a data center can be expected to reduce power consumption. Although demand for energy will increase with increasing performance and integration degree of semiconductor devices, the use of the semiconductor device of one embodiment of the present invention can thus reduce the emission amount of greenhouse gas typified by carbon dioxide (CO₂). Furthermore, the semiconductor device of one embodiment of the present invention has low power consumption and thus is effective as a global warming countermeasure.

The structures, configurations, methods, and the like described in this embodiment can be used in combination as appropriate with the structures, configurations, methods, and the like described in the other embodiments and the like.

(Supplementary Notes on Description in this Specification and the Like)

The following are supplementary notes on the description of the above embodiments and structures in the embodiments.

In the case where there is description “X and Y are connected” in this specification and the like, the case where X and Y are electrically connected, the case where X and Y are functionally connected, and the case where X and Y are directly connected are regarded as being disclosed in this specification and the like. Accordingly, without being limited to a predetermined connection relationship, e.g., a connection relationship shown in drawings or texts, a connection relationship other than one shown in drawings or texts is regarded as being disclosed in the drawings or the texts. Each of X and Y denotes an object (e.g., a device, an element, a circuit, a wiring, an electrode, a terminal, a conductive film, or a layer).

Here, the expression “X and Y are electrically connected” means the case where electric signals can be transmitted and received between X and Y when an object having any electric action is present between X and Y. For example, in the case where X and Y are electrically connected, one or more elements that allow electrical connection between X and Y (e.g., a switch, a transistor, a capacitor, an inductor, a resistor, a diode, a display device, a light-emitting device, or a load) can be connected between X and Y.

For example, in the case where X and Y are functionally connected, one or more circuits that allow functional connection between X and Y (e.g., a logic circuit (e.g., an inverter, a NAND circuit, or a NOR circuit); a signal converter circuit (e.g., a digital-analog converter circuit, an analog-digital converter circuit, or a gamma correction circuit); a potential level converter circuit (e.g., a power supply circuit (e.g., a step-up circuit or a step-down circuit) or a level shifter circuit for changing the potential level of a signal); a voltage source; a current source; a switch circuit; an amplifier circuit (e.g., a circuit that can increase signal amplitude, the current amount, or the like, an operational amplifier, a differential amplifier circuit, a source follower circuit, or a buffer circuit); a signal generation circuit; a memory circuit; or a control circuit) can be connected between X and Y. For instance, even if another circuit is provided between X and Y, X and Y are regarded as being functionally connected when a signal output from X is transmitted to Y.

Note that an explicit description that X and Y are electrically connected includes the case where X and Y are electrically connected (i.e., the case where X and Y are connected with another element or another circuit interposed therebetween) and the case where X and Y are directly connected (i.e., the case where X and Y are connected without another element or another circuit interposed therebetween).

It can be expressed as, for example, “X, Y, a source (sometimes called one of a first terminal and a second terminal in this specification and the like) of a transistor, and a drain (sometimes called the other of the first terminal and the second terminal in this specification and the like) of the transistor are electrically connected to each other, and X, the source of the transistor, the drain of the transistor, and Y are electrically connected to each other in this order”. Alternatively, it can be expressed as “a source of a transistor is electrically connected to X; a drain of the transistor is electrically connected to Y; and X, the source of the transistor, the drain of the transistor, and Y are electrically connected to each other in this order”. Alternatively, it can be expressed as “X is electrically connected to Y through a source and a drain of a transistor, and X, the source of the transistor, the drain of the transistor, and Y are provided in this connection order”. When the connection order in a circuit configuration is defined by an expression similar to the above examples, a source and a drain of a transistor can be distinguished from each other to specify the technical scope. Note that these expressions are examples and the expression is not limited to these expressions. Here, X and Y each denote an object (e.g., a device, an element, a circuit, a wiring, an electrode, a terminal, a conductive film, or a layer).

Even when independent components are electrically connected to each other in a circuit diagram, one component has functions of a plurality of components in some cases. For example, when part of a wiring also functions as an electrode, one conductive film has functions of both components: the wiring and the electrode. Thus, electrical connection in this specification and the like includes, in its category, such a case where one conductive film has functions of a plurality of components.

In this specification and the like, as a “resistor”, a circuit element, a wiring, or the like having a resistance value higher than 0Ω can be used, for example. Accordingly, in this specification and the like, examples of the “resistor” include a wiring having a resistance value, a transistor in which current flows between its source and drain, a diode, and a coil. Thus, the term “resistor” can be replaced with the terms “resistance”, “load”, “region having a resistance value”, or the like. Conversely, the terms “resistance”, “load”, and “region having a resistance value” can be replaced with the term “resistor”, or the like. The resistance value can be, for example, preferably higher than or equal to 1 mΩ and lower than or equal to 10Ω, further preferably higher than or equal to 5 mΩ and lower than or equal to 5Ω, still further preferably higher than or equal to 10 mΩ and lower than or equal to 1Ω. For another example, the resistance value may be higher than or equal to 1Ω and lower than or equal to 1×10⁹Ω.

In the case where a wiring is used as a resistor, the resistance value of the resistor is sometimes determined depending on the length of the wiring. Alternatively, a conductor with resistivity different from that of a conductor used as a wiring is sometimes used as a resistor. Alternatively, in the case where a semiconductor is used as a resistor, the resistance value of the resistor is sometimes determined by doping a semiconductor with an impurity.

In this specification and the like, a “capacitor” can be, for example, a circuit element having an electrostatic capacitance value higher than 0 F, a region of a wiring having an electrostatic capacitance value higher than 0 F, parasitic capacitance, or gate capacitance of a transistor. Thus, in this specification and the like, a “capacitor” is not limited to only a circuit element that has a pair of electrodes and a dielectric between the electrodes. A “capacitor” includes, for example, parasitic capacitance generated between wirings, gate capacitance generated between a gate and one of a source and a drain of a transistor, and the like. The term “capacitor”, “parasitic capacitance”, “gate capacitance”, or the like can be replaced with the term “capacitance” and the like, for example. Conversely, the term “capacitance” can be replaced with the term “capacitor”, “parasitic capacitance”, “gate capacitance”, or the like, for example. The term “a pair of electrodes” of a “capacitor” can be replaced with “a pair of conductors”, “a pair of conductive regions”, “a pair of regions”, or the like, for example. Note that the electrostatic capacitance value can be higher than or equal to 0.05 fF and lower than or equal to 10 pF, for example. For another example, the electrostatic capacitance value may be higher than or equal to 1 pF and lower than or equal to 10 μF.

A transistor in this specification and the like has three terminals called a gate (also referred to as a gate terminal, a gate region, or a gate electrode), a source (also referred to as a source terminal, a source region, or a source electrode), and a drain (also referred to as a drain terminal, a drain region, or a drain electrode). The transistor has a region where a channel is formed (also referred to as a channel formation region) between the drain and the source. In the transistor, current can flow through the channel formation region between the source and the drain. The channel formation region refers to a region through which current mainly flows. The gate is a control terminal for controlling the amount of current flowing through the channel formation region between the source and the drain. Two terminals functioning as the source and the drain are input/output terminals of the transistor.

Note that one of the two input/output terminals serves as the source and the other serves as the drain depending on the conductivity type (n-channel type or p-channel type) of the transistor and the levels of potentials supplied to the three terminals of the transistor. In some cases, functions of the source and the drain are replaced with each other when the direction of current flow is changed in circuit operation, for example. Thus, the terms “source” and “drain” can be replaced with each other in this specification and the like. Furthermore, in this specification and the like, expressions “one of a source and a drain” (or a first electrode or a first terminal) and “the other of the source and the drain” (or a second electrode or a second terminal) are used in the description of the connection relationship of a transistor.

Depending on the structure, a transistor may include a back gate in addition to the above three terminals. In that case, in this specification and the like, one of the gate and the back gate of the transistor may be referred to as a first gate and the other of the gate and the back gate of the transistor may be referred to as a second gate. Moreover, the terms “gate” and “back gate” can be replaced with each other in one transistor in some cases. In the case where a transistor includes three or more gates, each of the gates may be referred to as a first gate, a second gate, or a third gate, for example, in this specification and the like.

In this specification and the like, for example, a transistor with a multi-gate structure having two or more gate electrodes can be used as the transistor. In a transistor having the multi-gate structure, channel formation regions are connected in series; accordingly, a plurality of transistors are connected in series. Thus, in the transistor having the multi-gate structure, the amount of off-state current can be reduced, and the withstand voltage of the transistor can be increased (the reliability can be improved). Alternatively, in the transistor having the multi-gate structure, drain-source current does not change very much even if drain-source voltage changes at the time of operation in a saturation region, so that a flat slope of voltage-current characteristics can be obtained. The transistor having the flat slope of the voltage-current characteristics enables an ideal current source circuit or an active load having an extremely high resistance value. As a result, the transistor having the flat slope of the voltage-current characteristics enables, for example, a differential circuit, a current mirror circuit, or the like having high characteristics.

In this specification and the like, the case where a single circuit element is shown in a circuit diagram may indicate a case where the circuit element includes a plurality of circuit elements. For example, the case where a single resistor is shown in a circuit diagram may indicate a case where two or more resistors are electrically connected to each other in series. As another example, the case where a single capacitor is shown in a circuit diagram may indicate a case where two or more capacitors are electrically connected to each other in parallel. As another example, the case where a single transistor is shown in a circuit diagram may indicate a case where two or more transistors are electrically connected to each other in series and their gates are electrically connected to each other. Similarly, as another example, the case where a single switch is shown in a circuit diagram may indicate a case where the switch includes two or more transistors which are electrically connected to each other in series or in parallel and whose gates are electrically connected to each other.

In this specification and the like, a “node” can be referred to as a “terminal”, a “wiring”, an “electrode”, a “conductive layer”, a “conductor”, an “impurity region”, or the like depending on the circuit configuration, the device structure, or the like, for example. Furthermore, a “terminal”, a “wiring”, or the like can be referred to as a “node”, for example.

In this specification and the like, “voltage” and “potential” can be replaced with each other as appropriate. The term “voltage” refers to a potential difference from a reference potential. When the reference potential is a ground potential, for example, “voltage” can be replaced with “potential”. Note that the ground potential does not necessarily mean 0 V. Moreover, potentials are relative values. That is, a potential supplied to a wiring, a potential applied to a circuit and the like, or a potential output from a circuit and the like, are changed with a change of the reference potential.

In this specification and the like, the terms “high-level potential” (also referred to as “H potential” or “H”) and “low-level potential” (also referred to as “L potential” or “L”) do not mean a particular potential. For example, in the case where two wirings are both described as “functioning as a wiring for supplying a high-level potential”, the levels of the high-level potentials supplied from the wirings are not necessarily equal to each other. Similarly, in the case where two wirings are both described as “functioning as a wiring for supplying a low-level potential”, the levels of the low-level potentials supplied from the wirings are not necessarily equal to each other.

In this specification and the like, “current” means a charge transfer (electrical conduction). For example, the description “electrical conduction of positively charged particles occurs” can be rephrased as “electrical conduction of negatively charged particles occurs in the opposite direction”. Thus, unless otherwise specified, “current” in this specification and the like refers to a charge transfer phenomenon (electrical conduction) accompanying carrier movement. Examples of a carrier here include an electron, a hole, an anion, a cation, and a complex ion. The type of carrier differs depending on current-flowing systems (e.g., a semiconductor, a metal, an electrolyte solution, or a vacuum). For example, the “direction of current” in a wiring or the like refers to the direction in which a positive carrier moves, and the amount of current is expressed as a positive value. In other words, the direction in which a negative carrier moves is opposite to the direction of current, and the amount of current is expressed as a negative value. Thus, in the case where the polarity of current (or the direction of current) is not specified in this specification and the like, the description “current flows from element A to element B” can be rephrased as “current flows from element B to element A” and the like, for example. The description “current is input to element A” and the like can be rephrased as “current is output from element A” and the like, for example.

Ordinal numbers such as “first”, “second”, and “third” in this specification and the like are used to avoid confusion among components. Thus, the ordinal numbers do not limit the number of components. In addition, the ordinal numbers do not limit the order of components. For example, a “first” component in one embodiment in this specification and the like can be referred to as a “second” component in other embodiments, the scope of claims, or the like. Furthermore, for example, a “first” component in one embodiment in this specification and the like can be omitted in other embodiments, the scope of claims, or the like.

In this specification and the like, for example, terms for describing arrangement, such as “over”, “under”, “above”, and “below” are sometimes used for convenience to describe the positional relationship between components with reference to drawings. The positional relationship between components is changed as appropriate in accordance with a direction in which each component is described. Thus, the terms for describing arrangement in this specification and the like are not limited to those and can be replaced with another term as appropriate depending on the situation. For example, the expression “an insulator positioned over (on) the top surface of a conductor” can be replaced with the expression “an insulator positioned under (on) a bottom surface of a conductor” when the direction of a drawing showing these components is rotated by 180°. Moreover, the expression “an insulator located over (on) a top surface of a conductor” can be replaced with the expression “an insulator located on a left surface (or a right surface) of a conductor” when the direction of a drawing showing these components is rotated by 90 degrees.

The term “over” or “under” does not necessarily mean that a component is placed directly over or directly under and directly in contact with another component. For example, the expression “electrode B over insulating layer A” does not necessarily mean that the electrode B is formed over and in direct contact with the insulating layer A, and does not exclude the case where another component is provided between the insulating layer A and the electrode B.

In this specification and the like, components arranged in a matrix and their positional relationship are sometimes described using a term such as “row” or “column”, for example. The positional relationship between components is changed as appropriate in accordance with a direction in which each component is described. Thus, for example, the terms such as “row” and “column” are not limited to those described in this specification and the like and can be replaced with another term as appropriate depending on the situation. For example, the term “row direction” can be replaced with the term “column direction” when the direction of the diagram is rotated by 90 degrees.

Furthermore, the term “overlap”, for example, in this specification and the like does not limit a state such as the stacking order of components. For example, the expression “electrode B overlapping with insulating layer A” does not necessarily mean the state where the electrode B is formed over the insulating layer A. The expression “electrode B overlapping with insulating layer A”, for example, does not exclude the state where the electrode B is formed under the insulating layer A and the state where the electrode B is formed on the right side (or the left side) of the insulating layer A.

The term “adjacent” or “proximity” in this specification and the like does not necessarily mean that a component is directly in contact with another component. For example, the expression “electrode B adjacent to insulating layer A” does not necessarily mean that the electrode B is formed in direct contact with the insulating layer A and does not exclude the case where another component is placed between the insulating layer A and the electrode B.

In this specification and the like, the term “film”, “layer”, or the like can be, for example, interchanged with each other depending on the situation, in some cases. For example, the term “conductive layer” can be changed into the term “conductive film” in some cases. For another example, the term “insulating film” can be changed into the term “insulating layer” in some cases. Alternatively, for example, the term “film”, “layer”, or the like is not used and can be interchanged with another term depending on the situation, in some cases. For example, the term “conductive layer” or “conductive film” can be changed into the term “conductor” in some cases. Furthermore, the term “conductor” can be changed into the term “conductive layer” or “conductive film” in some cases. For example, the term “insulating layer” or “insulating film” can be changed into the term “insulator” in some cases. Furthermore, the term “insulator” can be changed into the term “insulating layer” or “insulating film” in some cases.

In addition, in this specification and the like, for example, the term such as “electrode”, “wiring”, or “terminal” does not limit the function of a component. For example, an “electrode” is used as part of a wiring in some cases, and vice versa. Furthermore, the term “electrode” or “wiring” also includes, for example, the case where a plurality of “electrodes” or “wirings” are formed in an integrated manner. For example, a “terminal” is used as part of a “wiring” or an “electrode” in some cases, and vice versa. Furthermore, the term “terminal” also includes the case where a plurality of “electrodes”, “wirings”, “terminals”, or the like are formed in an integrated manner, for example. Thus, for example, an “electrode” can be part of a “wiring” or a “terminal”. Furthermore, a “terminal” can be part of a “wiring” or an “electrode”. Moreover, the term “electrode”, “wiring”, “terminal”, or the like is sometimes replaced with the term “region”, for example.

In addition, in this specification and the like, for example, the term such as “wiring”, “signal line”, or “power supply line” can be replaced with each other depending on the situation, in some cases. For example, the term “wiring” can be changed into the term “signal line” in some cases. For another example, the term “wiring” can be changed into the term “power supply line” or the like in some cases. Conversely, for example, the term “signal line”, “power supply line”, or the like can be changed into the term “wiring” in some cases. Furthermore, for example, the term “power supply line” or the like can be changed into the term “signal line” or the like in some cases. Conversely, for example, the term “signal line” or the like can be changed into the term “power supply line” or the like in some cases. Moreover, the term “potential” that is applied to a wiring can be changed into the term “signal” or the like depending on the situation, for example. Conversely, for example, the term “signal” or the like can be changed into the term “potential” in some cases.

In this specification and the like, a “switch” includes a plurality of terminals and has a function of switching (selecting) electrical continuity and discontinuity between the terminals. For example, in the case where a switch includes two terminals and electrical continuity is established between the two terminals, the switch is in a “conduction state” or an “on state”. In the case where electrical continuity is not established between the two terminals, the switch is in a “non-conduction state” or an “off state”. Note that switching to one of a conduction state and a non-conduction state or maintaining one of a conduction state and a non-conduction state is sometimes referred to as “controlling a conduction state”.

That is, a switch has a function of controlling whether current flows therethrough or not. Alternatively, a switch has a function of selecting and changing a current path. For example, an electrical switch or a mechanical switch can be used as the switch. That is, a switch can be any element capable of controlling current, and is not limited to a particular element.

Note that as a kind of a switch, there is a switch which is normally in a non-conduction state and brought into a conduction state by controlling a conduction state; such a switch is referred to as an “A contact” in some cases. Furthermore, as another kind of a switch, there is a switch which is normally in a conduction state and brought into a non-conduction state by controlling a conduction state; such a switch is referred to as a “B contact” in some cases.

Examples of an electrical switch include a transistor (e.g., a bipolar transistor or a MOS transistor), a diode (e.g., a PN diode, a PIN diode, a Schottky diode, a MIM (Metal Insulator Metal) diode, a MIS (Metal Insulator Semiconductor) diode, or a diode-connected transistor), and a logic circuit in which such elements are combined. Note that in the case where a transistor operates just as a switch, there is no particular limitation on the polarity (conductivity type) of the transistor.

An example of a mechanical switch is a switch using a MEMS (micro electro mechanical systems) technology. Such a switch includes an electrode that can be moved mechanically, and selects a conduction or non-conduction state with the movement of the electrode.

In this specification and the like, the “channel length” of the transistor refers to, for example, the distance between a source and a drain in a region where a semiconductor (or a portion where current flows in a semiconductor when a transistor is in an on state) and a gate overlap with each other or the distance between the source and the drain of a region where a channel is formed in a top view of the transistor.

In this specification and the like, the “channel width” of the transistor refers to, for example, the length of a portion where a source and a drain face each other in a region where a semiconductor (or a portion where current flows in a semiconductor when a transistor is an on state) and a gate overlap with each other or the length of a portion where a source and a drain face each other in a region where a channel is formed in a top view of the transistor.

In this specification and the like, for example, the term such as “substrate”, “wafer”, or “die” does not functionally limit these components. For example, the term such as “substrate,” “wafer,” or “die,” can be interchanged with each other depending on the situation in some cases.

In this specification and the like, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°. Moreover, “perpendicular” indicates a state where two straight lines are placed at an angle greater than or equal to 80° and less than or equal to 100°. Thus, the case where the angle is greater than or equal to 85° and less than or equal to 95° is also included. Furthermore, “approximately perpendicular” or “substantially perpendicular” indicates a state where two straight lines are placed at an angle greater than or equal to 60° and less than or equal to 120°.

Note that in this specification and the like, the expression “level or substantially level” indicates having the same level from a reference surface (e.g., a flat surface such as a substrate surface) in a cross-sectional view. For example, in a manufacturing process of a semiconductor device, planarization treatment is performed, whereby the surface(s) of a single layer or a plurality of layers are exposed in some cases. In this case, the surfaces on which the planarization treatment is performed are at the same level from a reference surface. Note that the surfaces of a plurality of layers on which the planarization treatment is performed are not exactly level with each other in some cases, depending on a treatment apparatus, a treatment method, or a material of the treated surfaces on which the planarization treatment is performed. This case is also regarded as being “level or substantially level” in this specification and the like. For example, the expression “level or substantially level” also includes the case where two layers (here, given as a first layer and a second layer) whose levels with respect to the reference surface are different from each other are provided to have a difference between the top-surface level of the first layer and the top-surface level of the second layer of less than or equal to 20 nm.

Note that in this specification and the like, the expression “end portions are aligned or substantially aligned” means that at least outlines of stacked layers partly overlap with each other in a top view. For example, the case of processing the upper layer and the lower layer with use of the same mask pattern or mask patterns that are partly the same in a manufacturing process of a semiconductor device is included. However, in some cases, the outlines do not exactly overlap with each other and the outline of the upper layer is located inward from the outline of the lower layer or the outline of the upper layer is located outward from the outline of the lower layer. This case is also described with the expression “end portions are aligned or substantially aligned” in this specification and the like.

Note that in this specification and the like, for example, the terms “identical”, “the same”, “equal”, “uniform”, and the like (including synonyms of these words) used in describing calculation values and measurement values or in describing objects, methods, events, and the like that can be converted into calculation values or measurement values, allow for a margin of error of +20% unless otherwise specified.

In this specification and the like, an impurity in a semiconductor refers to a component other than a main component of the semiconductor, for example. For example, an element with a concentration of lower than 0.1 atomic % is an impurity. When an impurity is contained in a semiconductor, for example, the density of defect states in a semiconductor is increased, carrier mobility is decreased, or crystallinity is decreased in some cases. In the case where the semiconductor is an oxide semiconductor, examples of an impurity that changes the characteristics of the semiconductor include Group 1 elements, Group 2 elements, Group 13 elements, Group 14 elements, Group 15 elements, or transition metals other than the main components of the oxide semiconductor. Specific examples include hydrogen (included also in water), lithium, sodium, silicon, boron, phosphorus, carbon, and nitrogen. In addition, oxygen vacancies (also referred to as V_{O}) are formed in an oxide semiconductor in some cases by entry of impurities, for example.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like, for example. For example, in the case where a metal oxide is used for a semiconductor including a channel formation region of a transistor, the metal oxide is referred to as an oxide semiconductor in some cases. That is, when a metal oxide is used as a material that can be used for a channel formation region of a transistor that has at least one of an amplifying function, a rectifying function, and a switching function, the metal oxide can be referred to as a metal oxide semiconductor. In addition, the term “OS transistor” can also be referred to as a transistor including a metal oxide or an oxide semiconductor.

In this specification and the like, a metal oxide including nitrogen is also collectively referred to as a metal oxide in some cases. A metal oxide including nitrogen may be referred to as a metal oxynitride.

In the drawings and the like in this specification, arrows indicating the X direction, the Y direction, and the Z direction are shown in some cases. In this specification and the like, the “X direction” is a direction along the X-axis, and the forward direction and the reverse direction are not distinguished in some cases, unless otherwise specified. The same applies to the “Y direction” and the “Z direction”. The X direction, the Y direction, and the Z direction are directions intersecting with each other. More specifically, the X direction, the Y direction, and the Z direction are directions orthogonal to each other. In this specification and the like, one of the X direction, the Y direction, and the Z direction is referred to as a “first direction” in some cases. Another one of the directions is referred to as a “second direction” in some cases. The remaining one of the directions is referred to as a “third direction” in some cases.

### DESCRIPTION OF REFERENCE NUMERALS

200: semiconductor device, 201: first current generation portion, 202: second current generation portion, 203: product-sum operation unit, 204: cell, 205: memory unit, Dw: first data, Dx: second data, Iw: first current amount, Ix: second current amount, Iwx: third current amount, Io: fourth current amount, 300: arithmetic processing device, 301: semiconductor device, 302: semiconductor device, 400: arithmetic processing device, 401: neural network, 402: control portion, 100: neural network, 710: semiconductor device, 735: semiconductor device, 5626: semiconductor device, 5627: semiconductor device, 5628: semiconductor device, IM: cell, IMref: cell, IMr: cell, IMs: cell, IMsr: cell, IMrefs: cell

1. An arithmetic processing device comprising:
a first semiconductor device;
a second semiconductor device; and
a third semiconductor device,
wherein the first semiconductor device, the second semiconductor device, and the third semiconductor device each comprise a first current generation portion, a second current generation portion, a third current generation portion, and a product-sum operation unit,
wherein the product-sum operation unit comprises a first cell and a second cell,
wherein the first current generation portion is configured to output a first current amount corresponding to first data and to output a second current amount corresponding to second data,
wherein the second current generation portion is configured to output a third current amount corresponding to third data,
wherein the third current generation portion is configured to output a fourth current amount corresponding to fourth data,
wherein the first cell is configured to store the first current amount and to output a fifth current amount corresponding to multiplication of the first current amount and the third current amount,
wherein the second cell is configured to store the second current amount and to output a sixth current amount corresponding to multiplication of the second current amount and the fourth current amount,
wherein the product-sum operation unit is configured to output a seventh current amount corresponding to addition of the fifth current amount and the sixth current amount,
wherein the first current amount in a case where the first data is zero, the second current amount in a case where the second data is zero, the third current amount in the case where the third data is zero, and the fourth current amount in a case where the fourth data is zero are each lower than or equal to 1×10⁻¹¹ A,
wherein the first semiconductor device, the second semiconductor device, and the third semiconductor device each form part of a pruned neural network,
wherein data corresponding to the seventh current amount in the second semiconductor device is input as the third data in the first semiconductor device,
wherein data corresponding to the seventh current amount in the third semiconductor device is input as the fourth data in the first semiconductor device, and
wherein at least one of the first data and the second data in the first semiconductor device is zero.

2. The arithmetic processing device according to claim 1, comprising:
a control portion,
wherein the control portion is configured to set at least one of the first data and the second data in the first semiconductor device to zero.

3. The arithmetic processing device according to claim 1,
wherein the first semiconductor device, the second semiconductor device, and the third semiconductor device each comprise a transistor comprising an oxide semiconductor in a channel formation region.

4. The arithmetic processing device according to claim 1,
wherein the first semiconductor device, the second semiconductor device, and the third semiconductor device each comprise a plurality of current sources, and
wherein an amount of a current output from each of the plurality of current sources is lower than or equal to 1.0×10⁻⁸ A.

5. The arithmetic processing device according to claim 1,
wherein the first semiconductor device, the second semiconductor device, and the third semiconductor device each comprise a transistor operating in a subthreshold region.

6. The arithmetic processing device according to claim 1, comprising:
a first layer; and
a second layer positioned over the first layer,
wherein the first current generation portion and the product-sum operation unit of the first semiconductor device are provided in one of the first layer and the second layer, and
wherein the first current generation portion and the product-sum operation unit of the second semiconductor device and the first current generation portion and the product-sum operation unit of the third semiconductor device are each provided in the other of the first layer and the second layer.

7. The arithmetic processing device according to claim 1,
wherein the first cell comprises a first arithmetic cell and a first driving cell,
wherein the second cell comprises a second arithmetic cell and a second driving cell,
wherein the first arithmetic cell is electrically connected to the first current generation portion through a first wiring,
wherein the first arithmetic cell is electrically connected to the second current generation portion through a second wiring,
wherein the first driving cell is electrically connected to the second current generation portion through the second wiring,
wherein the second arithmetic cell is electrically connected to the first current generation portion through the first wiring,
wherein the second arithmetic cell is electrically connected to the third current generation portion through a third wiring,
wherein the second driving cell is electrically connected to the third current generation portion through the third wiring,
wherein the first current generation portion is configured to supply the first current amount or the second current amount to the first wiring,
wherein the second current generation portion is configured to supply a first reference current or the third current amount to the second wiring,
wherein the third current generation portion is configured to supply a second reference current or the fourth current amount to the third wiring,
wherein the first arithmetic cell is configured to retain a first potential corresponding to the first current amount,
wherein the first driving cell is configured to retain a second potential corresponding to the first reference current,
wherein the first arithmetic cell is configured to supply the fifth current amount corresponding to a product of the first current amount and the third current amount to the first wiring when a current supplied from the second current generation portion to the second wiring is changed from the first reference current to the third current amount in a state where the first potential is retained in the first arithmetic cell and the second potential is retained in the first driving cell,
wherein the second arithmetic cell is configured to retain a third potential corresponding to the second current amount,
wherein the second driving cell is configured to retain a fourth potential corresponding to the second reference current, and
wherein the second arithmetic cell is configured to supply the sixth current amount corresponding to a product of the second current amount and the fourth current amount to the first wiring when a current supplied from the third current generation portion to the third wiring is changed from the second reference current to the fourth current amount in a state where the third potential is retained in the second arithmetic cell and the fourth potential is retained in the second driving cell.
